(19) United States
(12) Patent Application Publication
(10) Pub. No.: US 2013/0223227 A1
(43) Pub. Date: Aug. 29, 2013

(54) FEMTO ACCESS POINT IN A COMMUNICATION SYSTEM AND CONTROL METHOD THEREOF

(71) Applicants: Jung-Suk Lee, Gwangju-si (KR); Ho-Sung Yoon, Suwon-si (KR); Hak-Yong Lee, Seongnam-si (KR); Kyung-Wun Chang, Seongnam-si (KR); Jong-Sun Ahn, Yongin-si (KR); Se-Won Jung, Seongnam-si (KR)

(72) Inventors: Jung-Suk Lee, Gwangju-si (KR); Ho-Sung Yoon, Suwon-si (KR); Hak-Yong Lee, Seongnam-si (KR); Kyung-Wun Chang, Seongnam-si (KR); Jong-Sun Ahn, Yongin-si (KR); Se-Won Jung, Seongnam-si (KR)

(73) Assignee: CS CORPORATION, Seongnam-si, Gyeonggi-do (KR)

(21) Appl. No.: 13/878,664

(22) PCT Filed: Feb. 25, 2010
(86) PCT No.: PCT/KR10/01190

§ 371 Date: Apr. 10, 2013

(30) Foreign Application Priority Data
Feb. 26, 2009 (KR) 10-2009-0016473

(51) Int. Cl. H04W 40/22

(52) U.S. Cl. CPC H04W 40/22
USPC 370/236; 370/315

(57) ABSTRACT

A femto access point in a communication system provides an interface for a UE, an interface for a macro access point or a relay, and an interface for a core network.

### TECHNICAL FIELD

The present invention relates to a femto access point in a communication system and a control method thereof.

### BACKGROUND ART

Communication systems are making progress to provide various high-speed large-capacity services to User Equipments (UEs). Especially, in a communication system, in order to increase the entire system capacity and improve the service quality, it is an important factor to provide a communication service to a shaded area, since it has a large influence on the expansion of a service area of an access point and the increase of a capacity of the access point. There are various methods of providing a communication service to a shaded area, representative examples of which include a method using a relay station providing an interface for a macro access point and a method using a femto access point providing an interface for a Core Network (CN).

In general, the relay station is divided into a repeater and a relay. The repeater transmits a downlink signal, which has been received from an access point, to a UE without changing the received downlink signal, and transmits an uplink signal, which has been received from the UE, to the access point without changing the received uplink signal. In contrast, the relay decodes a downlink signal, which has been received from an access point, to a digital signal, converts the decoded signal to a Radio Frequency (RF) signal, and then transmits the RF signal to a UE, and decodes an uplink signal, which has been received from the UE, converts the decoded signal to an RF signal, and then transmits the RF signal to the access point.

Further, the femto access point, which is the smallest access point from among the access points that have been proposed up to now, provides a communication service to a small number of UEs located within a femto cell area, which is a small-sized communication area, such as an office, a residence, or a building, independent of a typical access point (hereinafter, referred to as “macro access point”). That is, the femto access point not only can provide a communication service to a shaded area but also reduce the load of the macro access point. Therefore, the femto access point can increase the service capacity of a service provider, differently from a relay point sharing the capacity of the macro access point.

Meanwhile, in a communication system, it is necessary to discriminate between a subscriber group and a service provider group, which will be described hereinafter.

The following description is based on an assumption that the communication system as described above is a Wideband Code Division Multiple Access (WCDMA) communication system. In a WCDMA communication system, a service provider is identified by a Public Land Mobile Network (PLMN) identifier (ID) and a service subscriber is identified by an International Mobile Station Identifier (IMSI). However, since a communication service provided through a femto access point may employ a billing system different from that of the existing communication service provided through a macro access point, it is necessary to separately manage a service subscriber group through the femto access point. Therefore, the femto access point identifies a subscriber group by using its own subscriber group ID.

The subscriber group ID may be implemented by, for example, a Closed Subscriber Group (CSG)-ID. However, a UE, which is already being used from before the introduction of the femto access point, may be unable to support the CSG-ID. Therefore, the femto access point should take into account a scheme for providing a service to a conventional UE, which does not support the CSG-ID in consideration of backward compatibility, which will be described below in more detail.

Hereinafter, a method of providing a service by a femto access point by using a subscriber group ID in a typical WCDMA communication system will be described with reference to FIG. 1.

FIG. 1 is a schematic view illustrating a method of providing a service by a femto access point by using a subscriber group ID in a typical WCDMA communication system.

FIG. 1 is based on an assumption that the subscriber group ID is a CSG-ID.

Referring to FIG. 1, it is assumed that a femto access point 111 and UE #1 113 are registered in the same subscriber group and UE #2 115 is registered in a subscriber group different from that of the femto access point 111. Specifically, it is assumed that the femto access point 111 and UE #1 113 use a CSG-ID “A” and UE #2 115 uses a CSG-ID “B”.

Then, the UE #1 113 can receive all the service provided by the service provider. Meanwhile, the UE #2 115 cannot camp on the macro access point, the UE #2 115 can camp on the femto access point 111. However, at this time, the UE #2 115 cannot receive any service except for the emergency call since it is registered in the subscriber group different from that of the femto access point 111. In other words, when the UE #2 115 is located within a closed space and an incoming signal of an outer cell is not applied into the space at all, the UE #2 115 cannot receive any service at all.

Meanwhile, in consideration of current inclination of worldwide service providers, parts vendors, and system vendors, a standard enabling a femto access point to simultaneously provide an access point service to a maximum of four UEs is being prepared for a femto access point for home service and research is are being actively conducted in order to enable a femto access point to simultaneously provide an access point service to a maximum of eight UEs.

### DISCLOSURE OF INVENTION

### Technical Problem

Despite that the femto access point is a device proposed in order to prevent the occurrence of a shaded area and increase the service capacity as described above, a UE that is not registered in the same subscriber group as that of the femto access point may be unable to receive any service from the femto access point at all as described above with reference to FIG. 1.

In order to prevent a UE, which is not registered in the same subscriber group as that of the femto access point, from being unable to receive a service from the femto access point, an additional relay station may be used to provide a service to the UE that is not registered in the same subscriber group as that of the femto access point. At this time, the relay station includes a repeater and a relay. However, the additional relay station requires that the service provider should bear the expense increase due to installation of the relay station.

Therefore, there is a requirement for a scheme capable of providing a service to even a UE, which is registered in a subscriber group different from that of the femto access point, thereby overcoming the problem of service interruption.

Further, although a maximum of four UEs can simultaneously receive service from a femto access point as described above, the capacity of the femto access point may be insufficient when simultaneous voice calls are concentrated at a particular time point or simultaneous high speed data services are concentrated at a particular time point. At this time, the traffic exceeding the capacity of the femto access point may prevent some UEs from receiving a voice communication service or a high speed data service.

Therefore, there is also a requirement for a scheme capable of normally providing a service to UEs even when concentrated traffic exceeds the capacity of the femto access point.

### Solution to Problem

The present invention proposes a femto access point and a control method thereof in a communication system.

Further, the present invention proposes a femto access point and a control method thereof, which can provide an interface for a UE, an interface for a macro access point, and an interface for a core network in a communication system.

Further, the present invention proposes a femto access point and a control method thereof, which can provide a service to a UE that is not registered in the femto access point.

Also, the present invention proposes a femto access point and a control method thereof, which can expand the service area.

Furthermore, the present invention proposes a femto access point and a control method thereof, which can share the capacity of a macro access point.

Moreover, the present invention proposes a femto access point and a control method thereof, which can adaptively set resources to be used.

In addition, the present invention proposes a femto access point and a control method thereof, which can provide synchronization even without an additional unit.

Further, the present invention proposes a femto access point and a control method thereof, by which multiple units can share a radio frequency processing unit.

A femto access point proposed by the present invention provides an interface for a UE, an interface for a macro access point or a relay station, and an interface for a core network.

Especially, the femto access point includes: a relay unit for outputting a first downlink signal, which is received from a macro access point or a relay station, to a combination/distribution unit and relaying an uplink signal, which is output from the combination/distribution unit, to the macro access point or the relay station; a femto access point unit for outputting a second downlink signal, which is received from the core network, to the combination/distribution unit and transmitting an uplink signal, which is output from the combination/distribution unit, to the core network; the combination unit for combining the first downlink signal and the second downlink signal with each other and outputting a combined signal to the UE; the distribution unit for distributing uplink signals received from the UE to the relay unit and the femto access point unit; a Radio Frequency (RF) transmission unit for RF-processing the signal output from the combination unit and transmitting a processed signal to the UE; and an RF reception unit for RF-processing the signal output from the distribution unit and outputting the processed signal to the relay unit or the femto access point unit.

Also, the femto access point further includes a control unit for performing a control operation by using signals output from the relay unit and the femto access point unit, wherein the control unit determines if it will use the relay unit or the femto access point unit in order to provide a service, based on if the UE is registered in the femto access point.

A control method of a femto access point proposed by the present invention includes a step of providing an interface for a UE, an interface for a macro access point or a relay, and an interface for a core network.

Especially, the step of providing an interface for a UE, an interface for a macro access point or a relay, and an interface for a core network includes: combining a first downlink signal, which is received from a macro access point or a relay station, and a second downlink signal, which is received from the core network, with each other, thereby generating a combined signal; RF-processing the combined signal and then transmitting the processed signal to the UE; and relaying an uplink signal, which is received from the UE, to the macro access point or the relay station, or transmitting an uplink signal, which is received from the UE, to the core network.

Also, the step of performing a control operation by using the first downlink signal, the second downlink signal, and the uplink signal includes: determining if the UE is registered in the femto access point; and determining if it will use a relay mode or a femto access point mode in order to provide a service to the UE, based on if the UE is registered in the femto access point.

### Advantageous Effects of Invention

The present invention has the following effects.

(1) The present invention can provide an interface for a UE, an interface for a macro access point, and an interface for a core network in a communication system.

(2) The present invention can provide service to a UE that is not registered in the femto access point.

(3) The present invention can expand the service area.

(4) According to the present invention, when a femto access point includes a relay unit and a femto access point unit, a first downlink signal, which the relay unit receives from a macro access point or a relay station, is combined with a second downlink signal, which the femto access point receives from a core network, and uplink signals received from UEs are distributed to the relay unit and the femto access point. According to the part of the UE interface unit which performs the combination and distribution and according to the form of the UE interface unit, it is possible to share the physical units after the combination and distribution.

(5) The present invention can provide synchronization even without an additional unit.

(6) According to the present invention, even when a femto access point is using all available capacity, the femto access point can additionally provide service to a UE. That is, the present invention allows a femto access point to share the capacity of a macro access point to provide a service to a UE.

(7) The present invention enables adaptive setting of resources to be used by a femto access point. That is, according to the present invention, it is possible to set different Frequency Assignments (FAs) for a femto access point unit and a relay unit of the femto access point, so as to increase the entire service capacity.

(8) According to the present invention, when a base band signal processing unit of a UE interface unit performs the combination and distribution, not only can a relay unit of a femto access point and a femto access point unit share physical detailed units after the combination and distribution as described above, but also an additional unit for the combination and distribution is unnecessary.

### BRIEF DESCRIPTION OF DRAWINGS

The foregoing and other objects, features and advantages of the present invention will become more apparent from the following detailed description when taken in conjunction with the accompanying drawings in which:

FIG. 1 is a schematic view illustrating a method of providing a service by a femto access point by using a subscriber group ID in a typical WCDMA communication system;

FIG. 2 is a schematic view illustrating a structure of a mobile communication system according to an embodiment of the present invention;

FIG. 3 illustrates an internal structure of a femto access point according to an embodiment of the present invention;

FIG. 4 is a block diagram for illustrating a method of providing a service by a femto access point according to an embodiment of the present invention;

FIG. 5 is a flowchart illustrating a process of service beginning of a femto access point according to an embodiment of the present invention;

FIG. 6 is a signal flow diagram illustrating a process of performing the registration by a femto access point according to an embodiment of the present invention;

FIG. 7 is a schematic view illustrating a method of providing a service to a femto access point-unregistered UE by a femto access point according to an embodiment of the present invention;

FIG. 8 is a flowchart illustrating a process of providing a service to a femto access point-unregistered UE by a femto access point according to an embodiment of the present invention;

FIG. 9 is a schematic view illustrating a method of sharing the capacity of a macro access point by a femto access point according to an embodiment of the present invention;

FIG. 10 is a signal flow diagram illustrating a process of sharing the capacity of a macro access point by a femto access point according to the embodiment of the present invention;

FIG. 11 is a signal flow diagram illustrating a process of sharing the capacity of a macro access point by a femto access point according to the embodiment of the present invention;

FIG. 12 is a schematic block diagram illustrating a method of resource management by a femto access point according to an embodiment of the present invention;

FIG. 13 is a flowchart illustrating a process of managing resources of the femto access point according to an embodiment of the present invention;

FIG. 14 is a flowchart illustrating a method of acquiring a service provider ID and a cell ID by a femto access point according to an embodiment of the present invention;

FIG. 15 is a block diagram illustrating an internal structure of a reference signal generation unit that provides the reference signal in a femto access point according to an embodiment of the present invention;

FIG. 16 is a timing diagram illustrating the relation between the P-SCH signal, the clock of the crystal oscillator, and the reference clock generated by the counter-and-clock generation unit;

FIG. 17 is a flowchart illustrating a process of generating a reference clock by the reference signal generation unit of FIG. 15;

FIG. 18 is a block diagram illustrating an internal structure of a femto access point according to an embodiment of the present invention;

FIG. 19 is a block diagram illustrating an internal structure of a femto access point according to another embodiment of the present invention;

FIG. 20 is a block diagram illustrating an internal structure of a femto access point according to another embodiment of the present invention;

FIG. 21 is a block diagram illustrating an internal structure of a femto access point according to another embodiment of the present invention;

FIG. 22 is a block diagram illustrating an internal structure of a femto access point according to another embodiment of the present invention;

FIG. 23 is a block diagram illustrating an internal structure of a femto access point according to another embodiment of the present invention;

FIG. 24 is a block diagram illustrating an internal structure of a femto access point according to another embodiment of the present invention;

FIG. 25 is a block diagram illustrating an internal structure of a femto access point according to another embodiment of the present invention;

FIG. 26 is a block diagram illustrating an internal structure of a femto access point according to another embodiment of the present invention;

FIG. 27 is a block diagram illustrating an internal structure of a femto access point according to another embodiment of the present invention;

FIG. 28 is a block diagram illustrating an internal structure of a femto access point according to another embodiment of the present invention;

FIG. 29 is a block diagram illustrating an internal structure of a femto access point according to another embodiment of the present invention;

FIG. 30 is a block diagram illustrating an internal structure of a femto access point according to another embodiment of the present invention;

FIG. 31 is a block diagram illustrating an internal structure of a femto access point according to another embodiment of the present invention;

FIG. 32 is a block diagram illustrating an internal structure of a femto access point according to another embodiment of the present invention.

### BEST MODE FOR CARRYING OUT THE INVENTION

Hereinafter, exemplary embodiments of the present invention will be described with reference to the accompanying drawings. In the following description of the present invention, a detailed description of known functions and configurations incorporated herein will be omitted when it may make the subject matter of the present invention rather unclear.

The present invention proposes a femto Access Point (AP) and a control method thereof. Further, the present invention proposes a femto access point and a control method thereof, which can provide an interface for a UE, an interface for a macro access point, and an interface for a core network in a communication system. Further, the present invention proposes a femto access point and a control method thereof, which can provide service to a UE that is registered in a subscriber group different from that of the femto access point. Also, the present invention proposes a femto access point and a control method thereof, which can expand the service area. Furthermore, the present invention proposes a femto access point and a control method thereof, which can share the capacity of a macro access point. Moreover, the present invention proposes a femto access point and a control method thereof, which can adaptively set resources to be used. In addition, the present invention proposes a femto access point and a control method thereof, which can provide synchronization even without an additional unit.

FIG. 2 is a schematic view illustrating a structure of a mobile communication system according to an embodiment of the present invention.

Before describing FIG. 2, it is assumed that the mobile communication system is a Wideband Code Division Multiple Access (WCDMA) communication system. Although the following description is based on an assumption that the mobile communication system used herein is a WCDMA communication system, it goes without saying that not only the WCDMA communication system but also various communication systems, such as a Code Division Multiple Access (CDMA) communication system, an Institute of Electrical and Electronics Engineers (IEEE) 802.16 communication system, a mobile Worldwide Interoperability for Microwave Access (WiMAX) communication system, an Ultra Mobile Broadband (UMB) communication system, and a Long Term Evolution (LTE) communication system, can be employed as the mobile communication system used herein.

Referring to FIG. 2, the mobile communication system includes a Mobile service Switching Center (MSC) 211, a Serving General Packet Radio Service (GPRS) Support Node (SGSN) 213, a Femto Access Point-Gate Way (FAP-GW) 215, a generic Internet Protocol (IP) access network 217, a Radio Network Controller (RNC) 219, a macro access point 221, a femto access point 223, and a User Equipment (UE) 225. As used herein, it is assumed that the generic IP access network 217 is, for example, an Asymmetric Digital Subscriber Line (ADSL).

The femto access point 223 can provide an interface for the UE 225, an interface for the macro access point 221, and an interface for the Core Network (CN). The femto access point 223 is operable in both a relay mode and a femto access point mode. As used herein, the relay mode refers to a mode in which the femto access point 223 provides a relay service, and the femto access point mode refers to a mode in which the femto access point 223 provides a femto access point service. The relay mode and the femto access point mode will be described later again in more detail. The femto access point 223 simultaneously performs both the relay mode and the femto access point mode. That is, the femto access point 223 does not operate in only one mode from among the relay mode and the femto access point mode at a particular time point, but operate in both of the two modes. In other words, for convenience of description, an operation of the femto access point 223 when it provides a relay service is defined as a relay mode operation, and an operation of the femto access point 223 when it provides a femto access point service is defined as a femto access point mode operation. Such definitions do not imply that the femto access point 223 operates in only one mode from among the relay mode and the femto access point mode at a particular time point.

First, when the femto access point 223 operates in a relay mode, the femto access point 223 accesses the macro access point 221 and then accesses the MSC 211 through the RNC 219, in order to provide a Circuit Service (CS). Also, when the femto access point 223 operates in the relay mode, the femto access point 223 accesses the macro access point 221 and then accesses the SGSN 213, in order to provide a Packet Service (PS).

Next, when the femto access point 223 operates in a femto access point mode, the femto access point 223 accesses the FAP-GW 215 through the generic IP access network 217 and then accesses the MSC 211, in order to provide a circuit service. Also, when the femto access point 223 operates in the femto access point mode, the femto access point 223 accesses the FAP-GW 215 through the generic IP access network 217 and then accesses the SGSN 213, in order to provide a packet service.

In FIG. 2, operations of the MSC 211, the SGSN 213, the FAP-GW 215, the generic IP access network 217, the RNC 219, the macro access point 221, and the UE 225 except for the femto access point 223 are the same as those in a typical WCDMA communication system, so a detailed description of them will be omitted here.

Next, an internal structure of a femto access point according to an embodiment of the present invention will be described with reference to FIG. 3. FIG. 3 illustrates an internal structure of a femto access point according to an embodiment of the present invention.

Referring to FIG. 3, the femto access point includes a macro access point/relay station interface unit 311, a relay unit 313, a combination/distribution unit 315, a UE interface unit 317, a femto access point unit 319, a core network interface unit 321, and a control unit 323. The femto access point may not include the control unit 323 according to the service that the femto access point provides. The case when the femto access point does not include the control unit 323 will be described later in more detail.

The macro access point/relay station interface unit 311, which is a unit for interfacing between the femto access point and a macro access point or a relay station, can perform interfacing between the femto access point and a macro access point or a relay station by using a wireless interface, such as a Radio Frequency (RF) interface or a microwave interface, or can perform interfacing between the femto access point and a macro access point or a relay station by using a wired interface, such as an optical interface, a gigabit interface, or an Unshielded Twisted Pair (UTP) interface.

The UE interface unit 317, which is a unit for interfacing between a UE and the femto access point, may employ a wireless interface, such as an RF interface, or a wired interface, such as an RF coaxial cable, for the interfacing between a UE and the femto access point.

The core network interface unit 321, which is a unit for interfacing between a core network and the femto access point, may employ a wired interface, such as an x Digital Subscriber Line (xDSL) interface, a Hybrid Fiber Coaxial Cable (HFC) interface, a Local Area Network (LAN) interface, or a Fiber To The Home (FTTH) interface, for the interfacing between a core network and the femto access point.

Further, the combination/distribution unit 315 combines a downlink signal to be relayed from the relay unit 313 to a UE with a downlink signal to be transmitted from the femto access point unit 319 to the UE, and distributes uplink signals received from the UE to the relay unit 313 and the femto access point unit 319.

The femto access point can operate in two modes including a femto access point mode and a relay mode, which will be described hereinafter.

First, a case in which the femto access point operates in a femto access point mode will be described.

The femto access point accesses the FAP-GW through the generic IP access network and then accesses the MSC, in order to provide a circuit service. Also, the femto access point accesses the FAP-GW through the generic IP access network and then accesses the SGSN, in order to provide a packet service. In more detail, the core network interface unit 321 first receives a downlink signal targeting a UE from a core network, and outputs the received downlink signal to the femto access point unit 319. Then, the femto access point unit 319 receives the downlink signal from the core network interface unit 321 and outputs the downlink signal to the combination/distribution unit 315. The combination/distribution unit 315 combines the signal output from the femto access point unit 319 with a signal output from the relay unit 313 and transmits the combined signal to the UE through the UE interface unit 317.

Further, the UE interface unit 317 receives an uplink signal from a UE and outputs the received uplink signal to the combination/distribution unit 315. The combination/distribution unit 315 receives the uplink signal from the UE interface unit 317 and outputs the uplink signal to the femto access point unit 319. Then, the femto access point unit 319 performs processing of the signal output from the combination/distribution unit 315 and then transmits the processed signal to a destination through the core network interface unit 321. That is, when the femto access point operates in the femto access point mode, the femto access point may perform the same operation as that of a conventional femto access point.

Second, a case in which the femto access point operates in a relay station mode will be described.

The femto access point accesses the macro access point and then accesses an MSC through an RNC, in order to provide a circuit service. Also, the femto access point accesses the macro access point and then accesses the SGSN, in order to provide a packet service.

In more detail, the macro access point/relay station interface unit 311 first receives a downlink signal targeting a UE from a macro access point or a relay station, and outputs the received downlink signal to the relay unit 313. Then, the relay unit 313 receives the downlink signal from the macro access point/relay station interface unit 311 and outputs the downlink signal to the combination/distribution unit 315. The combination/distribution unit 315 combines the signal output from the relay unit 313 with a signal output from the femto access point unit 319 and transmits the combined signal to the UE through the UE interface unit 317.

Further, the UE interface unit 317 receives an uplink signal from the UE and outputs the received uplink signal to the combination/distribution unit 315. The combination/distribution unit 315 receives the uplink signal from the UE interface unit 317 and outputs the uplink signal to the relay unit 313. Then, the relay unit 313 relays the signal output from the combination/distribution unit 315 to the macro access point or the relay station through the macro access point/relay station interface unit 311. That is, the femto access point may perform the same operation as that of a conventional relay station. As used herein, the relay station includes a repeater and relay.

In the meantime, FIG. 3 shows individual elements of the femto access point, which includes the macro access point/relay station interface unit 311, the relay unit 313, the combination/distribution unit 315, the UE interface unit 317, the femto access point unit 319, the core network interface unit 321, and the control unit 323. However, it goes without saying that the elements including the macro access point/relay station interface unit 311, the relay unit 313, the combination/distribution unit 315, the UE interface unit 317, the femto access point unit 319, the core network interface unit 321, and the control unit 323 may be implemented by a single unit.

Further, even when the macro access point/relay station interface unit 311 does not include the macro access point/relay station interface unit 311, the relay unit 313, the combination/distribution unit 315, the UE interface unit 317, the femto access point unit 319, the core network interface unit 321, and the control unit 323 within itself, those elements including the macro access point/relay station interface unit 311, the relay unit 313, the combination/distribution unit 315, the UE interface unit 317, the femto access point unit 319, the core network interface unit 321, and the control unit 323 may be implemented as separate units outside of the femto access point when it is possible to transmit a control message between the units through a wired/wireless near distance communication device, such as a cable, an Industrial Scientific and Medical equipment (ISM) band modem, a Zigbee modem, a Bluetooth modem, or an Ultra WideBand (UWB) modem. Detailed structures and operations of the macro access point/relay station interface unit 311, the relay unit 313, the combination/distribution unit 315, the UE interface unit 317, the femto access point unit 319, the core network interface unit 321, and the control unit 323 will be described later in more detail.

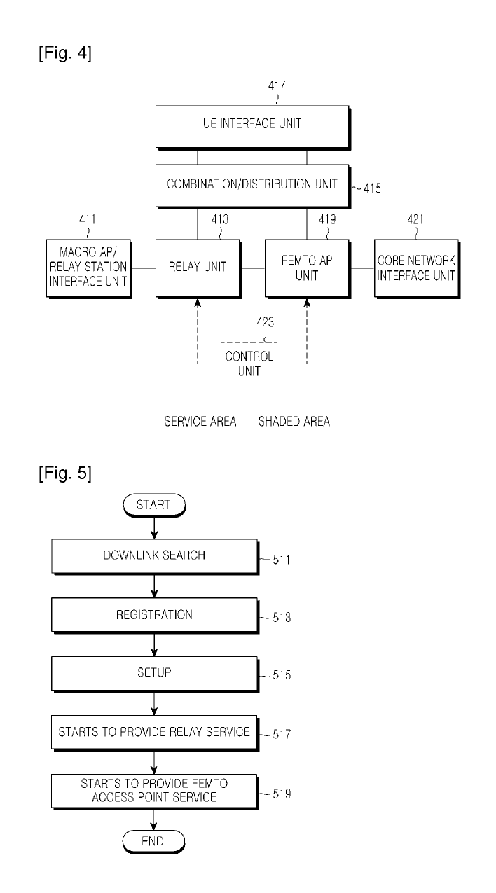

Next, a method of providing a service by a femto access point according to an embodiment of the present invention will be described with reference to FIG. 4.

FIG. 4 is a block diagram for illustrating a method of providing a service by a femto access point according to an embodiment of the present invention.

Referring to FIG. 4, the service area refers to an area in which a macro access point provides a service, and a shaded area (non-service area) refers to an area in which a macro access point cannot provide a service.

If only a conventional femto access point is installed within the non-service area, a UE within the non-service area may be unable to use a communication service. That is, when the UE is not registered in the same subscriber group as that of the conventional femto access point, the UE located within the non-service area cannot receive any service except for an emergency call service even when the UE camps on the conventional femto access point. The case in which the femto access point and the UE are not registered in the same subscriber group will be briefly described below.

First, the femto access point identifies a subscriber group by its own subscriber group identifier (ID). As used herein, the subscriber group ID may be implemented by, for example, a Closed Subscriber Group (CSG)-ID. At this time, the case in which the femto access point and the UE are not registered in the same subscriber group includes: (1) when the UE does not have a CSG-ID since it is a conventional UE that has been already used from before the introduction of the femto access point; and (2) when the UE has a CSG-ID that is not registered in the femto access point.

Meanwhile, the femto access point includes a macro access point/relay station interface unit 411, a relay unit 413, a combination/distribution unit 415, a UE interface unit 417, a femto access point unit 419, a core network interface unit 421, and a control unit 423.

The femto access point proposed by the present invention can operate in not only a femto access point mode in which it can perform the same operation as that of a conventional femto access point but also a relay mode in which it can perform a relay function. Therefore, the femto access point receives a downlink signal from a macro access point or a relay station through the macro access point/relay station interface unit 411 and outputs the received downlink signal to the relay/distribution unit 415. The relay/distribution unit 415 outputs the received downlink signal to the relay unit 413, and then the relay unit 413 relays the received downlink signal to the UE through the UE interface unit 417, so that the UE can continuously receive the service. That is, the femto access point can provide a service, by performing the relay mode operation, to even a UE that is not registered in the same subscriber group as that of the femto access point.

Hereinafter, a process of service beginning of a femto access point according to an embodiment of the present invention will be described with reference to FIG. 5.

FIG. 5 is a flowchart illustrating a process of service beginning of a femto access point according to an embodiment of the present invention.

Referring to FIG. 5, first in step 511, the femto access point is powered on and performs a downlink search, and then proceeds to step 513. As used herein, the downlink search refers to an operation of: (1) receiving downlink signals of all macro access points received according to each FA; (2) measuring the signal quality of each downlink signal of all macro access points; and (3) decoding each received downlink signal of all macro access points, so as to detect a Public Land Mobile Network (PLMN) and location information of a corresponding macro access point. The signal quality may be measured by using, for example, Energy per Chip over the Interface noise (Ec/Io), Received Signal Code Power (RSCP), etc.

Now, the unit for performing the downlink search will be discussed.

First, when the femto access point includes a control unit, the downlink search may be performed either by the femto access point unit or the relay unit. That is, the unit for performing the downlink search is determined by the control unit.

Second, when the femto access point does not include a control unit, the downlink search can be performed only by the relay unit.

Meanwhile, the reason why the femto access point detects the PLMN ID is in order to interrupt the relay mode operation when a PLMN ID of a service provider, a service of which the femto access point can provide, does not exist. Therefore, when a PLMN ID of a service provider, a service of which the femto access point can provide, exists, the femto access point can proceed directly to step 517 from step 511 regardless of the registration of the femto access point.

Hereinafter, an operation of setup of the relay unit when the femto access point does not include a control unit will be discussed.

First, when setup parameters set in advance by a service provider are stored in a separate storage unit (not shown), the femto access point automatically sets the relay unit by using the stored setup parameters before or after step 513. In contrast, when the setup parameters are not stored in a separate storage unit, the femto access point may manually set the relay unit when the femto access point is installed.

The downlink search will not be described further here and will be described later in more detail.

In step 513, the femto access point performs the registration and proceeds to step 515. The registration refers to an operation of registering the femto access point in the core network. Through the registration, the femto access point can acquire existing parameters relating to the setup of the femto access point from the FAP-GW. The parameters relating to the setup of the femto access point include information on the FA already set by the femto access point. The already set FA is determined as an FA to be used by the femto access point unit.

Of course, when the femto access point includes a control unit and when a result of the downlink search shows that the already set FA is not proper to be used by the current femto access point, the femto access point can determine an FA to be used by itself when it performs the setup operation, which will be described below. Here, the frequency use policy of the service provider can determine if the FA to be used by the femto access point is determined by using an already set FA acquired during registration of the femto access point or an FA acquired through the setup operation.

The registration of the femto access point will be described later in more detail.

In step 515, the femto access point performs a setup operation through a control unit and proceeds to step 517. The setup operation refers to an operation of: (1) detecting a Frequency Assignment (FA), through which a downlink signal having the best signal quality from among downlink signals having the same PLMN ID as that of the femto access point has been transmitted; (2) determining the detected FA as an FA to be used by a relay unit; (3) determining one of the other FAs, through which the other downlink signals except for the downlink signal having the best signal quality from among downlink signals having the same PLMN ID as that of the femto access point have been transmitted, as an FA to be used by the femto access point. Here, the operation of determining the FA to be used by the femto access point may be excluded from the setup operation. This case corresponds to a case in which the FA to be used by the femto access point has been set to be determined by using FA information of the existing femto access point acquired during the registration according to the frequency use policy of the service provider as described above in relation to step 513.

Although the above description is based on an assumption that one FA is to be used in the relay unit, it goes without saying that multiple FAs may be used in the relay unit. When multiple FAs are to be used in the relay unit, FAs used for transmitting at least two downlink signals including the downlink signal having the best signal quality from among the downlink signals having the same PLMN ID as that of the femto access point are determined as the FAs to be used in the relay unit.

Meanwhile, when the type of the relay unit corresponds to a repeater using a Radio Frequency (RF) scheme, the operation of determining the FA to be used in the relay unit is omitted in the setup operation. Further, when the type of the relay unit corresponds to a repeater using an Intermediate Frequency (IF) scheme, the number of FAs to be used in the relay unit cannot be changed since the bandwidth used by the relay unit is fixed. The types of the relay unit will be described later in more detail.

In step 517, the femto access point begins to provide a relay service after the setup of the relay unit is completed through the setup operation by the control unit, and then proceeds to step 519. In step 519, the femto access point begins to provide a femto access point service.

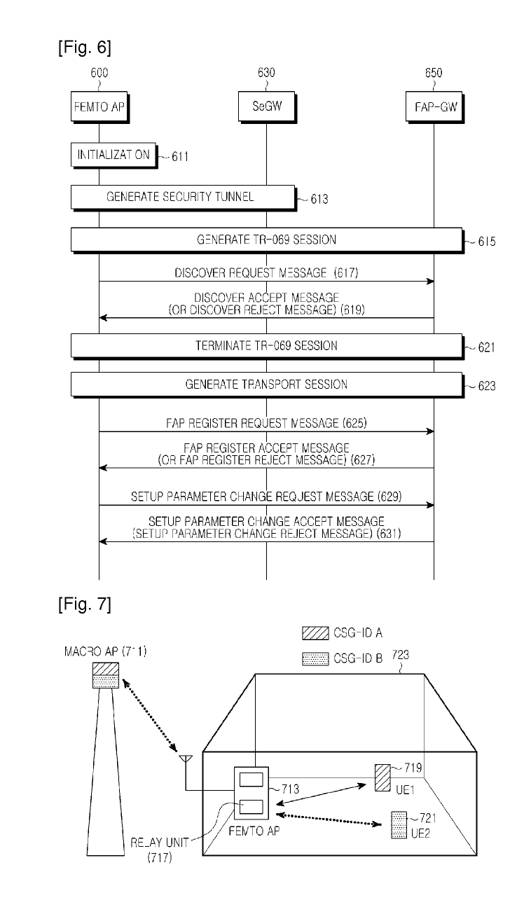

Hereinafter, a process of performing a registration by a femto access point according to an embodiment of the present invention will be described with reference to FIG. 6.

FIG. 6 is a signal flow diagram illustrating a process of performing the registration by a femto access point according to an embodiment of the present invention. Referring to FIG. 6, a femto access point 600 performs an initialization (step 611) and then generates a Security Gate Way (SeGW) 630 and a security tunnel (step 613). The initialization refers to an operation of initializing parameters related to the femto access point 600 and performing the downlink search as described above with reference to FIG. 5.

After generating the security tunnel, the femto access point 600 generates a TR-069 session with an FAP-GW 650 (step 615). The TR-069 refers to a femto access point management protocol for performing operations, such as network setting, device setting, and configuration file download. The femto access point 600 transmits a DISCOVER REQUEST message for searching for an FAP-GW of the femto access point 600 through the TR-069 session to the FAP-GW 650 (step 617). The DISCOVER REQUEST message may include cell ID information of neighbor macro access points for identifying the location of the femto access point 600 and a femto access point ID of the femto access point 600.

Upon receiving the DISCOVER REQUEST message from the femto access point 600, the FAP-GW 650 identifies that the FAP-GW 650 itself is a serving FAP-GW of the femto access point 600 and transmits a DISCOVER ACCEPT message, which is a response message to the DISCOVER REQUEST message, to the femto access point 600 (step 619). The DISCOVER ACCEPT message may include parameters related to the femto access point, such as information on the FAP-GW 650 and information on the FA to be used by the femto access point 600.

Meanwhile, when the FAP-GW 650 cannot become the serving FAP-GW of the femto access point 600, the FAP-GW 650 searches for another FAP-GW (not shown), which can become the serving FAP-GW of the femto access point 600, through the Core Network (not shown). As a result of the search, when another FAP-GW, which can become the serving FAP-GW of the femto access point 600, exists, the FAP-GW 650 transmits a DISCOVER ACCEPT message, which includes parameters related to the femto access point, such as information on the FAP-GW 650 and information on the FA to be used by the femto access point 600, to the femto access point 600.

In contrast, when the result of the search shows that another FAP-GW, which can become the serving FAP-GW of the femto access point 600, does not exist, the FAP-GW 650 may transmit a DISCOVER REJECT message to the femto access point 600 (step 619). The DISCOVER REJECT message may include information on a reason why the femto access point 600 has been rejected.

Upon receiving the DISCOVER ACCEPT message (or DISCOVER REJECT message) from the FAP-GW 650, the femto access point 600 terminates the TR-069 session (step 621).

Further, the femto access point 600 should perform a process of registering itself in the FAP-GW 650, which is a serving FAP-GW. To this end, the femto access point 600 generates a transport session with the FAP-GW 650 (step 623). At this time, the femto access point 600 uses, for example, a Streaming Control Transmission Protocol (SCTP), for generation of the transport session with the FAP-GW 650. After generating the transport session with the FAP-GW 650, the femto access point 600 transmits a femto access point registration request (FAP REGISTER REQUEST) message to the FAP-GW 650 (step 625). The FAP REGISTER REQUEST message may include location information of the femto access point 600, a femto access point ID, etc.

Upon receiving the FAP REGISTER REQUEST message from the femto access point 600, the FAP-GW 650 performs authentication of the femto access point 600. When a result of the authentication shows that the femto access point 600 is a proper femto access point, the FAP-GW 650 registers the femto access point 600 and transmits a femto access point accept (FAP REGISTER ACCEPT) message to the femto access point 600 (step 627).

In contrast, when the result of the authentication shows that the femto access point 600 is not a proper femto access point, the FAP-GW 650 transmits a femto access point reject (FAP REGISTER REJECT) message to the femto access point 600 (step 627). The FAP REGISTER REJECT message may include information related to the reason why registration of the femto access point 600 has been rejected.

After the registration as described above or even during the registration, when a control unit included in the femto access point 600 determines that a parameter acquired through the downlink search operation of the relay unit and a femto access point setup parameter received from the FAP-GW 650 do not coincide with each other, the femto access point 600 may request the FAP-GW 650 to change the femto access point setup parameter. For example, when the FAP-GW 650 stores a femto access point setup parameter for use of a particular FA and the femto access point 600 determines that use of the particular FA may degrade the service quality due to an initial or a midway change in the electric wave environment, the femto access point 600 may transmit a SETUP PARAMETER REQUEST message in order to change the particular FA (step 627). The SETUP PARAMETER CHANGE REQUEST message may include information on an FA that the femto access point 600 wants.

Upon receiving the SETUP PARAMETER CHANGE REQUEST message from the femto access point 600, the FAP-GW 650 may transmit a SETUP PARAMETER CHANGE RESPONSE message or a SETUP PARAMETER CHANGE REJECT message, which is a response to the SETUP PARAMETER CHANGE REQUEST message (step 631). The SETUP PARAMETER CHANGE REJECT message may include information on a reason of the rejection.

Although the SeGW 630 and the FAP-GW 650 are separated from each other in the example shown in FIG. 6, the SeGW 630 and the FAP-GW 650 may be implemented as a single unit in performing the registration of the femto access point 600.

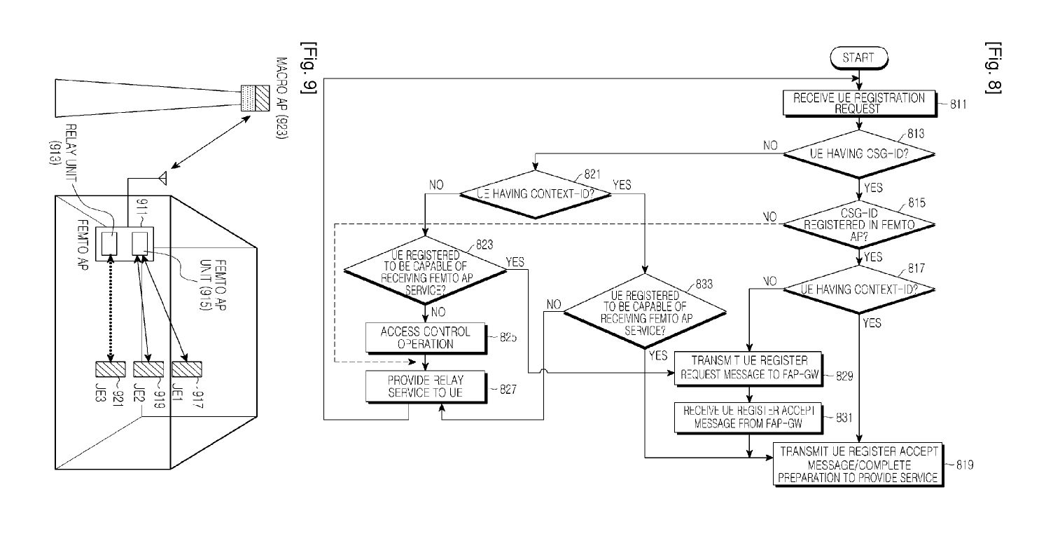

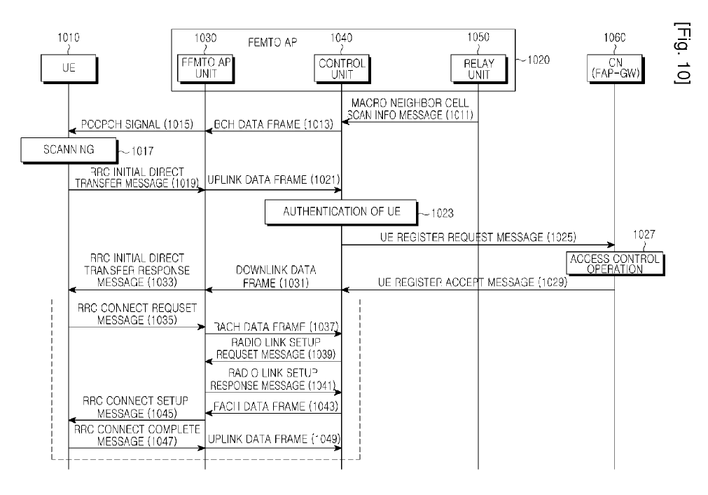

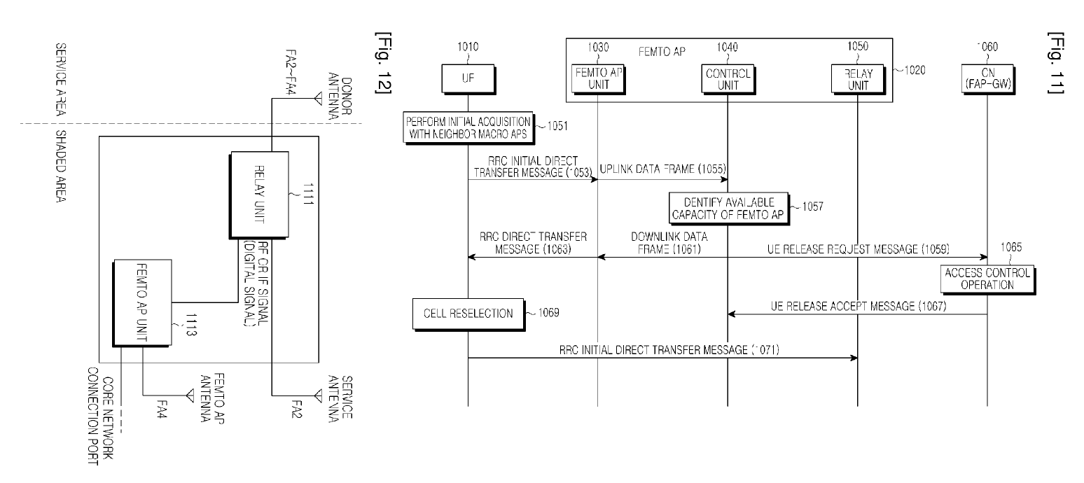

Next, a process of providing a service to a UE, which is not registered in a femto access point, by the femto access point according to an embodiment of the present invention will be described with reference to FIGS. 7 and 8. For convenience of description, the UE, which is not registered in a femto access point, is referred to as a “femto access point-unregistered UE”.

FIG. 7 is a schematic view illustrating a method of providing a service to a femto access point-unregistered UE by a femto access point according to an embodiment of the present invention.

Before describing FIG. 7, the reasons why the femto access point restricts the subscribers who receive a service from the femto access point based on if a corresponding UE has been registered in the femto access point will be described first.

First, the femto access point is usually installed in a femto cell, which is a small-sized communication area, such as an office, a residence, or a building, and provides a high quality voice service and high speed data service to a subscriber located within the femto cell. Especially, with the recent increase in services providing large capacity contents, demand for the high speed data service is also gradually increasing. If a UE (a femto access point-unregistered UE), which is not a UE (a femto access point-registered UE) that has been rightfully registered in the femto access point, can camp on and receive a service from the femto access point, the femto access point-registered UE may unfairly lose a large quantity of traffic resources and may thus incur a monetary lost due to the femto access point-unregistered UE.

Especially, when the femto access point has a higher priority than a macro access point in an access point operation algorithm, the femto access point-unregistered UE has a higher probability of camping on the femto access point than the femto access point-registered UE in an area in which a service area of the femto access point overlaps with a service area of the macro access point. The access point operation algorithm may be, for example, a Hierarchical Cell Structure (HCS), which does not directly relate to the present invention and will not be described further.

Therefore, in order to prevent a femto access point-unregistered UE from camping on the femto access point, the femto access point allows only the femto access point-registered UE to camp on the femto access point by using the CSG-ID. However, since an already existing UE before introduction of the femto access point does not have a CSG-ID, it can camp on the femto access point through a separate access control.

However, since the femto access point-unregistered UE is unable to receive a service from a corresponding femto access point located in a shaded area of a macro access point, the femto access point-unregistered UE cannot receive a normal service. Therefore, the present invention proposes a method enabling even a femto access point-unregistered UE to receive a service through a femto access point.

Hereinafter, a method of providing a service to a femto access point-unregistered UE by the femto access point will be described with reference to FIG. 7.

FIG. 7 is based on an assumption that a UE #1 719 uses CSG-ID “A” and is a femto access point-unregistered UE while a UE #2 721 uses CSG-ID “B” and is a femto access point-registered UE. The UE #1 719 cannot receive a service from a conventional femto access point since it is a femto access point-unregistered UE. However, the femto access point 713 can perform a relay mode operation and can provide service to even the UE #1 719, which is a femto access point-unregistered UE. That is, the femto access point 713 enables the UE #1 719 to receive a service from a macro access point 711 (or a relay station, which is not shown).

In more detail, the femto access point 713 relays a downlink signal received from the macro access point 711 to the UE #1 719 and relays an uplink signal received from the UE #1 719 to the macro access point 711. Further, the femto access point 713 performs a femto access point mode operation and provides a service to the UE #2 721, which is a femto access point-registered UE.

In conclusion, the femto access point 713 can provide a service to not only a femto access point-registered UE but also a femto access point-unregistered UE. As a result, the femto access point-unregistered UE can receive an uninterrupted normal service.

Hereinafter, a method of providing a service to a femto access point-unregistered UE by a femto access point according to an embodiment of the present invention will be described in detail with reference to FIG. 8.

FIG. 8 is a flowchart illustrating a process of providing a service to a femto access point-unregistered UE by a femto access point according to an embodiment of the present invention.

Referring to FIG. 8, the femto access point first receives a UE REGISTER REQUEST message from a UE in step 811 and then proceeds to step 813. The UE REGISTER REQUEST message includes a UE ID of the UE, which may be, for example, an International Mobile Subscriber Identifier (IMSI) or a Temporary Mobile Subscriber Identifier (TMSI). The TMSI is used in order to minimize exposure of the IMSI on an air interface and may be allocated, instead of the IMSI, to each UE at the time of initial location registration. Therefore, the TMSI may be used as the UE ID after the allocation. In step 813, the femto access point determines if the UE is a UE having a CSG-ID.

As a result of the determination, when the UE is a UE having a CSG-ID, the femto access point proceeds to step 815. In step 815, the femto access point determines if the CSG-ID of the UE is a CSG-ID registered in the femto access point. When the CSG-ID of the UE is a CSG-ID registered in the femto access point, the femto access point proceeds to step 817.

In step 817, the femto access point determines if the UE is a UE having a context-ID. The context-ID is used as an ID granted to the FAP-GW connected to the femto access point in order to enable the FAP-GW to manage all UEs connected to the femto access point. Further, the reason why the femto access point determines if the UE is a UE having a context-ID is in order to determine if the UE is a UE registered in the FAP-GW connected to the femto access point.

As a result of the determination, when the UE is a UE registered in the FAP-GW connected to the femto access point, the femto access point proceeds to step 819. In step 819, since the UE is a UE already registered in the FAP-GW connected to the femto access point, the femto access point transmits a UE REGISTER ACCEPT message to the UE and completes the preparation to provide a service to the UE.

When a result of the determination in step 813 shows that the UE is not a UE having a CSG-ID, the femto access point proceeds to step 821. In step 821, the femto access point determines if the UE is a UE having a context-ID. When a result of the determination in step 821 shows that the UE is not a UE having a context-ID, the femto access point proceeds to step 823. Here, the fact that a UE has neither a CSG-ID nor a context-ID implies that the UE has never been registered in the FAP-GW. In step 823, the femto access point determines if the UE is a UE that has been registered so that it can receive the femto access point service. That is, the femto access point determines if the UE is a UE capable of receiving the femto access point service provided by the femto access point. The determination if the UE is a UE capable of receiving the femto access point service provided by the femto access point is performed in order to provide backward compatibility. Even when the UE is an existing UE before the introduction of the femto access point, the determination is performed in order to provide the femto access point service to the UE.

When a result of the determination in step 823 shows that the UE is not a UE that has been registered so that it can receive the femto access point service, the femto access point proceeds to step 825. In step 825, the femto access point performs an access control operation for the UE, and then proceeds to step 827. The access control operation refers to an operation of: generating a message indicating the UE is an unregistered UE and a message for performing a cell reselection operation; and transmitting the generated messages to the UE. In step 827, the femto access point concludes that it cannot provide a femto access point service to the UE, and provides a relay service to the UE.

Meanwhile, when a result of the determination in step 823 shows that the UE is a UE that has been registered so that it can receive the femto access point service, the femto access point proceeds to step 829. In step 829, the femto access point transmits a UE REGISTER REQUEST message to the FAP-GW in order to register the UE in the FAP-GW, and proceeds to step 831. The UE REGISTER REQUEST message may include an IMSI of the UE. In step 831, the femto access point receives a UE REGISTER ACCEPT message, which is a response to the UE REGISTER REQUEST message, from the FAP-GW, and proceeds to step 819. The UE REGISTER ACCEPT message includes a context-ID.

Meanwhile, when a result of the determination in step 821 shows that the UE is a UE having a context-ID, the femto access point proceeds to step 833. In step 833, the femto access point determines if the UE is a UE that has been registered so that it can receive the femto access point service. When a result of the determination in step 833 shows that the UE is not a UE that has been registered so that it can receive the femto access point service, the femto access point proceeds to step 827.

In the meantime, when a result of the determination in step 833 shows that the UE is a UE that has been registered so that it can receive the femto access point service, the femto access point proceeds to step 819.

In the meantime, when a result of the determination in step 833 shows that the CSG-ID of the UE is not a CSG-ID registered in the femto access point, the femto access point proceeds to step 827. Further, when a result of the determination in step 833 shows that the UE is not a UE having a context-ID, the femto access point proceeds to step 829.

Next, a method in which a femto access point having a control unit according to an embodiment of the present invention shares the capacity of a macro access point by using the control unit will be described with reference to FIGS. 9, 10, and 11.

FIG. 9 is a schematic view illustrating a method of sharing the capacity of a macro access point by a femto access point according to an embodiment of the present invention.

Before describing FIG. 9, reasons of the proposal for sharing of the capacity of the macro access point by the femto access point according to the present invention will be described below.

First, in consideration of the current inclination of worldwide service providers, parts vendors, and system vendors, a standard enabling a femto access point to simultaneously provide an access point service to a maximum of four UEs is being prepared for a femto access point for home service and research is being actively conducted in order to enable a femto access point to simultaneously provide an access point service to a maximum of eight UEs.

Further, although a maximum of four UEs can simultaneously receive service from a femto access point as described above, the capacity of the femto access point may be insufficient when simultaneous voice calls are concentrated at a particular time point or simultaneous high speed data services are concentrated at a particular time point. At this time, traffic exceeding the capacity of the femto access point may prevent some UEs from receiving a voice communication service or a high speed data service.

Therefore, the present invention proposes a scheme enabling a femto access point to share the capacity of the macro access point, in order to normally provide a service to UEs even when concentrated traffic exceeds the capacity of the femto access point.

FIG. 9 is based on an assumption that a femto access point 911 can provide a femto access point service to a maximum of two simultaneously accessing UEs and the femto access point 911 is using all the capacity of the femto access point 911 in order to provide the femto access point service to UE #1 917 and UE #2 919.

When it is necessary for the femto access point 911 to provide a femto access point service to UE #3 921 while the femto access point 911 is providing the femto access point service to the UE #1 917 and the UE #2 919, the femto access point 911 is unable to provide the femto access point service to the UE #3 921 due to exhaustion of the capacity of the femto access point 911. Therefore, the femto access point 911 provides a relay service to the UE #3 921 through a relay unit 913. Then, the UE #3 921 can camp on the macro access point 923 and normally receive service.

Meanwhile, since the femto access point 911 has a higher priority than the macro access point 923, when the femto access point service provided to the UE #1 917 or the UE #2 919 is completed to produce an available capacity in the femto access point 911, the UE #3 921 having received the relay service camps on the femto access point 911 and receives the femto access point service from the femto access point 911.

As described above, when a conventional femto access point has no more available capacity, some UEs may be unable to receive any service because it cannot receive the femto access point service. However, according to an embodiment of the present invention, even when a femto access point has no more available capacity, the femto access point can provide a relay service to prevent interruption of the service provided to UEs. That is, according to an embodiment of the present invention, the femto access point can share the capacity of a macro access point, thereby increasing a capacity of the entire system.

Hereinafter, a method of sharing the capacity of a macro access point by a femto access point according to the embodiment of the present invention shown in FIG. 9 will be described in detail with reference to FIGS. 10 and 11.

FIGS. 10 and 11 are a signal flow diagram illustrating a process of sharing the capacity of a macro access point by a femto access point according to the embodiment of the present invention.

FIGS. 10 and 11 are based on an assumption that the femto access point includes a total of three units, that is, a femto access point unit, a relay unit, and a control unit. However, the process of sharing the capacity of a macro access point by a femto access point according to the embodiment of the present invention can be also applied to a case in which the femto access point unit, the relay unit, and the control unit are implemented as a single unit.

Referring to FIGS. 10 and 11, a relay unit 1050 first performs a downlink search, and transmits a neighbor macro cell scan information message including a result of the downlink search to a control unit 1040 (step 1011). The downlink search has been already described above and will not be further described here. Also, as already described above with reference to FIG. 5, a femto access point 1020 may acquire cell information of neighbor macro cells while it performs a setup operation.

When the femto access point 1020 completes its registration in an FAP-GW 1060 and starts to provide a service, the control unit 1040 periodically generates and transmits a Broadcast Channel (BCH) data frame to a femto access point unit 1030 in order to provide broadcast information including system information of the femto access point 1020 and neighbor access point information to UEs (step 1013). Upon receiving the BCH data frame from the control unit 1040, the femto access point unit 1030 generates a physical channel signal, which is a Primary Common Control Physical Channel (PCCPH) signal, from the BCH data frame and broadcasts the PCCPPH signal (step 1015).

Meanwhile, in order to determine if a femto access point exists around a UE 1010, the UE 1010 may periodically perform a scanning operation (step 1017). The scanning operation is not directly related to the present invention and will not be described further.

Upon identifying the existence of a femto access point around the UE 1010 through the scanning, the UE 1010 transmits a Radio Resource Control (RRC) Initial Direct Transfer message to the femto access point unit 1030 in order to camp on the femto access point 1020 (step 1019). The RRC Initial Direct Transfer message includes location update information for the UE 1010 and UE register request information which the UE 1010 wants to register in the femto access point 1020. Upon receiving the RRC Initial Direct Transfer message from the UE 1010, the femto access point unit 1030 generates an uplink data frame from information included in the RRC Initial Direct Transfer message and transmits the generated uplink data frame to the control unit 1040 (step 1021).

Upon receiving the uplink data frame from the femto access point unit 1030, the control unit 1040 performs authentication of the UE 1010 (step 1023). As a result of the authentication, the control unit 1040 transmits a UE REGISTER REQUEST message to the FAP-GW 1060 when the UE 1010 is a rightful UE (step 1025). The UE REGISTER REQUEST message includes an IMSI of the UE 1010.

In contrast, if a result of the authentication in step 1019 shows that the UE 1010 is not a rightful UE, the control unit 1040 transmits a downlink data frame, which is a response to the uplink data frame, to the femto access point unit 1030 (not shown). Upon receiving the downlink data frame from the control unit 1040, the femto access point unit 1030 transmits an RRC Initial Direct Transfer response message, which is a response to the RRC Initial Direct Transfer message, to the UE 1010 (not shown). When the UE 1010 is not a rightful UE, both the downlink data frame and the RRC Initial Direct Transfer response message include information indicating failure in the authentication.

Upon receiving the UE REGISTER REQUEST message from the control unit 1040, the FAP-GW 1060 performs an access control operation in order to determine if the UE 1010 is a UE capable of receiving the service, based on the information including the IMSI value of the UE 1010 (step 1027). After performing the access control operation for the UE 1010, the FAP-GW 1060 determines if the UE 1010 is a UE capable of receiving the service, and transmits a UE REGISTER ACCEPT/REJECT message to the control unit 1040 based on a result of the determination (step 1029). The UE REGISTER ACCEPT message includes a context ID.

Upon receiving the UE REGISTER ACCEPT message from the FAP-GW 1060, the control unit 1040 transmits a downlink data frame, which is a response to the uplink data frame, to the femto access point unit 1030 (step 1031). Upon receiving the downlink data frame from the control unit 1040, the femto access point unit 1030 transmits an RRC Initial Direct Transfer response message, which is a response to the RRC Initial Direct Transfer message, to the UE 1010 (step 1033). The RRC Initial Direct Transfer response message includes a context ID.

In order for the UE 1010 registered in the femto access point 1020 through the process as described above to receive a service, it is necessary to allocate resources related to a request service through the RRC connection to the UE 1010, which will be described hereinafter in detail.

In order to set an RRC connection with the femto access point 1020, the UE 1010 transmits an RRC connection request message to the femto access point unit 1030 (step 1035). Upon receiving the RRC connection request message from the UE 1010, the femto access point unit 1030 transmits a Random Access Channel (RACH) data frame to the control unit 1040 (step 1037).

Upon receiving the RACH data frame from the femto access point unit 1030, the control unit 1040 transmits a radio link setup request message to the femto access point unit 1030 (step 1039). Upon receiving the radio link setup request message from the control unit 1040, the femto access point unit 1030 transmits a radio link setup response message, which is a response to the radio link setup request message, to the control unit 1040 (step 1041).

Upon receiving the radio link setup response message from the femto access point unit 1030, the control unit 1040 transmits a Fast Access Channel (FACH) data frame to the femto access point unit 1030 (step 1043). Upon receiving the FACH data frame from the control unit 1040, the femto access point unit 1030 transmits an RRC connection setup message, which is a response to the RRC connection request message, to the UE 1010 (step 1045).

Upon receiving the RRC connection setup message from the femto access point unit 1030, the UE 1010 sets an RRC connection and then transmits an RRC connection complete message to the femto access point unit 1030 (step 1047). Upon receiving the RRC connection complete message from the UE 1010, the femto access point unit 1030 transmits an uplink data frame including information reporting completion of the RRC connection of the UE 1010 to the control unit 1040 (step 1049).

Meanwhile, the UE 1010 may preliminarily perform an initial acquisition operation together with neighbor macro access points (step 1051). The reason why the UE 1010 preliminarily performs an initial acquisition operation together with neighbor macro access points is in order to more quickly start a communication with a corresponding macro access point when the UE 1010 cannot receive the femto access point service and receives a relay service from the femto access point 1020 due to exhaustion of the capacity of the femto access point 1020. That is, in order to prevent a communication delay due to the initial acquisition operation when the UE 1010 performs a communication with a particular macro access point due to exhaustion of the capacity of the femto access point 1020, the UE 1010 preliminarily performs the initial acquisition operation together with neighbor macro access points.

In order to receive a voice communication service, the UE 1010 transmits an RRC Initial Direct Transfer message to the femto access point unit 1030 (step 1053). The RRC Initial Direct Transfer message includes Call Management (CM) service request information. Upon receiving the RRC Initial Direct Transfer message from the UE 1010, the femto access point unit 1030 generates an uplink data frame from information included in the RRC Initial Direct Transfer message and transmits the generated uplink data frame to the control unit 1040 (step 1055).

Upon receiving the uplink data frame from the femto access point unit 1030, the control unit 1040 identifies the available capacity of the femto access point 1020 (step 1057). As a result of the identification of the available capacity of the femto access point 1020, when the femto access point 1020 is unable to provide a voice communication service to the UE 1010, the control unit 1040 transmits a UE Release Request message to the FAP-GW 1060 in order to remove the control unit 1040 from the UEs to which the femto access point 1020 provides the femto access point service (step 1059). The UE Release Request message includes a context ID or an IMSI of the UE 1010.

Further, in order to enable the UE 1010 to receive a service from a macro access point other than the femto access point 1020, the control unit 1040 transmits a downlink data frame to the femto access point unit 1030 (step 1061). The downlink data frame includes information commanding the UE 1010 to handover to a macro access point. Upon receiving the downlink frame from the control unit 1040, the femto access point unit 1030 transmits an RRC Direct Transfer message to the UE 1010 (step 1063). The RRC Direct Transfer message also includes information commanding the UE 1010 to handover to a macro access point.

Meanwhile, upon receiving the UE Release Request message from the control unit 1040, the FAP-GW 1060 performs an access control operation in relation to a UE release of the UE 1010 (step 1065). After performing the access control operation with respect to the UE 1010, the FAP-GW 1060 transmits a UE Release Accept message, which is a response to the UE Release Request message, to the control unit 1040 (step 1067).

Upon receiving the RRC Direct Transfer message from the control unit 1040, the UE 1010 recognizes that the UE 1010 cannot receive the femto access point service from the femto access point 1020 and should receive a service from a macro access point. Therefore, the UE 1010 performs a cell reselection operation (step 1069). In order to receive a service from a macro access point selected as a result of the cell reselection, the UE 1010 transmits an RRC Initial Direct Transfer message to the relay unit 1050 (step 1071). Thereafter, the UE 1010 receives a service from the selected macro access point. That is, the femto access point 1020 relays a downlink signal, which is received from the macro access point selected by the UE 1010, to the UE 1010, and relays an uplink signal received from the UE 1010 to the macro access point selected by the UE 1010.

Thereafter, when the voice communication service provided from the macro access point is completed, the UE 1010 repeats steps 1011 to 1033 in order to register to the femto access point 1020 since the femto access point 1020 has a higher priority than the macro access point.

Although FIGS. 10 and 11 show an RRC connection setup process (the process in steps 1035 to 1047) based on an assumption that the UE 1010 is initially in an idle mode, it goes without saying that the RRC connection setup process may be omitted if the UE 1010 is in an RRC connected mode.

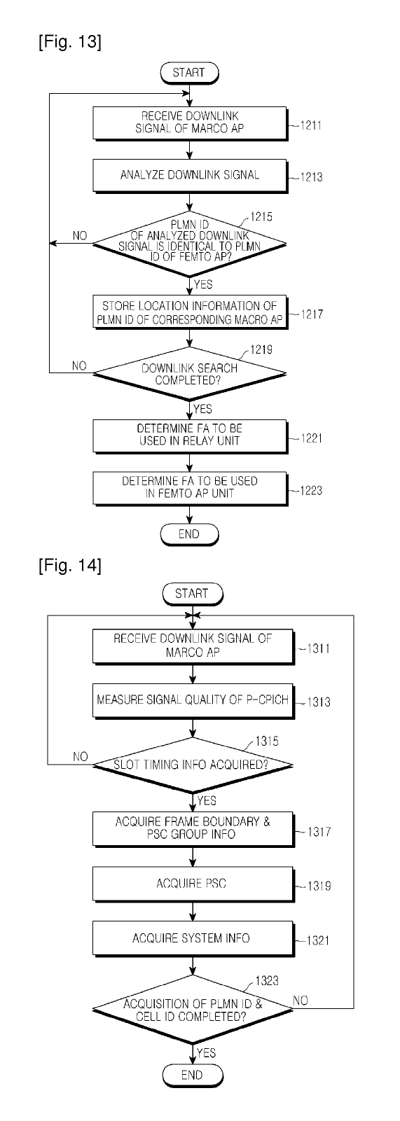

Next, a method of resource management by a femto access point according to an embodiment of the present invention will be described with reference to FIGS. 12 and 13.

FIG. 12 is a schematic block diagram illustrating a method of resource management by a femto access point according to an embodiment of the present invention.

As shown in FIG. 12, the femto access point includes a femto access point unit 1113, a relay unit 1111, and a control unit. The control unit may be may be included in either the relay unit 1111 or the femto access point unit 1113, so it is not separately illustrated in FIG. 11. The control unit manages resources of the femto access point. Further, it is noted from FIG. 11 that, for convenience of description, antennas included in a UE interface unit (not shown) of the femto access point are separately illustrated for convenience of description. Further, although it is a basic assumption that the femto access point unit uses one FA and the relay unit uses one FA, the relay unit may use more than one FA according to the request of a service provider. Further, it is assumed that each of the relay unit and the femto access point unit can perform a downlink search and they are connected to each other through an RF path, a base band In-phase/Quardrature-phase (I/Q) path, or a digital control path. The downlink search is performed for each preset frequency unit, for example, for each 200 kHz or for each FA.

Referring to FIG. 12, it is assumed that the service provider can use a total of four FAs including FA1 to FA4, from among which FA2 and FA3 are actually used and a downlink signal transmitted through FA2 has the best signal quality, and the relay unit 1111 performs the downlink search. In order to perform the downlink search, the relay unit 1111 should include a Digital Signal Processor (DSP) capable of decoding a channel signal, which may be implemented by a Field Programmable Gate Array (FPGA) or an Application-Specific Integrated Circuit (ASIC).

After performing the downlink search, the relay unit 1111 performs a setup operation. That is, the relay unit 1111 determines an FA, through which a downlink signal having the best signal quality from among the downlink signals having the same PLMN ID as that of the femto access point is transmitted, as an FA to be used by the relay unit 1111, and determines one of the other FAs except for the FA, through which the downlink signal having the best signal quality from among the downlink signals having the same PLMN ID as that of the femto access point is transmitted, as an FA to be used by the femto access point unit 1113.

In FIG. 12, since the downlink signal transmitted through FA2 has the best signal quality, the relay unit 1111 determines FA2 as the FA to be used by the relay unit 1111 and FA3 as the FA to be used by the femto access point unit 1113. Further, the relay unit 1111 transmits information on the FA, which the relay unit 1111 has determined as the FA to be used by the femto access point unit 1113, to the femto access point unit 1113. Then, based on the FA information transmitted from the relay unit 1111, the femto access point unit 1113 sets the FA to be used by itself.

Although the downlink search and setup operation is performed by the relay unit 1111 in the example described above, the downlink search and setup operation overlaps, to a certain some degree, with the operation performed by the DSP included in the femto access point unit 1113, and the DSP included in the relay unit 1111 may increase the cost. Therefore, according to the present invention, the downlink search and setup operation can be performed by the femto access point unit 1113 as well as the relay unit 1111.

Further, the problems, which may occur while the relay unit 1111 performs the downlink search and setup operation, can be overcome by the relay unit 1111 by transferring a downlink RF signal of a macro access point to the femto access point unit 1113 without change and using a downlink signal receiving function of the femto access point unit 1113 or by the relay unit 1111 by converting the downlink signal and transferring a baseband I/Q signal to the femto access point unit 1113.

As described above, one reason why the relay unit 1111 and the femto access point unit 1113 use different FAs is a necessity for resource management. If the femto access point unit 1113 uses the same FA as that of a macro access point, a signal of the macro access point may have an influence on the femto access point unit 1113 and a signal of the femto access point unit 1113 may have an influence on the macro access point. As a result, signals of UEs camping on the macro access point may have an influence on the femto access point unit 1113, and a signal of the femto access point unit 1113 may have an influence on the UEs camping on the macro access point.

In other words, the correlation between the femto access point unit 1113 and the macro access point and the correlation between UEs camping on the femto access point unit 1113 and the macro access point may cause reduction of the capacity, such as data throughput. Therefore, the present invention proposes the use of different FAs by the relay unit 1111 and the femto access point unit 1113. That is, by setting different FAs for use by the relay unit 1111 and the femto access point unit 1113, it is possible to prevent the relay unit 1111 and the femto access point unit 1113 from having an effect on each other, thereby increasing the entire service capacity. Especially, the resource management method as described above is very advantageous in such a country as the United States of America, in which each state uses a different frequency, and when an owner of a femto access point moves between states and provides a femto access point service in a new state.

Therefore, according to the resource management method proposed by the present invention, FAs to be used by the femto access point unit and the relay unit are adaptively set by using macro access point signals at a location at which the femto access point is installed, so that it is possible to prevent the relay unit and the femto access point unit from having an effect on each other, thereby increasing the entire system capacity, and to set a service configuration proper for a situation of the femto access point.

Hereinafter, a method of managing resources of the femto access point of FIG. 11 according to an embodiment of the present invention will be described with reference to FIG. 13.

FIG. 13 is a flowchart illustrating a process of managing resources of the femto access point according to an embodiment of the present invention.

Referring to FIG. 13, first in step 1211, the femto access point receives downlink signals of all macro access points in the unit of a preset frequency, for example, for each 200 kHz or each FA. Then, in step 1213, the femto access point performs analysis of the received downlink signal, and then proceeds to step 1215. The analysis of the received downlink signal refers to an operation of detecting location information and a PLMN ID of a corresponding macro access point by measuring the quality of the received downlink signal and decoding the received downlink signal. Further, the signal quality can be measured by, for example, Ec/Io and RSCP.

In step 1215, the femto access point determines if the PLMN ID of the analyzed downlink signal is identical to the PLMN ID of the femto access point. As a result of the determination, when the PLMN ID of the analyzed downlink signal is not identical to the PLMN ID of the femto access point, the femto access point returns to step 1213.

In contrast, as a result of the determination, when the PLMN ID of the analyzed downlink signal is identical to the PLMN ID of the femto access point, the femto access point proceeds to step 1217. In step 1217, the femto access point stores the information of the downlink having the same PLMN ID as the PLMN ID of the femto access point, that is, stores location information and the PLMN ID of the corresponding macro access point, and proceeds to step 1219. The operation performed through steps 1211 to 1219 corresponds to the downlink search operation.

In step 1219, the femto access point determines if the downlink search operation has been completed. As a result of the determination, when the downlink search operation has been completed, the femto access point proceeds to step 1221. In step 1221, the femto access point detects an FA, through which a downlink signal having the best signal quality from among downlink signals having the same PLMN ID as the PLMN ID of the femto access point has been transmitted, based on a result of the downlink search, and determines the detected FA as an FA to be used by the relay unit.

Then, in step 1223, the femto access point selects one FA from the FAs, through which the other downlink signals except for the downlink signal having the best signal quality from among the downlink signals having the same PLMN ID as the PLMN ID of the femto access point have been transmitted, and then determines the selected FA as an FA to be used by the femto access point. The operation performed through steps 1221 to 1223 corresponds to the downlink search operation.

Meanwhile, as described above with reference to FIG. 5, when the FA to be used by the femto access point has been determined based on the frequency use policy of a service provider, steps 1223 and 1221 may be performed in a reversed order. Especially, the above description is based on an assumption that the femto access point uses the same FA as a pre-defined FA to be used by the femto access point itself in step 1223. However, when the macro access point signal has a good quality, which disturbs a sufficient security for the coverage of the femto access point, it is possible to determine the best FA for use by the femto access point unit and then change the setup parameter by transmitting a SETUP PARAMETER CHANGE REQUEST message to the FAP-GW as described above with reference to FIG. 6.

Although the relay unit uses only one FA in the above description, it goes without saying that the relay unit may use multiple FAs. When the relay unit uses multiple FAs, FAs, through which at least two downlink signals including the downlink signal having the best signal quality from among the downlink signals having the same PLMN ID as the PLMN ID of the femto access point have been transmitted, are determined as the FAs to be used by the relay unit.

Meanwhile, when the type of the relay unit is the repeater type using an RF scheme, the operation of determining the FA to be used in the relay unit is omitted from the setup operation. Further, when the type of the relay unit is the repeater type using an IF scheme, the bandwidth used by the relay unit is fixed so that it is impossible to change the number of FAs to be used by the relay unit. The types of the relay unit will be described later in more detail.

The resource management method described above with reference to FIGS. 12 and 13 enables a femto access point to adaptively set FAs to be used by the relay unit and the femto access point unit, thereby increasing the entire service capacity and enabling the setup of a service configuration proper for the situation of the femto access point.

Meanwhile, as described above, a femto access point proposed by the present invention is required to be capable of acquiring location information of a macro access point and a service provider ID (i.e. PLMN ID) in order to share the capacity with a macro access point and manage the resources thereof. It is very important for the femto access point to acquire the location information of a macro access point and a PLMN ID, due to the following reasons:

First, when the service provider does not allow the femto access point to be used in any area other than a preset country or a preset area, the PLMN ID may be used to prevent an operation of the femto access point when the femto access point departs from the preset country or the preset area.

Second, when the femto access point service is provided by the same service provider but each area uses a different frequency, the femto access point can set a service configuration proper for its own situation by using the location information of the macro access point.

Third, when an emergency situation occurs, the femto access point is required to be capable of receiving an emergency broadcast or automatically reporting the emergency situation of the femto access point to a macro access point. To this end, the femto access point is required to have its own location information. In this case, if the femto access point can acquire the location information of a macro access point from the relay unit included in the femto access point, it can acquire the location information of the femto access point itself also in an easy, simple, and stable manner.

Fourth, a relay station usually requires a service provider identification function and an accompanying Network Management System (NMS) function. Since the relay unit included in the femto access point interworks with the femto access point unit, the relay unit can automatically acquire a PLMN ID. Further, by performing an NMS function through a core network connection port included in the femto access point, the relay unit can provide a more stable service in comparison with the case of performing the NMS function through a typical wireless connection, and can reduce the load of a wireless network.

Hereinafter, a method of acquiring a service provider ID and a cell ID by a femto access point according to an embodiment of the present invention will be described with reference to FIG. 14.

FIG. 14 is a flowchart illustrating a method of acquiring a service provider ID and a cell ID by a femto access point according to an embodiment of the present invention.

FIG. 14 is based on an assumption that, when the femto access point does not include a control unit, each of the relay unit and the femto access point unit can independently perform the operation of acquiring a service provider ID (i.e. PLMN ID) and a cell ID. When a macro access point having the PLMN ID of a service provider, a service of which the femto access point provides, does not exist around the femto access point, the relay unit should acquire the PLMN ID in order to prevent the femto access point from operating in a relay mode. In contrast, the femto access point unit requires information of neighbor macro access points (including cell IDs) in order to identify the location of itself during the registration of the femto access point.

Further, the cell ID is the only ID for identifying the cell within one PLMN and can be implemented with, for example, 28 bits. Since the cell ID has been registered in the CN, the femto access point can identify the location information of the cell by acquiring the cell ID. When a macro access point has a three sector structure or a single sector structure, each sector may serve as a cell. Also, when a macro access point uses multiple FAs in each sector, each of the multiple FAs may serve as a cell. A detailed description of the cell has no direct relation to the present invention and will be omitted here.

Referring to FIG. 14, first in step 1311, the femto access point receives downlink signals of all macro access points in the unit of a preset frequency, for example, for each 200 kHz or for each FA. Then, in step 1313, the femto access point detects a Primary Common Pilot Channel (P-CPICH) signal from the received downlink signal of the macro access point and measures the quality of the P-CPICH signal, such as Ec/To and RSCP.

Then, in step 1315, the femto access point detects a Primary Synchronization Channel (P-SCH) signal from a downlink signal (hereinafter, referred to as “reference downlink signal”) including a P-CPICH signal having the best signal quality, and determines, by using the P-SCH signal, if it is possible to acquire slot timing information. As a result of the determination, when it is impossible to acquire slot timing information, the femto access point returns to step 1311.

As a result of the determination in step 1315, when it is possible to acquire slot timing information, the femto access point proceeds to step 1317. In step 1317, since the femto access point has already acquired the slot timing, the femto access point detects a Secondary Synchronization Channel (S-SCH) signal from the reference downlink signal and acquires a frame boundary and Primary Scrambling Code (PSC) group information by using the S-SCH.

In step 1319, the femto access point detects a CPICH signal from the reference downlink signal and acquires a PSC by using the CPICH signal. In step 1321, the femto access point detects a Primary Common Control Physical Channel (P-CCPCH) signal from the reference downlink signal and acquires system information including a PLMN ID by decoding the P-CCPCH. Then, in step 1323, the femto access point determines if the operation of acquiring the PLMN ID and cell ID has been completed. As a result of the determination, when the operation of acquiring the PLMN ID and cell ID has not been completed, the femto access point returns to step 1311.

In general, the femto access point requires an exact reference signal. However, in consideration of various conditions including the price, volume, etc., the femto access point cannot use an oscillator, which is relatively expensive. Therefore, it is possible to consider use of a synchronization module of Institute of Electrical and Electronics Engineers (IEEE)-1588 standards, a Global Positioning System (GPS), or an Assisted Global Positioning System (AGPS). However, each of the synchronization module of IEEE-1588 standards, GPS, and AGPS is a separate unit that should be additionally included in the femto access point.

Therefore, the present invention proposes a synchronization providing method, which enables generation of an exact reference signal without addition of a separate unit. That is, the present invention enables a femto access point, which generally provides a service in a shaded area, to generate an exact reference signal, which is exactly synchronized with the macro access point, without addition of a separate unit.

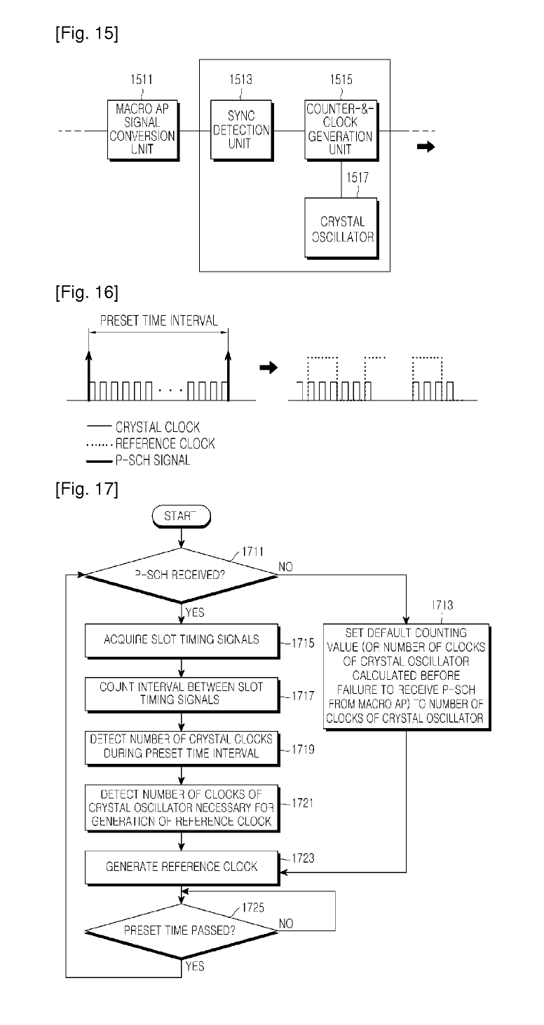

Hereinafter, a method of providing synchronization by a femto access point according to an embodiment of the present invention will be described with reference to FIGS. 15 to 17. As a presumption before the description of FIGS. 15 to 17, since the operation of providing synchronization by a femto access point is an operation of generating a reference signal to be used by the femto access point regardless of whether the femto access point includes a control unit, it is okay if the operation of providing synchronization is performed by either the relay unit or the femto access point unit.

FIG. 15 is a block diagram illustrating an internal structure of a reference signal generation unit that provides the reference signal in a femto access point according to an embodiment of the present invention.

Referring to FIG. 15, the reference signal generation unit includes a macro access point conversion unit 1511, a synchronization detection unit 1513, a counter-and-clock generation unit 1515, and a crystal oscillator 1517.

First, the macro access point conversion unit 1511 receives a downlink signal from a macro access point, converts the received downlink signal to a baseband signal, and then outputs the converted baseband signal to the synchronization detection unit 1513. The synchronization detection unit 1513 receives the signal output from the macro access point conversion unit 1511, detects a synchronization from the received signal, and then outputs the synchronization signal to the counter-and-clock generation unit 1515. The synchronization signal of the macro access point can be detected from the P-SCH. Since the P-SCH includes 15 slots in each frame with a period of 10 ms, each frame includes 15 slot timing signals.

The counter-and-clock generation unit 1515 receives the synchronization signal from the synchronization detection unit 1513 and counts crystal clocks in the synchronization signal, so as to determine how many crystal clocks exist during a predetermined time interval. By using the determined number of crystal clocks, the counter-and-clock generation unit 1515 calculates how many clocks of the crystal oscillator 1517 are required in order to generate a reference clock. Further, the counter-and-clock generation unit 1515 generates a reference clock based on the calculated number of clocks of the crystal oscillator 1517.

Meanwhile, if the femto access point can monitor a downlink signal of a macro access point in real time, the femto access point can calibrate the reference clock in real time also. Further, the reference signal generation unit generates a reference clock by using a preset default counting value at an initial stage and then generates the reference clock as described above from the time point when it can receive a downlink signal from a macro access point.

Further, the reference signal generation unit may be unable to receive a downlink signal from the macro access point while the reference signal generation unit generates a reference clock. Then, the reference signal generation unit generates the reference signal according to the number of clocks of the crystal oscillator 1517 calculated before the time point when it became unable to receive a downlink signal from the macro access point.

Hereinafter, the relation between the P-SCH signal described above with reference to FIG. 15, the clock of the crystal oscillator 1517, and the reference clock generated by the counter-and-clock generation unit 1515 will be discussed with reference to FIG. 16.

FIG. 16 is a timing diagram illustrating the relation between the P-SCH signal, the clock of the crystal oscillator 1517, and the reference clock generated by the counter-and-clock generation unit 1515.

Referring to FIG. 16, a reference clock is generated by using the P-SCH signal and the clock of the crystal oscillator 1517.

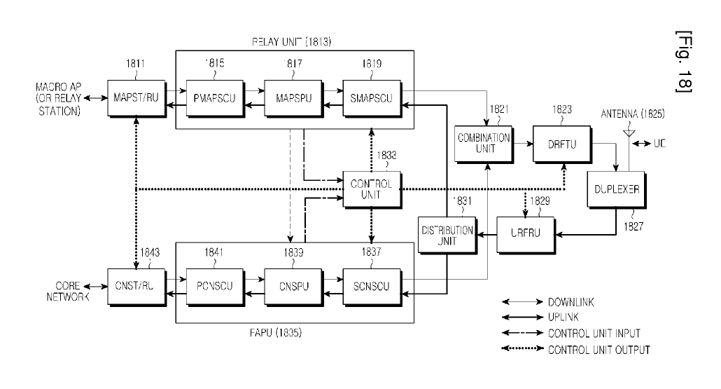

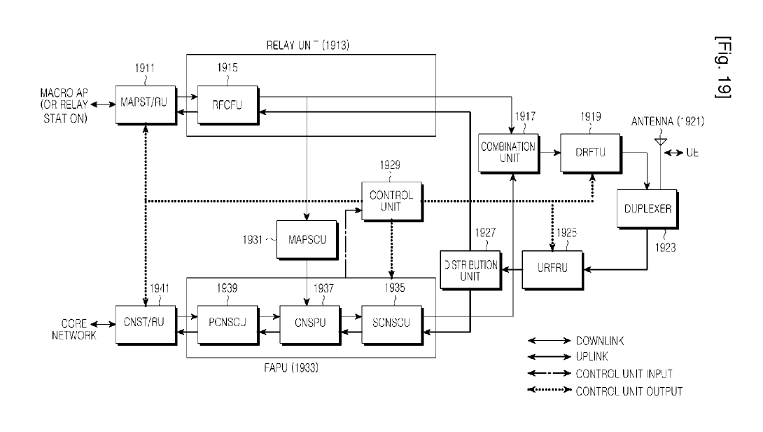

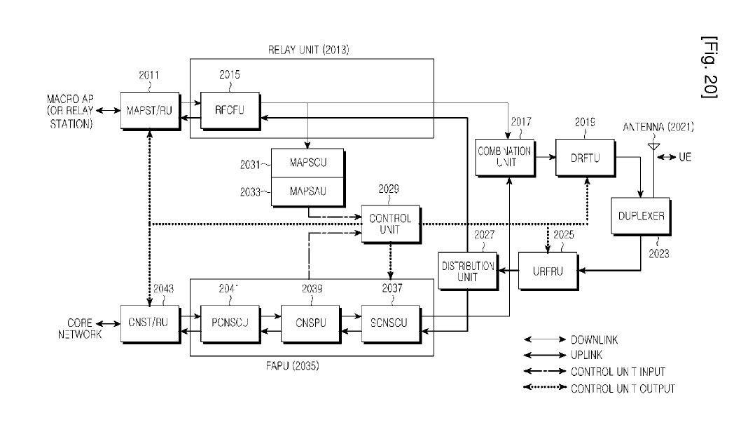

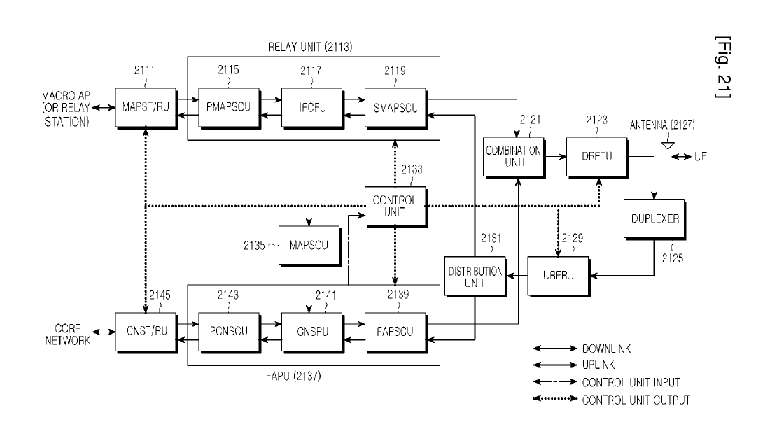

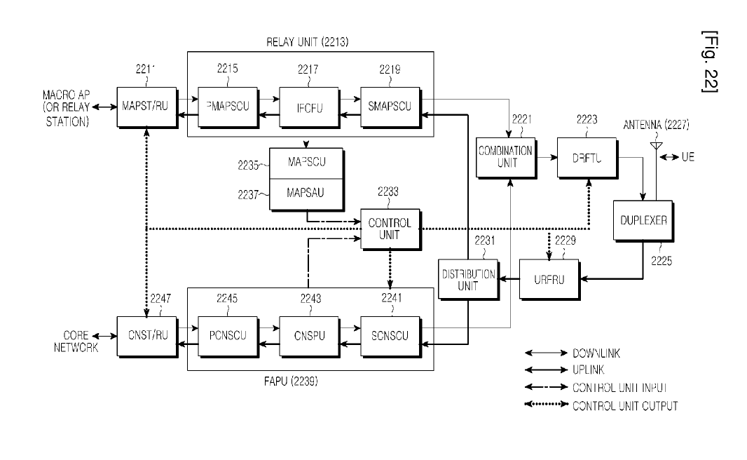

Next, a method of generating a reference clock by the reference signal generation unit of FIG. 15 will be described with reference to FIG. 17.

FIG. 17 is a flowchart illustrating a process of generating a reference clock by the reference signal generation unit of FIG. 15.

Referring to FIG. 17, in step 1711, the reference signal generation unit determines if a P-SCH signal has been received. As a result of the determination, when a P-SCH signal has not been received, the reference signal generation unit proceeds to step 1713. The cases when a P-SCH signal has not been received includes two cases including a case when the reference signal generation unit is initialized and generates a reference clock for the first time and a case when the reference signal generation unit fails to receive a P-SCH signal from a macro access point while it generates the reference clock.

In step 1713, since a P-SCH signal has been received, the reference signal generation unit sets the default counting value or the number of clocks of the crystal oscillator, which has been calculated before the time point when it became unable to receive the P-SCH signal from the macro access point, as the number of clocks of the crystal oscillator, and proceeds to step 1723. The case in which the default counting value is set as the number of clocks of the crystal oscillator corresponds to a case in which the reference signal generation unit is initialized and generates a reference clock for the first time. Also, the case in which the number of clocks of the crystal oscillator, which has been calculated before the time point when it became unable to receive the P-SCH signal from the macro access point, is set as the number of clocks of the crystal oscillator corresponds to a case in which the reference signal generation unit fails to receive a P-SCH signal from a macro access point while it generates the reference clock.

In the meantime, as a result of the determination in step 1711, when a P-SCH signal has been received, the reference signal generation unit proceeds to step 1715. In step 1715, the reference signal generation unit acquires slot timing signals from the received P-SCH signal. Then, in step 1717, the reference signal generation unit calculates the interval between the slot timing signals. In step 1719, the reference signal generation unit detects, by using the counted number of clocks, how many crystal clocks exist during a preset time period.

Then, in step 1721, by using the detected number of crystal clocks, the reference signal generation unit calculates how many clocks of the crystal oscillator are required in order to generate a reference clock. In step 1723, the reference signal generation unit generates a reference clock based on the calculated number of clocks of the crystal oscillator.

Then, in step 1725, the reference signal generation unit determines if a preset time has passed. As a result of the determination, when a preset time has passed, the reference signal generation unit returns to step 1711. The preset time is a period of time determined in advance in order to calibrate the reference clock and can be changed in accordance with the situation of the femto access point. That is, since the femto access point can monitor the downlink signal of the femto access point in real time, the femto access point calibrates the reference clock at each preset time.

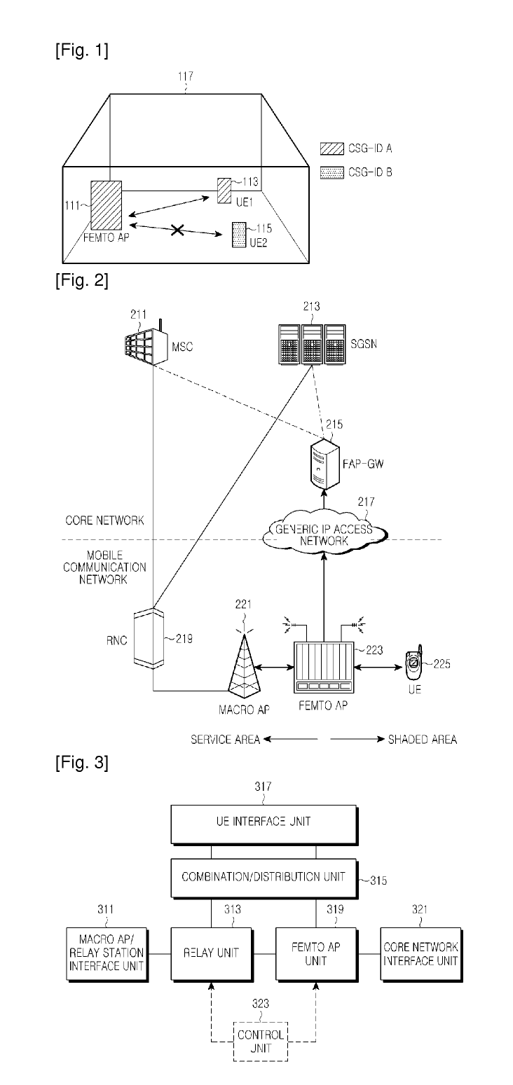

When a femto access point operates as described above with reference to FIGS. 1 to 17, the femto access point can provide an interface for a UE, an interface for a macro access point, and an interface for a core network.

Next, an internal structure of a femto access point proposed by the present invention will be described with reference to FIGS. 18 to 28.

FIG. 18 is a block diagram illustrating an internal structure of a femto access point according to an embodiment of the present invention.

For convenience, in FIGS. 18 to 28, a macro AP signal transmission/reception unit is illustrated as MAPST/RU, a primary macro AP signal conversion unit is illustrated as PMAPSCU, a macro AP signal processor unit is illustrated as MAPSPU, a secondary macro AP signal conversion unit is illustrated as SMAPSCU, a downlink RF transmission unit is illustrated as DRFTU, a uplink RF reception unit is illustrated as URFRU, a femto AP unit is illustrated as FAPU, a secondary core network signal conversion unit is illustrated as SCNSCU, a core network signal processor unit is illustrated as CNSPU, a primary core network signal conversion unit is illustrated as PCNSCU, a core network signal transmission/reception unit is illustrated as CNST/RU, a RF channel filter unit is illustrated as RFCFU, a downlink RF transmission unit is illustrated as DRFTU, a uplink RF reception unit is illustrated as IURFRU, a macro AP signal conversion unit is illustrated as MAPSCU, a macro AP signal analysis unit is illustrated as MAPSAU, an IF channel filter unit is illustrated as IFCFU, a digital filter unit is illustrated as DFU, a signal processor unit is illustrated as SPU, and a digital signal processor unit is illustrated as DSPU.

Referring to FIG. 18, the femto access point includes a macro access point signal transmission/reception unit 1811, a relay unit 1813, a combination unit 1821, a downlink RF transmission unit 1823, an antenna 1825, a duplexer 1827, an uplink RF reception unit 1829, a distribution unit 1831, a control unit 1833, a femto access point unit 1835, and a core network signal transmission/reception unit 1843. The relay unit 1813 includes a primary macro access point signal conversion unit 1815, a macro access point signal processor unit 1817, and a secondary macro access point signal conversion unit 1819, and the femto access point unit 1835 includes a primary core network signal conversion unit 1841, a core network signal processor unit 1839, and a secondary core network signal conversion unit 1837.

First, the macro access point signal transmission/reception unit 1811 receives a downlink signal from a macro access point and outputs the downlink signal to the primary macro access point signal conversion unit 1815 or receives an uplink signal from the primary macro access point signal conversion unit 1815 and transmits the uplink signal to the macro access point.

The primary macro access point signal conversion unit 1815 performs a primary conversion of the downlink signal output from the macro access point signal transmission/reception unit 1811 to a macro access point signal and then outputs the primary-converted macro access point signal to the macro access point signal processor unit 1817, or performs a primary conversion of the uplink signal output from the macro access point signal processor unit 1817 to a macro access point signal and then outputs the primary-converted macro access point signal to the macro access point signal transmission/reception unit 1811. As used herein, the primary conversion of the downlink signal refers to a conversion of an RF signal to an IF band signal or a baseband signal, and the primary conversion of the uplink signal refers to a conversion of an IF signal or a baseband signal to an RF signal. The macro access point signal processor unit 1817 performs signal processing of the signal output from the primary macro access point signal conversion unit 1815 and outputs the processed signal to the secondary macro access point signal conversion unit 1819, or performs signal processing of the signal output from the secondary macro access point signal conversion unit 1819 and outputs the processed signal to the primary macro access point signal conversion unit 1815.

The secondary macro access point signal conversion unit 1819 performs a secondary conversion of the signal output from the macro access point signal processor unit 1817 to a macro access point signal and then outputs the secondary-converted macro access point signal to the combination unit 1821, or performs a secondary conversion of the signal output from the distribution unit 1831 to a macro access point signal and then outputs the secondary-converted macro access point signal to the macro access point signal processor unit 1817. As used herein, the secondary conversion of a downlink signal to a macro access point signal refers to a conversion of an IF band signal or a baseband signal to an RF signal, and the secondary conversion of an uplink signal to a macro access point signal refers to a conversion of an RF signal to an IF signal or a baseband signal.

The combination unit 1821 combines the signal output from the secondary macro access point signal conversion unit 1819 with a signal output from the secondary core network signal conversion unit 1837 and outputs the combined signal to the downlink RF transmission unit 1823. The downlink RF transmission unit 1823 performs RF transmission processing of the signal output from the combination unit 1821 and then outputs the processed signal to the duplexer 1827. The duplexer 1827 transmits the signal output from the downlink RF transmission unit 1823 to a corresponding UE through the antenna 1825 at a corresponding time point.

Meanwhile, a signal received from the UE through the antenna 1825 is output to the duplexer 1827, and the duplexer 1827 outputs the signal received through the antenna 1825 to the uplink RF reception unit 1829 at a corresponding time point. The uplink RF reception unit 1829 performs an incoming signal RF processing of the signal output from the duplexer 1827 and then outputs the processed signal to the distribution unit 1831. The distribution unit 1831 determines the unit to which the signal output from the uplink RF reception unit 1829 should be distributed, and then outputs the signal to the secondary macro access point signal conversion unit 1819 or the secondary core network signal conversion unit 1837. The distribution unit 1831 outputs the uplink signal received from the UE to the secondary macro access point signal conversion unit 1819 when the uplink signal received from the UE should be transmitted through the relay unit 1813, and the uplink signal received from the UE to the secondary core network signal conversion unit 1837 when the uplink signal received from the UE should be transmitted through the femto access point unit 1835.

The secondary core network signal conversion unit 1837 performs a secondary conversion of the signal output from the distribution unit 1831 to a core network signal and then outputs the secondary-converted core network signal to the core network signal processor unit 1839, or performs a secondary conversion of the signal output from the core network signal processor unit 1839 to a core network signal and then outputs the secondary-converted core network signal to the distribution unit 1831. As used herein, the secondary conversion of a downlink signal to a core network signal refers to a conversion of a baseband digital signal to an RF signal, and the secondary conversion of an uplink signal to a core network signal refers to a conversion of an RF signal to a baseband digital signal.

The core network signal processor unit 1839 performs signal processing of the signal output from the secondary core network signal conversion unit 1837 and then outputs the processed signal to the primary core network signal conversion unit 1841, or performs signal processing of the signal output from the primary core network signal conversion unit 1841 and then outputs the processed signal to the secondary core network signal conversion unit 1837.

The primary core network signal conversion unit 1841 performs a primary conversion of the signal output from the core network signal processor unit 1839 to a core network signal and then outputs the primary-converted core network signal to the core network signal transmission/reception unit 1843, or performs a primary conversion of the signal output from the core network signal transmission/reception unit 1843 to a core network signal and then outputs the primary-converted core network signal to the core network signal processor unit 1839. As used herein, the primary conversion of a downlink signal to a core network signal refers to a process of extracting data relating to a wireless service from a network protocol signal, such as a Transmission control Protocol/Internet Protocol (TCP/IP) signal, and converting the data to a baseband digital signal, and the primary conversion of an uplink signal to a core network signal refers to a process of converting a baseband digital signal in accordance with a network protocol.

The core network signal transmission/reception unit 1843 transmits the signal output from the primary core network signal conversion unit 1841 to a core network, or outputs a signal received through the core network to the primary core network signal conversion unit 1841.

Further, the control unit 1833 controls the operations of the macro access point signal transmission/reception unit 1811, the relay unit 1813, the downlink RF transmission unit 1823, the uplink RF reception unit 1829, the femto access point unit 1835, and the core network signal transmission/reception unit 1843. Various control operations performed by the control unit 1833 are based on the signals output from the relay unit 1813 and the femto access point unit 1835 and received by the control unit 1833, and a detailed description of them has been already described above and is thus omitted here.

In the meantime, when parameters relating to the control operations have been already determined by the service provider and the femto access point provides limited services as described above, the femto access point may not include the control unit 1833. Hereinafter, a method of relaying a downlink signal received from a macro access point to a UE by a femto access point when the femto access point is in a relay mode will be first described.

First, the macro access point signal transmission/reception unit 1811 receives a downlink signal from a macro access point and outputs the downlink signal to the primary macro access point signal conversion unit 1815. The primary macro access point signal conversion unit 1815 primary-converts the signal output from the macro access point signal transmission/reception unit 1811 to a macro access point signal and then outputs the converted macro access point signal to the macro access point signal processor unit 1817. The macro access point signal processor unit 1817 processes the signal output from the primary macro access point signal conversion unit 1815 and outputs the processed signal to the secondary macro access point signal conversion unit 1819. The secondary macro access point signal conversion unit 1819 secondary-converts the signal output from the macro access point signal processor unit 1817 to a macro access point signal and then outputs the converted macro access point signal to the combination unit 1821.

The combination unit 1821 combines the signal output from the secondary macro access point signal conversion unit 1819 with the signal output from the secondary core network signal conversion unit 1837 and then outputs the combined signal to the downlink RF transmission unit 1823. The downlink RF transmission unit 1823 performs an outgoing signal RF processing of the signal output from the combination unit 1821 and then outputs the processed signal to the duplexer 1827. The duplexer 1827 transmits the signal output from the downlink RF transmission unit 1823 to a corresponding UE through the antenna 1825 at a corresponding time point.

Second, a method of relaying an uplink signal received from a UE to a macro access point by a femto access point when the femto access point is in a relay mode will be described.

When an uplink signal from a corresponding UE is received through the antenna 1825, the uplink signal received through the antenna 1825 is output to the duplexer 1827. The duplexer 1827 outputs the uplink signal output from the antenna 1825 to the uplink RF reception unit 1829 at a corresponding time point. The uplink RF reception unit 1829 performs an incoming signal RF processing of the signal output from the duplexer 1827 and outputs the processed signal to the distribution unit 1831. The distribution unit 1831 outputs the signal output from the uplink RF reception unit 1829 to the secondary macro access point signal conversion unit 1819.

The secondary macro access point signal conversion unit 1819 performs a secondary conversion of the signal output from the distribution unit 1831 to a macro access point signal and outputs the converted macro access point signal to the macro access point signal processor unit 1817. The macro access point signal processor unit 1817 processes the signal output from the secondary macro access point signal conversion unit 1819 and then outputs the processed signal to the primary macro access point signal conversion unit 1815. The primary macro access point signal conversion unit 1815 performs a primary conversion of the signal output from the macro access point signal processor unit 1817 to a macro access point signal and outputs the converted macro access point signal to the macro access point signal transmission/reception unit 1811. The macro access point signal transmission/reception unit 1811 transmits the signal output from the primary macro access point signal conversion unit 1815 to a corresponding macro access point (or a relay station).

Third, a method of transmitting a downlink signal received from a core network to a UE by a femto access point when the femto access point is in a femto access point mode will be described.

The core network signal transmission/reception unit 1843 receives a downlink signal from the core network, and then outputs the received downlink signal to the primary core network signal conversion unit 1841. The primary core network signal conversion unit 1841 performs a primary conversion of the signal output from the core network signal transmission/reception unit 1843 to a core network signal and outputs the converted core network signal to the core network signal processor unit 1839. The core network signal processor unit 1839 processes the signal output from the primary core network signal conversion unit 1841 and outputs the processed signal to the secondary core network signal conversion unit 1837. The secondary core network signal conversion unit 1837 performs a secondary conversion of the signal output from the core network signal processor unit 1839 to a core network signal and outputs the converted core network signal to the combination unit 1821.

The combination unit 1821 combines the signal output from the secondary core network signal conversion unit 1837 with the signal output from the secondary macro access point signal conversion unit 1819 and then outputs the combined signal to the downlink RF transmission unit 1823. The downlink RF transmission unit 1823 performs an outgoing signal RF processing of the signal output from the combination unit 1821 and then outputs the processed signal to the duplexer 1827. The duplexer 1827 transmits the signal output from the downlink RF transmission unit 1823 to a corresponding UE through the antenna 1825 at a corresponding time point.

Fourth, a method of transmitting an uplink signal received from a UE to a core network by a femto access point when the femto access point is in a femto access point mode will be described.

When an uplink signal from a corresponding UE is received through the antenna 1825, the uplink signal received through the antenna 1825 is output to the duplexer 1827. The duplexer 1827 outputs the uplink signal output from the antenna 1825 to the uplink RF reception unit 1829 at a corresponding time point. The uplink RF reception unit 1829 performs an incoming signal RF processing of the signal output from the duplexer 1827 and outputs the processed signal to the distribution unit 1831. The distribution unit 1831 outputs the signal output from the uplink RF reception unit 1829 to the secondary core network signal conversion unit 1837. The secondary core network signal conversion unit 1837 performs a secondary conversion of the signal output from the distribution unit 1831 and then outputs the converted signal to the core network signal processor unit 1839. The core network signal processor unit 1839 processes the signal output from the secondary core network signal conversion unit 1837 and outputs the processed signal to the primary core network signal conversion unit 1841. The primary core network signal conversion unit 1841 performs a primary conversion of the signal output from the core network signal processor unit 1839 and then outputs the converted signal to the core network signal transmission/reception unit 1843. The core network signal transmission/reception unit 1843 transmits the signal output from the primary core network signal conversion unit 1841 to the core network.

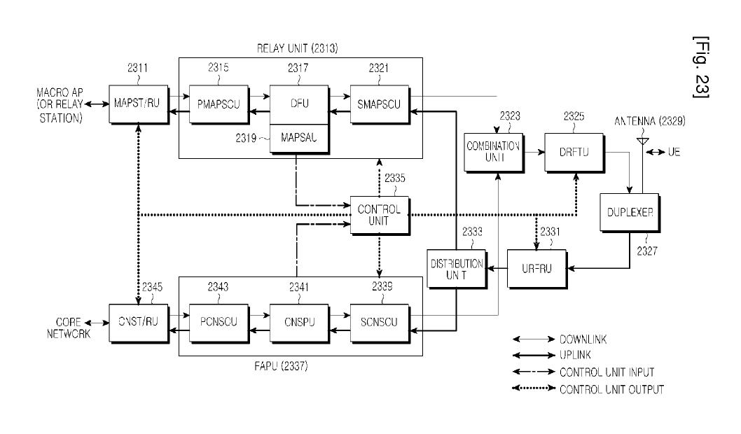

FIG. 19 is a block diagram illustrating an internal structure of a femto access point according to another embodiment of the present invention.

It should be noted that the internal structure of the femto access point shown in FIG. 19 corresponds to an internal structure in which the relay unit has an RF repeater type. Further, when the relay unit is a unit of the RF repeater type, since the relay unit does not include a DSP capable of analyzing a baseband signal, it is necessary to add a DSP in the relay unit or to use the DSP included in a femto access point unit. FIG. 19 is based on an assumption that the relay unit does not include a DSP and uses the DSP included in a femto access point unit.

Referring to FIG. 19, the femto access point includes a macro access point signal transmission/reception unit 1911, a relay unit 1913, a combination unit 1917, a downlink RF transmission unit 1919, an antenna 1921, a duplexer 1923, an uplink RF reception unit 1925, a distribution unit 1927, a control unit 1929, a macro access point signal conversion unit 1931, a femto access point unit 1933, and a core network signal transmission/reception unit 1941. The relay unit 1913 includes an RF channel filter unit 1915, and the femto access point unit 1933 includes a primary core network signal conversion unit 1939, a core network signal processor unit 1937, and a secondary core network signal conversion unit 1935. The RF channel filter unit 1915 includes a channel filter and an amplifier.

First, the macro access point signal transmission/reception unit 1911 receives a downlink signal from a macro access point and outputs the downlink signal to the RF channel filter unit 1915 or receives an uplink signal from the RF channel filter unit 1915 and transmits the uplink signal to the macro access point.

The RF channel filter unit 1915 extracts only an RF signal by RF channel-filtering the downlink signal output from the macro access point signal transmission/reception unit 1911 and then outputs the extracted RF signal to the combination unit 1917 and the macro access point signal conversion unit 1931 or receives a signal from the distribution unit 1927 and outputs the received signal to the macro access point signal transmission/reception unit 1911.

The combination unit 1917 combines the signal output from the RF channel filter unit 1915 with a signal output from the secondary core network signal conversion unit 1935 and outputs the combined signal to the downlink RF transmission unit 1919. The downlink RF transmission unit 1919 performs RF transmission processing of the signal output from the combination unit 1917 and then outputs the processed signal to the duplexer 1923. The duplexer 1923 transmits the signal output from the downlink RF transmission unit 1919 to a corresponding UE through the antenna 1921 at a corresponding time point.

Meanwhile, a signal received from the UE through the antenna 1921 is output to the duplexer 1923, and the duplexer 1923 outputs the signal received through the antenna 1921 to the uplink RF reception unit 1925 at a corresponding time point. The uplink RF reception unit 1925 performs an incoming signal RF processing of the signal output from the duplexer 1923 and then outputs the processed signal to the distribution unit 1927. The distribution unit 1927 determines the unit to which the signal output from the uplink RF reception unit 1925 should be distributed, and then outputs the signal to the RF channel filter unit 1915 or the secondary core network signal conversion unit 1935. The distribution unit 1927 outputs the uplink signal received from the UE to the RF channel filter unit 1915 when the uplink signal received from the UE should be transmitted through the relay unit 1913, and outputs the uplink signal received from the UE to the secondary core network signal conversion unit 1935 when the uplink signal received from the UE should be transmitted through the femto access point unit 1933.

The secondary core network signal conversion unit 1935 performs a secondary conversion of the signal output from the distribution unit 1927 to a core network signal and then outputs the secondary-converted core network signal to the core network signal processor unit 1937, or performs a secondary conversion of the signal output from the core network signal processor unit 1937 to a core network signal and then outputs the secondary-converted core network signal to the distribution unit 1927. The core network signal processor unit 1937 performs signal processing of the signal output from the secondary core network signal conversion unit 1935 and then outputs the processed signal to the primary core network signal conversion unit 1939, or performs signal processing of the signal output from the primary core network signal conversion unit 1939 and then outputs the processed signal to the secondary core network signal conversion unit 1935.

The primary core network signal conversion unit 1939 performs a primary conversion of the signal output from the core network signal processor unit 1937 to a core network signal and then outputs the primary-converted core network signal to the core network signal transmission/reception unit 1941, or performs a primary conversion of the signal output from the core network signal transmission/reception unit 1941 to a core network signal and then outputs the primary-converted core network signal to the core network signal processor unit 1937. The core network signal transmission/reception unit 1941 transmits the signal output from the primary core network signal conversion unit 1939 to a core network, or outputs a signal received through the core network to the primary core network signal conversion unit 1939.

Further, the control unit 1929 controls the operations of the macro access point signal transmission/reception unit 1911, the downlink RF transmission unit 1919, the uplink RF reception unit 1925, the femto access point unit 1933, and the core network signal transmission/reception unit 1941. Various control operations performed by the control unit 1929 are based on the signals output from the femto access point unit 1933 and received by the control unit 1929, and a detailed description of them has been already described above and is thus omitted here.

In the meantime, when parameters relating to the control operations have been already determined by the service provider and the femto access point provides limited services as described above, the femto access point may not include the control unit 1929.

Further, the macro access point signal conversion unit 1931 receives the signal output from the RF channel filter unit 1915, converts the received signal to a macro access point signal, and outputs the converted signal to the core network signal processor unit 1937. That is, since the relay unit 1913 does not include a DSP, the core network signal processor unit 1937 is used to analyze the macro access point signal.

Hereinafter, a method of relaying a downlink signal received from a macro access point to a UE by a femto access point when the femto access point is in a relay mode will be first described.

First, the macro access point signal transmission/reception unit 1911 receives a downlink signal from a macro access point and outputs the downlink signal to the RF channel filter unit 1915. The RF channel filter unit 1915 converts the signal output from the macro access point signal transmission/reception unit 1911 to an RF signal through RF channel filtering and outputs the converted signal to the combination unit 1917 and the macro access point signal conversion unit 1931.

The combination unit 1917 combines the signal output from the RF channel filter unit 1915 with the signal output from the secondary core network signal conversion unit 1935 and then outputs the combined signal to the downlink RF transmission unit 1919. The downlink RF transmission unit 1919 performs an outgoing signal RF processing of the signal output from the combination unit 1917 and then outputs the processed signal to the duplexer 1923. The duplexer 1923 transmits the signal output from the downlink RF transmission unit 1919 to a corresponding UE through the antenna 1921 at a corresponding time point.

Second, a method of relaying an uplink signal received from a UE to a macro access point by a femto access point when the femto access point is in a relay mode will be described.

When an uplink signal from a corresponding UE is received through the antenna 1921, the uplink signal received through the antenna 1921 is output to the duplexer 1923. The duplexer 1923 outputs the uplink signal output from the antenna 1921 to the uplink RF reception unit 1925 at a corresponding time point. The uplink RF reception unit 1925 performs an incoming signal RF processing of the signal output from the duplexer 1923 and outputs the processed signal to the distribution unit 1927. The distribution unit 1927 outputs the signal output from the uplink RF reception unit 1925 to the RF channel filter unit 1915. The RF channel filter unit 1915 converts the signal output from the distribution unit 1927 to an RF signal through RF channel filtering and then outputs the converted signal to the macro access point signal transmission/reception unit 1911. The macro access point signal transmission/reception unit 1911 transmits the signal output from the RF channel filter unit 1915 to a corresponding macro access point (or a relay station).

Third, a method of transmitting a downlink signal received from a core network to a UE by a femto access point when the femto access point is in a femto access point mode will be described.

The core network signal transmission/reception unit 1941 receives a downlink signal from the core network, and then outputs the received downlink signal to the primary core network signal conversion unit 1939. The primary core network signal conversion unit 1939 performs a primary conversion of the signal output from the core network signal transmission/reception unit 1941 to a core network signal and outputs the converted core network signal to the core network signal processor unit 1937. The core network signal processor unit 1937 processes the signal output from the primary core network signal conversion unit 1939 and outputs the processed signal to the secondary core network signal conversion unit 1935. The secondary core network signal conversion unit 1935 performs a secondary conversion of the signal output from the core network signal processor unit 1937 to a core network signal and outputs the converted core network signal to the combination unit 1917.

The combination unit 1917 combines the signal output from the secondary core network signal conversion unit 1935 with the signal output from the RF channel filter unit 1915 and then outputs the combined signal to the downlink RF transmission unit 1919. The downlink RF transmission unit 1919 performs an outgoing signal RF processing of the signal output from the combination unit 1917 and then outputs the processed signal to the duplexer 1923. The duplexer 1923 transmits the signal output from the downlink RF transmission unit 1919 to a corresponding UE through the antenna 1921 at a corresponding time point.

Fourth, a method of transmitting an uplink signal received from a UE to a core network by a femto access point when the femto access point is in a femto access point mode will be described.

When an uplink signal from a corresponding UE is received through the antenna 1921, the uplink signal received through the antenna 1921 is output to the duplexer 1923. The duplexer 1923 outputs the uplink signal output from the antenna 1921 to the uplink RF reception unit 1925 at a corresponding time point. The uplink RF reception unit 1925 performs an incoming signal RF processing of the signal output from the duplexer 1923 and outputs the processed signal to the distribution unit 1927. The distribution unit 1927 outputs the signal output from the uplink RF reception unit 1925 to the secondary core network signal conversion unit 1935. The secondary core network signal conversion unit 1935 performs a secondary conversion of the signal output from the distribution unit 1927 to a core network signal and then outputs the converted signal to the core network signal processor unit 1937. The core network signal processor unit 1937 processes the signal output from the secondary core network signal conversion unit 1935 and outputs the processed signal to the primary core network signal conversion unit 1939. The primary core network signal conversion unit 1939 performs a primary conversion of the signal output from the core network signal processor unit 1937 to a core network signal and then outputs the converted signal to the core network signal transmission/reception unit 1941. The core network signal transmission/reception unit 1941 transmits the signal output from the primary core network signal conversion unit 1939 to the core network.

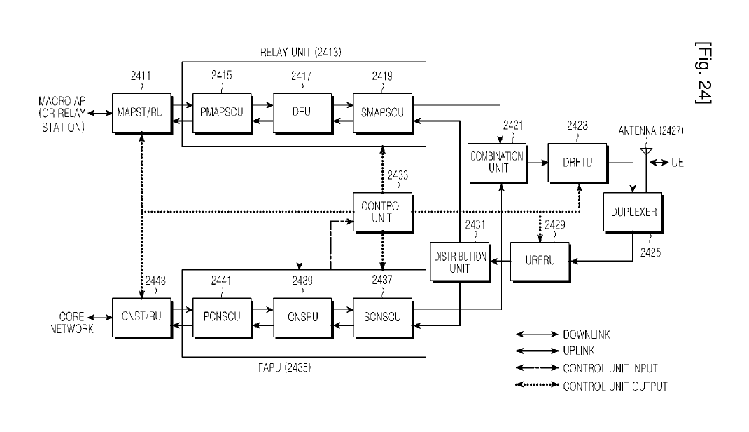

FIG. 20 is a block diagram illustrating an internal structure of a femto access point according to another embodiment of the present invention.

It should be noted that the internal structure of the femto access point shown in FIG. 20 corresponds to an internal structure in which the relay unit has an RF repeater type. Further, when the relay unit is a unit of the RF repeater type, since the relay unit does not include a DSP capable of analyzing a baseband signal, it is necessary to add a DSP in the relay unit or to use the DSP included in a femto access point unit. FIG. 20 is based on an assumption that the relay unit does not include a DSP and uses the DSP included in a femto access point unit. FIG. 20 is based on an assumption that the relay unit includes a separate DSP.

Referring to FIG. 20, the femto access point includes a macro access point signal transmission/reception unit 2011, a relay unit 2013, a combination unit 2017, a downlink RF transmission unit 2019, an antenna 2021, a duplexer 2023, an uplink RF reception unit 2025, a distribution unit 2027, a control unit 2029, a femto access point unit 2035, and a core network signal transmission/reception unit 2043. The relay unit 2013 includes an RF channel filter unit 2015, a macro access point signal conversion unit 2031, and a macro access point signal analysis unit 2033, and the femto access point unit 2035 includes a primary core network signal conversion unit 2041, a core network signal processor unit 2039, and a secondary core network signal conversion unit 2037.

First, the macro access point signal transmission/reception unit 2011 receives a downlink signal from a macro access point and outputs the downlink signal to the RF channel filter unit 2015 or receives an uplink signal from the RF channel filter unit 2015 and transmits the uplink signal to the macro access point.

The RF channel filter unit 2015 generates an RF signal by RF channel-filtering the downlink signal output from the macro access point signal transmission/reception unit 2011 and then outputs the generated RF signal to the combination unit 2017 and the macro access point signal conversion unit 2031 or receives a signal from the distribution unit 2027 and outputs the received signal to the macro access point signal transmission/reception unit 2011.

The combination unit 2017 combines the signal output from the RF channel filter unit 2015 with a signal output from the secondary core network signal conversion unit 2037 and outputs the combined signal to the downlink RF transmission unit 2019. The downlink RF transmission unit 2019 performs RF transmission processing of the signal output from the combination unit 2017 and then outputs the processed signal to the duplexer 2023. The duplexer 2023 transmits the signal output from the downlink RF transmission unit 2019 to a corresponding UE through the antenna 2021 at a corresponding time point.

Meanwhile, a signal received from the UE through the antenna 2021 is output to the duplexer 2023, and the duplexer 2023 outputs the signal received through the antenna 2021 to the uplink RF reception unit 2025 at a corresponding time point. The uplink RF reception unit 2025 performs an incoming signal RF processing of the signal output from the duplexer 2023 and then outputs the processed signal to the distribution unit 2027. The distribution unit 2027 determines the unit to which the signal output from the uplink RF reception unit 2025 should be distributed, and then outputs the signal to the RF channel filter unit 2015 or the secondary core network signal conversion unit 2037. The distribution unit 2027 outputs the uplink signal received from the UE to the RF channel filter unit 2015 when the uplink signal received from the UE should be transmitted through the relay unit 2013, and outputs the uplink signal received from the UE to the secondary core network signal conversion unit 2037 when the uplink signal received from the UE should be transmitted through the femto access point unit 2035.

The secondary core network signal conversion unit 2037 performs a secondary conversion of the signal output from the distribution unit 2027 to a core network signal and then outputs the secondary-converted core network signal to the core network signal processor unit 2039, or performs a secondary conversion of the signal output from the core network signal processor unit 2039 to a core network signal and then outputs the secondary-converted core network signal to the distribution unit 2027. The core network signal processor unit 2039 performs signal processing of the signal output from the secondary core network signal conversion unit 2037 and then outputs the processed signal to the primary core network signal conversion unit 2041, or performs signal processing of the signal output from the primary core network signal conversion unit 2041 and then outputs the processed signal to the secondary core network signal conversion unit 2037.

The primary core network signal conversion unit 2041 performs a primary conversion of the signal output from the core network signal processor unit 2039 to a core network signal and then outputs the primary-converted core network signal to the core network signal transmission/reception unit 2043, or performs a primary conversion of the signal output from the core network signal transmission/reception unit 2043 to a core network signal and then outputs the primary-converted core network signal to the core network signal processor unit 2039. The core network signal transmission/reception unit 2043 transmits the signal output from the primary core network signal conversion unit 2041 to a core network, or outputs a signal received through the core network to the primary core network signal conversion unit 2041.

Further, the control unit 2029 controls the operations of the macro access point signal transmission/reception unit 2011, the downlink RF transmission unit 2019, the uplink RF reception unit 2025, the femto access point unit 2035, and the core network signal transmission/reception unit 2043. Various control operations performed by the control unit 2029 are based on the signals output from the femto access point unit 2035 and received by the control unit 2029, and a detailed description of them has been already described above and is thus omitted here.

In the meantime, when parameters relating to the control operations have been already determined by the service provider and the femto access point provides limited services as described above, the femto access point may not include the control unit 2029. Further, the macro access point signal conversion unit 2031 receives the signal output from the RF channel filter unit 2015, converts the received signal to a macro access point signal, and outputs the converted signal to the macro access point signal analysis unit 2033. The macro access point signal analysis unit 2033 analyzes the signal output from the macro access point signal conversion unit 2031 and then outputs the analyzed signal to the control unit 2029.

Hereinafter, a method of relaying a downlink signal received from a macro access point to a UE by a femto access point when the femto access point is in a relay mode will be first described.

First, the macro access point signal transmission/reception unit 2011 receives a downlink signal from a macro access point and outputs the downlink signal to the RF channel filter unit 2015. The RF channel filter unit 2015 converts the signal output from the macro access point signal transmission/reception unit 2011 to an RF signal through RF channel filtering and outputs the converted signal to the combination unit 2017 and the macro access point signal conversion unit 2031.

The combination unit 2017 combines the signal output from the RF channel filter unit 2015 with the signal output from the secondary core network signal conversion unit 2037 and then outputs the combined signal to the downlink RF transmission unit 2019. The downlink RF transmission unit 2019 performs an outgoing signal RF processing of the signal output from the combination unit 2017 and then outputs the processed signal to the duplexer 2023. The duplexer 2023 transmits the signal output from the downlink RF transmission unit 2019 to a corresponding UE through the antenna 2021 at a corresponding time point.

Second, a method of relaying an uplink signal received from a UE to a macro access point by a femto access point when the femto access point is in a relay mode will be described.

When an uplink signal from a corresponding UE is received through the antenna 2021, the uplink signal received through the antenna 2021 is output to the duplexer 2023. The duplexer 2023 outputs the uplink signal output from the antenna 2021 to the uplink RF reception unit 2025 at a corresponding time point. The uplink RF reception unit 2025 performs an incoming signal RF processing of the signal output from the duplexer 2023 and outputs the processed signal to the distribution unit 2027. The distribution unit 2027 outputs the signal output from the uplink RF reception unit 2025 to the RF channel filter unit 2015. The RF channel filter unit 2015 converts the signal output from the distribution unit 2027 to an RF signal through RF channel filtering and then outputs the converted signal to the macro access point signal transmission/reception unit 2011. The macro access point signal transmission/reception unit 2011 transmits the signal output from the RF channel filter unit 2015 to a corresponding macro access point (or a relay station).

Third, a method of transmitting a downlink signal received from a core network to a UE by a femto access point when the femto access point is in a femto access point mode will be described.

The core network signal transmission/reception unit 2043 receives a downlink signal from the core network, and then outputs the received downlink signal to the primary core network signal conversion unit 2041. The primary core network signal conversion unit 2041 performs a primary conversion of the signal output from the core network signal transmission/reception unit 2043 to a core network signal and outputs the converted core network signal to the core network signal processor unit 2039. The core network signal processor unit 2039 processes the signal output from the primary core network signal conversion unit 2041 and outputs the processed signal to the secondary core network signal conversion unit 2037. The secondary core network signal conversion unit 2037 performs a secondary conversion of the signal output from the core network signal processor unit 2039 to a core network signal and outputs the converted core network signal to the combination unit 2017.

The combination unit 2017 combines the signal output from the secondary core network signal conversion unit 2037 with the signal output from the RF channel filter unit 2015 and then outputs the combined signal to the downlink RF transmission unit 2019. The downlink RF transmission unit 2019 performs an outgoing signal RF processing of the signal output from the combination unit 2017 and then outputs the processed signal to the duplexer 2023. The duplexer 2023 transmits the signal output from the downlink RF transmission unit 2019 to a corresponding UE through the antenna 2021 at a corresponding time point.

Fourth, a method of transmitting an uplink signal received from a UE to a core network by a femto access point when the femto access point is in a femto access point mode will be described.

When an uplink signal from a corresponding UE is received through the antenna 2021, the uplink signal received through the antenna 2021 is output to the duplexer 2023. The duplexer 2023 outputs the uplink signal output from the antenna 2021 to the uplink RF reception unit 2025 at a corresponding time point. The uplink RF reception unit 2025 performs an incoming signal RF processing of the signal output from the duplexer 2023 and outputs the processed signal to the distribution unit 2027. The distribution unit 2027 outputs the signal output from the uplink RF reception unit 2025 to the secondary core network signal conversion unit 2037. The secondary core network signal conversion unit 2037 performs a secondary conversion of the signal output from the distribution unit 2027 to a core network signal and then outputs the converted signal to the core network signal processor unit 2039. The core network signal processor unit 2039 processes the signal output from the secondary core network signal conversion unit 2037 and outputs the processed signal to the primary core network signal conversion unit 2041. The primary core network signal conversion unit 2041 performs a primary conversion of the signal output from the core network signal processor unit 2039 to a core network signal and then outputs the converted signal to the core network signal transmission/reception unit 2043. The core network signal transmission/reception unit 2043 transmits the signal output from the primary core network signal conversion unit 2041 to the core network.

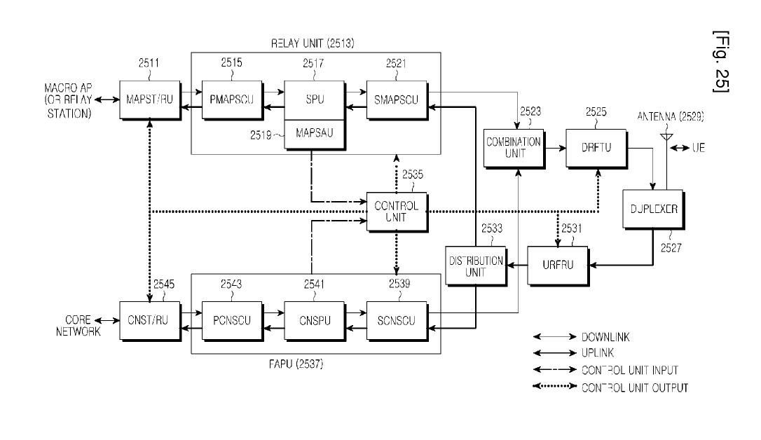

FIG. 21 is a block diagram illustrating an internal structure of a femto access point according to another embodiment of the present invention.

It should be noted that the internal structure of the femto access point shown in FIG. 21 corresponds to an internal structure in which the relay unit has an IF repeater type. Further, when the relay unit is a unit of the IF repeater type, since the relay unit does not include a DSP capable of analyzing a baseband signal, it is necessary to add a DSP in the relay unit or to use the DSP included in a femto access point unit. FIG. 21 is based on an assumption that the relay unit does not include a DSP and uses the DSP included in a femto access point unit.

Referring to FIG. 21, the femto access point includes a macro access point signal transmission/reception unit 2111, a relay unit 2113, a combination unit 2121, a downlink RF transmission unit 2123, a duplexer 2125, an antenna 2127, an uplink RF reception unit 2129, a distribution unit 2131, a control unit 2133, a macro access point signal conversion unit 2135, a femto access point unit 2137, and a core network signal transmission/reception unit 2145. The relay unit 2113 includes a primary macro access point signal conversion unit 2115, an IF channel filter unit 2117, and a secondary macro access point signal conversion unit 2119, and the femto access point unit 2137 includes a primary core network signal conversion unit 2143, a core network signal processor unit 2141, and a secondary core network signal conversion unit 2139. Further, each of the primary macro access point signal conversion unit 2115 and the secondary macro access point signal conversion unit 2119 includes a down-converting unit and an up-converting unit, and the IF channel filter unit 2117 includes an IF channel filter and an amplifying unit for gain compensation by a channel filter. The IF channel filter may be a Surface Acoustic Wave (SAW) filter.

First, the macro access point signal transmission/reception unit 2111 receives a downlink signal from a macro access point and outputs the downlink signal to the primary macro access point signal conversion unit 2115 or receives an uplink signal from the primary macro access point signal conversion unit 2115 and transmits the uplink signal to the macro access point.

The primary macro access point signal conversion unit 2115 performs a primary conversion of the downlink signal output from the macro access point signal transmission/reception unit 2111 to a macro access point signal and then outputs the primary-converted macro access point signal to the IF channel filter unit 2117, or performs a primary conversion of the uplink signal output from the IF channel filter unit 2117 to a macro access point signal and then outputs the primary-converted macro access point signal to the macro access point signal transmission/reception unit 2111.

The IF channel filter unit 2117 performs IF channel filtering of the signal output from the primary macro access point signal conversion unit 2115 and outputs the filtered signal to the secondary macro access point signal conversion unit 2119 and the macro access point signal conversion unit 2135, or performs IF channel filtering of the signal output from the secondary macro access point signal conversion unit 2119 and outputs the filtered signal to the primary macro access point signal conversion unit 2115.

The secondary macro access point signal conversion unit 2119 performs a secondary conversion of the signal output from the IF channel filter unit 2117 to a macro access point signal and then outputs the secondary-converted macro access point signal to the combination unit 2121, or performs a secondary conversion of the signal output from the distribution unit 2131 to a macro access point signal and then outputs the secondary-converted macro access point signal to the IF channel filter unit 2117. The combination unit 2121 combines the signal output from the secondary macro access point signal conversion unit 2119 with a signal output from the secondary core network signal conversion unit 2139 and outputs the combined signal to the downlink RF transmission unit 2123. The downlink RF transmission unit 2123 performs RF transmission processing of the signal output from the combination unit 2121 and then outputs the processed signal to the duplexer 2125. The duplexer 2125 transmits the signal output from the downlink RF transmission unit 2123 to a corresponding UE through the antenna 2127 at a corresponding time point.

Meanwhile, a signal received from the UE through the antenna 2127 is output to the duplexer 2125, and the duplexer 2125 outputs the signal received through the antenna 2127 to the uplink RF reception unit 2129 at a corresponding time point. The uplink RF reception unit 2129 performs an incoming signal RF processing of the signal output from the duplexer 2125 and then outputs the processed signal to the distribution unit 2131. The distribution unit 2131 determines the unit to which the signal output from the uplink RF reception unit 2129 should be distributed, and then outputs the signal to the secondary macro access point signal conversion unit 2119 or the secondary core network signal conversion unit 2139. The distribution unit 2131 outputs the uplink signal received from the UE to the secondary macro access point signal conversion unit 2119 when the uplink signal received from the UE should be transmitted through the relay unit 2113, and outputs the uplink signal received from the UE to the secondary core network signal conversion unit 2139 when the uplink signal received from the UE should be transmitted through the femto access point unit 2137.

The secondary core network signal conversion unit 2139 performs a secondary conversion of the signal output from the distribution unit 2131 to a core network signal and then outputs the secondary-converted core network signal to the core network signal processor unit 2141, or performs a secondary conversion of the signal output from the core network signal processor unit 2141 to a core network signal and then outputs the secondary-converted core network signal to the distribution unit 2131.

The core network signal processor unit 2141 performs signal processing of the signal output from the secondary core network signal conversion unit 2139 and then outputs the processed signal to the primary core network signal conversion unit 2143, or performs signal processing of the signal output from the primary core network signal conversion unit 2143 and then outputs the processed signal to the secondary core network signal conversion unit 2139.

The primary core network signal conversion unit 2143 performs a primary conversion of the signal output from the core network signal processor unit 2141 to a core network signal and then outputs the primary-converted core network signal to the core network signal transmission/reception unit 2145, or performs a primary conversion of the signal output from the core network signal transmission/reception unit 2145 to a core network signal and then outputs the primary-converted core network signal to the core network signal processor unit 2141. The core network signal transmission/reception unit 2145 transmits the signal output from the primary core network signal conversion unit 2143 to a core network, or outputs a signal received through the core network to the primary core network signal conversion unit 2143.

Further, the control unit 2133 controls the operations of the macro access point signal transmission/reception unit 2111, the downlink RF transmission unit 2123, the uplink RF reception unit 2129, the femto access point unit 2137, and the core network signal transmission/reception unit 2145. Various control operations performed by the control unit 2133 are based on the signals output from the femto access point unit 2137 and received by the control unit 2133, and a detailed description of them has been already described above and is thus omitted here.

In the meantime, when parameters relating to the control operations have been already determined by the service provider and the femto access point provides limited services as described above, the femto access point may not include the control unit 2133. Further, the macro access point signal conversion unit 2135 receives the signal output from the IF channel filter unit 2117, converts the received signal to a macro access point signal, and outputs the converted signal to the core network signal processor unit 2141. That is, since the relay unit 2113 does not include a DSP, the core network signal processor unit 2141 is used to analyze the macro access point signal.

Hereinafter, a method of relaying a downlink signal received from a macro access point to a UE by a femto access point when the femto access point is in a relay mode will be first described.

First, the macro access point signal transmission/reception unit 2111 receives a downlink signal from a macro access point and outputs the downlink signal to the primary macro access point signal conversion unit 2115. The primary macro access point signal conversion unit 2115 primary-converts the signal output from the macro access point signal transmission/reception unit 2111 to a macro access point signal and then outputs the converted macro access point signal to the IF channel filter unit 2117. The IF channel filter unit 2117 performs IF channel filtering of the signal output from the primary macro access point signal conversion unit 2115 and outputs the filtered signal to the secondary macro access point signal conversion unit 2119 and the macro access point signal conversion unit 2135. The secondary macro access point signal conversion unit 2119 secondary-converts the signal output from the IF channel filter unit 2117 to a macro access point signal and then outputs the converted macro access point signal to the combination unit 2121.

The combination unit 2121 combines the signal output from the secondary macro access point signal conversion unit 2119 with the signal output from the secondary core network signal conversion unit 2139 and then outputs the combined signal to the downlink RF transmission unit 2123. The downlink RF transmission unit 2123 performs an outgoing signal RF processing of the signal output from the combination unit 2121 and then outputs the processed signal to the duplexer 2125. The duplexer 2125 transmits the signal output from the downlink RF transmission unit 2123 to a corresponding UE through the antenna 2127 at a corresponding time point.

Second, a method of relaying an uplink signal received from a UE to a macro access point by a femto access point when the femto access point is in a relay mode will be described.

When an uplink signal from a corresponding UE is received through the antenna 2127, the uplink signal received through the antenna 2127 is output to the duplexer 2125. The duplexer 2125 outputs the uplink signal output from the antenna 2127 to the uplink RF reception unit 2129 at a corresponding time point. The uplink RF reception unit 2129 performs an incoming signal RF processing of the signal output from the duplexer 2125 and outputs the processed signal to the distribution unit 2131. The distribution unit 2131 outputs the signal output from the uplink RF reception unit 2129 to the secondary macro access point signal conversion unit 2119.

The secondary macro access point signal conversion unit 2119 performs a secondary conversion of the signal output from the distribution unit 2131 to a macro access point signal and outputs the converted macro access point signal to the IF channel filter unit 2117. The IF channel filter unit 2117 performs IF channel filtering of the signal output from the secondary macro access point signal conversion unit 2119 and outputs the filtered signal to the primary macro access point signal conversion unit 2115. The primary macro access point signal conversion unit 2115 performs a primary conversion of the signal output from the IF channel filter unit 2117 to a macro access point signal and outputs the converted macro access point signal to the macro access point signal transmission/reception unit 2111. The macro access point signal transmission/reception unit 2111 transmits the signal output from the primary macro access point signal conversion unit 2115 to a corresponding macro access point (or a relay station).

Third, a method of transmitting a downlink signal received from a core network to a UE by a femto access point when the femto access point is in a femto access point mode will be described.

The core network signal transmission/reception unit 2145 receives a downlink signal from the core network, and then outputs the received downlink signal to the primary core network signal conversion unit 2143. The primary core network signal conversion unit 2143 performs a primary conversion of the signal output from the core network signal transmission/reception unit 2145 to a core network signal and outputs the converted core network signal to the core network signal processor unit 2141. The core network signal processor unit 2141 processes the signal output from the primary core network signal conversion unit 2143 and outputs the processed signal to the secondary core network signal conversion unit 2139. The secondary core network signal conversion unit 2139 performs a secondary conversion of the signal output from the core network signal processor unit 2141 to a core network signal and outputs the converted core network signal to the combination unit 2121.

The combination unit 2121 combines the signal output from the secondary core network signal conversion unit 2139 with the signal output from the secondary macro access point signal conversion unit 2119 and then outputs the combined signal to the downlink RF transmission unit 2123. The downlink RF transmission unit 2123 performs an outgoing signal RF processing of the signal output from the combination unit 2121 and then outputs the processed signal to the duplexer 2125. The duplexer 2125 transmits the signal output from the downlink RF transmission unit 2123 to a corresponding UE through the antenna 2127 at a corresponding time point.

Fourth, a method of transmitting an uplink signal received from a UE to a core network by a femto access point when the femto access point is in a femto access point mode will be described.

When an uplink signal from a corresponding UE is received through the antenna 2127, the uplink signal received through the antenna 2127 is output to the duplexer 2125. The duplexer 2125 outputs the uplink signal output from the antenna 2127 to the uplink RF reception unit 2129 at a corresponding time point. The uplink RF reception unit 2129 performs an incoming signal RF processing of the signal output from the duplexer 2125 and outputs the processed signal to the distribution unit 2131. The distribution unit 2131 outputs the signal output from the uplink RF reception unit 2129 to the secondary core network signal conversion unit 2139. The secondary core network signal conversion unit 2139 performs a secondary conversion of the signal output from the distribution unit 2131 to a core network signal and then outputs the converted signal to the core network signal processor unit 2141. The core network signal processor unit 2141 processes the signal output from the secondary core network signal conversion unit 2139 and outputs the processed signal to the primary core network signal conversion unit 2143. The primary core network signal conversion unit 2143 performs a primary conversion of the signal output from the core network signal processor unit 2141 to a core network signal and then outputs the converted signal to the core network signal transmission/reception unit 2145. The core network signal transmission/reception unit 2145 transmits the signal output from the primary core network signal conversion unit 2143 to the core network.

FIG. 22 is a block diagram illustrating an internal structure of a femto access point according to another embodiment of the present invention.

It should be noted that the internal structure of the femto access point shown in FIG. 22 corresponds to an internal structure in which the relay unit has an IF repeater type. Further, when the relay unit is a unit of the IF repeater type, since the relay unit does not include a DSP capable of analyzing a baseband signal, it is necessary to add a DSP in the relay unit or to use the DSP included in a femto access point unit. FIG. 22 is based on an assumption that the relay unit includes a separate DSP.

Referring to FIG. 22, the femto access point includes a macro access point signal transmission/reception unit 2211, a relay unit 2213, a combination unit 2221, a downlink RF transmission unit 2223, a duplexer 2225, an antenna 2227, an uplink RF reception unit 2229, a distribution unit 2231, a control unit 2233, a macro access point signal conversion unit 2235, a macro access point analysis unit 2237, a femto access point unit 2239, and a core network signal transmission/reception unit 2247. The relay unit 2213 includes a primary macro access point signal conversion unit 2215, an IF channel filter unit 2217, and a secondary macro access point signal conversion unit 2219, and the femto access point unit 2239 includes a primary core network signal conversion unit 2245, a core network signal processor unit 2243, and a secondary core network signal conversion unit 2241.

Further, each of the primary macro access point signal conversion unit 2215 and the secondary macro access point signal conversion unit 2219 includes a down-converting unit and an up-converting unit, and the IF channel filter unit 2217 includes an IF channel filter and an amplifying unit for gain compensation by a channel filter. The IF channel filter may be a SAW filter.

First, the macro access point signal transmission/reception unit 2211 receives a downlink signal from a macro access point and outputs the downlink signal to the primary macro access point signal conversion unit 2215 or receives an uplink signal from the primary macro access point signal conversion unit 2215 and transmits the uplink signal to the macro access point.

The primary macro access point signal conversion unit 2215 performs a primary conversion of the downlink signal output from the macro access point signal transmission/reception unit 2211 to a macro access point signal and then outputs the primary-converted macro access point signal to the IF channel filter unit 2217, or performs a primary conversion of the uplink signal output from the IF channel filter unit 2217 to a macro access point signal and then outputs the primary-converted macro access point signal to the macro access point signal transmission/reception unit 2211.

The IF channel filter unit 2217 performs IF channel filtering of the signal output from the primary macro access point signal conversion unit 2215 and outputs the filtered signal to the secondary macro access point signal conversion unit 2219 and the macro access point signal conversion unit 2235, or performs IF channel filtering of the signal output from the secondary macro access point signal conversion unit 2219 and outputs the filtered signal to the primary macro access point signal conversion unit 2215.

The secondary macro access point signal conversion unit 2219 performs a secondary conversion of the signal output from the IF channel filter unit 2217 to a macro access point signal and then outputs the secondary-converted macro access point signal to the combination unit 2221, or performs a secondary conversion of the signal output from the distribution unit 2231 to a macro access point signal and then outputs the secondary-converted macro access point signal to the IF channel filter unit 2217. The combination unit 2221 combines the signal output from the secondary macro access point signal conversion unit 2219 with a signal output from the secondary core network signal conversion unit 2241 and outputs the combined signal to the downlink RF transmission unit 2223. The downlink RF transmission unit 2223 performs RF transmission processing of the signal output from the combination unit 2221 and then outputs the processed signal to the duplexer 2225. The duplexer 2225 transmits the signal output from the downlink RF transmission unit 2223 to a corresponding UE through the antenna 2227 at a corresponding time point.

Meanwhile, a signal received from the UE through the antenna 2227 is output to the duplexer 2225, and the duplexer 2225 outputs the signal received through the antenna 2227 to the uplink RF reception unit 2229 at a corresponding time point. The uplink RF reception unit 2229 performs an incoming signal RF processing of the signal output from the duplexer 2225 and then outputs the processed signal to the distribution unit 2231. The distribution unit 2231 determines the unit to which the signal output from the uplink RF reception unit 2229 should be distributed, and then outputs the signal to the secondary macro access point signal conversion unit 2219 or the secondary core network signal conversion unit 2241. The distribution unit 2231 outputs the uplink signal received from the UE to the secondary macro access point signal conversion unit 2219 when the uplink signal received from the UE should be transmitted through the relay unit 2213, and outputs the uplink signal received from the UE to the secondary core network signal conversion unit 2241 when the uplink signal received from the UE should be transmitted through the femto access point unit 2239.

The secondary core network signal conversion unit 2241 performs a secondary conversion of the signal output from the distribution unit 2231 to a core network signal and then outputs the secondary-converted core network signal to the core network signal processor unit 2243, or performs a secondary conversion of the signal output from the core network signal processor unit 2243 to a core network signal and then outputs the secondary-converted core network signal to the distribution unit 2231. The core network signal processor unit 2243 performs signal processing of the signal output from the secondary core network signal conversion unit 2241 and then outputs the processed signal to the primary core network signal conversion unit 2245, or performs signal processing of the signal output from the primary core network signal conversion unit 2245 and then outputs the processed signal to the secondary core network signal conversion unit 2241.

The primary core network signal conversion unit 2245 performs a primary conversion of the signal output from the core network signal processor unit 2243 to a core network signal and then outputs the primary-converted core network signal to the core network signal transmission/reception unit 2247, or performs a primary conversion of the signal output from the core network signal transmission/reception unit 2247 to a core network signal and then outputs the primary-converted core network signal to the core network signal processor unit 2243. The core network signal transmission/reception unit 2247 transmits the signal output from the primary core network signal conversion unit 2245 to a core network, or outputs a signal received through the core network to the primary core network signal conversion unit 2245.

Further, the control unit 2233 controls the operations of the macro access point signal transmission/reception unit 2211, the downlink RF transmission unit 2223, the uplink RF reception unit 2229, the femto access point unit 2239, and the core network signal transmission/reception unit 2247. Various control operations performed by the control unit 2233 are based on the signals output from the femto access point unit 2239 and received by the control unit 2233, and a detailed description of them has been already described above and is thus omitted here.

In the meantime, when parameters relating to the control operations have been already determined by the service provider and the femto access point provides limited services as described above, the femto access point may not include the control unit 2233.

Further, the macro access point signal conversion unit 2235 receives the signal output from the IF channel filter unit 2217, converts the received signal to a macro access point signal, and outputs the converted signal to the macro access point analysis unit 2237. The macro access point analysis unit analyzes the signal output from the macro access point conversion unit 2235 and then outputs the analyzed signal to the control unit 2233.

Hereinafter, a method of relaying a downlink signal received from a macro access point to a UE by a femto access point when the femto access point is in a relay mode will be first described.

First, the macro access point signal transmission/reception unit 2211 receives a downlink signal from a macro access point and outputs the downlink signal to the primary macro access point signal conversion unit 2215. The primary macro access point signal conversion unit 2215 primary-converts the signal output from the macro access point signal transmission/reception unit 2211 to a macro access point signal and then outputs the converted macro access point signal to the IF channel filter unit 2217. The IF channel filter unit 2217 performs IF channel filtering of the signal output from the primary macro access point signal conversion unit 2215 and outputs the filtered signal to the secondary macro access point signal conversion unit 2219 and the macro access point signal conversion unit 2235. The secondary macro access point signal conversion unit 2219 secondary-converts the signal output from the IF channel filter unit 2217 to a macro access point signal and then outputs the converted macro access point signal to the combination unit 2221.

The combination unit 2221 combines the signal output from the secondary macro access point signal conversion unit 2219 with the signal output from the secondary core network signal conversion unit 2241 and then outputs the combined signal to the downlink RF transmission unit 2223. The downlink RF transmission unit 2223 performs an outgoing signal RF processing of the signal output from the combination unit 2221 and then outputs the processed signal to the duplexer 2225. The duplexer 2225 transmits the signal output from the downlink RF transmission unit 2223 to a corresponding UE through the antenna 2227 at a corresponding time point.

Second, a method of relaying an uplink signal received from a UE to a macro access point by a femto access point when the femto access point is in a relay mode will be described.

When an uplink signal from a corresponding UE is received through the antenna 2227, the uplink signal received through the antenna 2227 is output to the duplexer 2225. The duplexer 2225 outputs the uplink signal output from the antenna 2227 to the uplink RF reception unit 2229 at a corresponding time point. The uplink RF reception unit 2229 performs an incoming signal RF processing of the signal output from the duplexer 2225 and outputs the processed signal to the distribution unit 2231. The distribution unit 2231 outputs the signal output from the uplink RF reception unit 2229 to the secondary macro access point signal conversion unit 2219.

The secondary macro access point signal conversion unit 2219 performs a secondary conversion of the signal output from the distribution unit 2231 to a macro access point signal and outputs the converted macro access point signal to the IF channel filter unit 2217. The IF channel filter unit 2217 performs IF channel filtering of the signal output from the secondary macro access point signal conversion unit 2219 and outputs the filtered signal to the primary macro access point signal conversion unit 2215. The primary macro access point signal conversion unit 2215 performs a primary conversion of the signal output from the IF channel filter unit 2217 to a macro access point signal and outputs the converted macro access point signal to the macro access point signal transmission/reception unit 2211. The macro access point signal transmission/reception unit 2211 transmits the signal output from the primary macro access point signal conversion unit 2215 to a corresponding macro access point (or a relay station).

Third, a method of transmitting a downlink signal received from a core network to a UE by a femto access point when the femto access point is in a femto access point mode will be described.

The core network signal transmission/reception unit 2247 receives a downlink signal from the core network, and then outputs the received downlink signal to the primary core network signal conversion unit 2245. The primary core network signal conversion unit 2245 performs a primary conversion of the signal output from the core network signal transmission/reception unit 2247 to a core network signal and outputs the converted core network signal to the core network signal processor unit 2243. The core network signal processor unit 2243 processes the signal output from the primary core network signal conversion unit 2245 and outputs the processed signal to the secondary core network signal conversion unit 2241. The secondary core network signal conversion unit 2241 performs a secondary conversion of the signal output from the core network signal processor unit 2243 to a core network signal and outputs the converted core network signal to the combination unit 2221.

The combination unit 2221 combines the signal output from the secondary core network signal conversion unit 2241 with the signal output from the secondary macro access point signal conversion unit 2219 and then outputs the combined signal to the downlink RF transmission unit 2223. The downlink RF transmission unit 2223 performs an outgoing signal RF processing of the signal output from the combination unit 2221 and then outputs the processed signal to the duplexer 2225. The duplexer 2225 transmits the signal output from the downlink RF transmission unit 2223 to a corresponding UE through the antenna 2227 at a corresponding time point.

Fourth, a method of transmitting an uplink signal received from a UE to a core network by a femto access point when the femto access point is in a femto access point mode will be described.

When an uplink signal from a corresponding UE is received through the antenna 2227, the uplink signal received through the antenna 2227 is output to the duplexer 2225. The duplexer 2225 outputs the uplink signal output from the antenna 2227 to the uplink RF reception unit 2229 at a corresponding time point. The uplink RF reception unit 2229 performs an incoming signal RF processing of the signal output from the duplexer 2225 and outputs the processed signal to the distribution unit 2231. The distribution unit 2231 outputs the signal output from the uplink RF reception unit 2229 to the secondary core network signal conversion unit 2241. The secondary core network signal conversion unit 2241 performs a secondary conversion of the signal output from the distribution unit 2231 to a core network signal and then outputs the converted signal to the core network signal processor unit 2243. The core network signal processor unit 2243 processes the signal output from the secondary core network signal conversion unit 2241 and outputs the processed signal to the primary core network signal conversion unit 2245. The primary core network signal conversion unit 2245 performs a primary conversion of the signal output from the core network signal processor unit 2243 to a core network signal and then outputs the converted signal to the core network signal transmission/reception unit 2247. The core network signal transmission/reception unit 2247 transmits the signal output from the primary core network signal conversion unit 2245 to the core network.

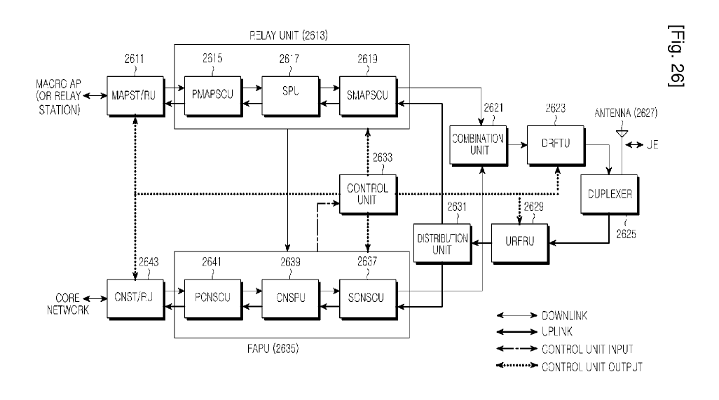

FIG. 23 is a block diagram illustrating an internal structure of a femto access point according to another embodiment of the present invention.

It should be noted that the internal structure of the femto access point shown in FIG. 23 corresponds to an internal structure in which the relay unit has a digital filtering repeater type. Further, when the relay unit is a unit of the digital filtering repeater type, since the relay unit includes a DSP capable of analyzing a baseband signal, the relay unit also can analyze a macro access point signal. However, when the relay unit cannot analyze a macro access point signal due to a problem of expense, etc., it is necessary to use the DSP included in a femto access point unit. FIG. 23 is based on an assumption that the relay unit also can analyze a macro access point signal.

Referring to FIG. 23, the femto access point includes a macro access point signal transmission/reception unit 2311, a relay unit 2313, a combination unit 2323, a downlink RF transmission unit 2325, a duplexer 2327, an antenna 2329, an uplink RF reception unit 2331, a distribution unit 2333, a control unit 2335, a femto access point unit 2337, and a core network signal transmission/reception unit 2345. The relay unit 2313 includes a primary macro access point signal conversion unit 2315, an digital filter unit 2317, a macro access point signal analysis unit 2319, and a secondary macro access point signal conversion unit 2321, and the femto access point unit 2337 includes a primary core network signal conversion unit 2343, a core network signal processor unit 2341, and a secondary core network signal conversion unit 2339. Further, each of the primary macro access point signal conversion unit 2315 and the secondary macro access point signal conversion unit 2321 includes a down-converting unit and an up-converting unit.

First, the macro access point signal transmission/reception unit 2311 receives a downlink signal from a macro access point and outputs the downlink signal to the primary macro access point signal conversion unit 2315 or receives an uplink signal from the primary macro access point signal conversion unit 2315 and transmits the uplink signal to the macro access point.

The primary macro access point signal conversion unit 2315 performs a primary conversion of the downlink signal output from the macro access point signal transmission/reception unit 2311 to a macro access point signal and then outputs the primary-converted macro access point signal to the digital filter unit 2317, or performs a primary conversion of the uplink signal output from the digital filter unit 2317 to a macro access point signal and then outputs the primary-converted macro access point signal to the macro access point signal transmission/reception unit 2311.

The digital filter unit 2317 performs digital filtering of the signal output from the primary macro access point signal conversion unit 2315 and outputs the filtered signal to the macro access point analysis unit 2319 and the secondary macro access point signal conversion unit 2321, or performs digital filtering of the signal output from the secondary macro access point signal conversion unit 2321 and outputs the filtered signal to the primary macro access point signal conversion unit 2315.

The secondary macro access point signal conversion unit 2321 performs a secondary conversion of the signal output from the digital filter unit 2317 to a macro access point signal and then outputs the secondary-converted macro access point signal to the combination unit 2323, or performs a secondary conversion of the signal output from the distribution unit 2333 to a macro access point signal and then outputs the secondary-converted macro access point signal to the digital filter unit 2317. The combination unit 2323 combines the signal output from the secondary macro access point signal conversion unit 2321 with a signal output from the secondary core network signal conversion unit 2339 and outputs the combined signal to the downlink RF transmission unit 2325. The downlink RF transmission unit 2325 performs RF transmission processing of the signal output from the combination unit 2323 and then outputs the processed signal to the duplexer 2327. The duplexer 2327 transmits the signal output from the downlink RF transmission unit 2325 to a corresponding UE through the antenna 2329 at a corresponding time point.

Meanwhile, a signal received from the UE through the antenna 2329 is output to the duplexer 2327, and the duplexer 2327 outputs the signal received through the antenna 2329 to the uplink RF reception unit 2331 at a corresponding time point. The uplink RF reception unit 2331 performs an incoming signal RF processing of the signal output from the duplexer 2327 and then outputs the processed signal to the distribution unit 2333. The distribution unit 2333 determines the unit to which the signal output from the uplink RF reception unit 2331 should be distributed, and then outputs the signal to the secondary macro access point signal conversion unit 2321 or the secondary core network signal conversion unit 2339. The distribution unit 2333 outputs the uplink signal received from the UE to the secondary macro access point signal conversion unit 2321 when the uplink signal received from the UE should be transmitted through the relay unit 2313, and outputs the uplink signal received from the UE to the secondary core network signal conversion unit 2339 when the uplink signal received from the UE should be transmitted through the femto access point unit 2337.

The secondary core network signal conversion unit 2339 performs a secondary conversion of the signal output from the distribution unit 2333 to a core network signal and then outputs the secondary-converted core network signal to the core network signal processor unit 2341, or performs a secondary conversion of the signal output from the core network signal processor unit 2341 to a core network signal and then outputs the secondary-converted core network signal to the distribution unit 2333. The core network signal processor unit 2341 performs signal processing of the signal output from the secondary core network signal conversion unit 2339 and then outputs the processed signal to the primary core network signal conversion unit 2343, or performs signal processing of the signal output from the primary core network signal conversion unit 2343 and then outputs the processed signal to the secondary core network signal conversion unit 2339.

The primary core network signal conversion unit 2343 performs a primary conversion of the signal output from the core network signal processor unit 2341 to a core network signal and then outputs the primary-converted core network signal to the core network signal transmission/reception unit 2345, or performs a primary conversion of the signal output from the core network signal transmission/reception unit 2345 to a core network signal and then outputs the primary-converted core network signal to the core network signal processor unit 2341. The core network signal transmission/reception unit 2345 transmits the signal output from the primary core network signal conversion unit 2343 to a core network, or outputs a signal received through the core network to the primary core network signal conversion unit 2343.

Further, the control unit 2335 controls the operations of the macro access point signal transmission/reception unit 2311, the relay unit 2313, the downlink RF transmission unit 2325, the uplink RF reception unit 2331, the femto access point unit 2337, and the core network signal transmission/reception unit 2345. Various control operations performed by the control unit 2335 are based on the signals output from the femto access point unit 2337 and received by the control unit 2335, and a detailed description of them has been already described above and is thus omitted here. In the meantime, when parameters relating to the control operations have been already determined by the service provider and the femto access point provides limited services as described above, the femto access point may not include the control unit 2335. Further, the macro access point signal analysis unit 2319 analyzes the signal output from the digital filter unit 2317 and then outputs the analyzed signal to the control unit 2335.

Hereinafter, a method of relaying a downlink signal received from a macro access point to a UE by a femto access point when the femto access point is in a relay mode will be first described.

First, the macro access point signal transmission/reception unit 2311 receives a downlink signal from a macro access point and outputs the downlink signal to the primary macro access point signal conversion unit 2315. The primary macro access point signal conversion unit 2315 primary-converts the signal output from the macro access point signal transmission/reception unit 2311 to a macro access point signal and then outputs the converted macro access point signal to the digital filter unit 2317. The digital filter unit 2317 performs digital filtering of the signal output from the primary macro access point signal conversion unit 2315 and outputs the filtered signal to the secondary macro access point signal conversion unit 2321 and the macro access point signal analysis unit 2319. The secondary macro access point signal conversion unit 2321 secondary-converts the signal output from the digital filter unit 2317 to a macro access point signal and then outputs the converted macro access point signal to the combination unit 2323.

The combination unit 2323 combines the signal output from the secondary macro access point signal conversion unit 2321 with the signal output from the secondary core network signal conversion unit 2339 and then outputs the combined signal to the downlink RF transmission unit 2325. The downlink RF transmission unit 2325 performs an outgoing signal RF processing of the signal output from the combination unit 2323 and then outputs the processed signal to the duplexer 2327. The duplexer 2327 transmits the signal output from the downlink RF transmission unit 2325 to a corresponding UE through the antenna 2329 at a corresponding time point.

Second, a method of relaying an uplink signal received from a UE to a macro access point by a femto access point when the femto access point is in a relay mode will be described.

When an uplink signal from a corresponding UE is received through the antenna 2329, the uplink signal received through the antenna 2329 is output to the duplexer 2327. The duplexer 2327 outputs the uplink signal output from the antenna 2329 to the uplink RF reception unit 2331 at a corresponding time point. The uplink RF reception unit 2331 performs an incoming signal RF processing of the signal output from the duplexer 2327 and outputs the processed signal to the distribution unit 2333. The distribution unit 2333 outputs the signal output from the uplink RF reception unit 2331 to the secondary macro access point signal conversion unit 2321.

The secondary macro access point signal conversion unit 2321 performs a secondary conversion of the signal output from the distribution unit 2333 to a macro access point signal and outputs the converted macro access point signal to the digital filter unit 2317. The digital filter unit 2317 performs digital filtering of the signal output from the secondary macro access point signal conversion unit 2321 and outputs the filtered signal to the primary macro access point signal conversion unit 2315. The primary macro access point signal conversion unit 2315 performs a primary conversion of the signal output from the digital filter unit 2317 to a macro access point signal and outputs the converted macro access point signal to the macro access point signal transmission/reception unit 2311. The macro access point signal transmission/reception unit 2311 transmits the signal output from the primary macro access point signal conversion unit 2315 to a corresponding macro access point (or a relay station).

Third, a method of transmitting a downlink signal received from a core network to a UE by a femto access point when the femto access point is in a femto access point mode will be described.

The core network signal transmission/reception unit 2345 receives a downlink signal from the core network, and then outputs the received downlink signal to the primary core network signal conversion unit 2343. The primary core network signal conversion unit 2343 performs a primary conversion of the signal output from the core network signal transmission/reception unit 2345 to a core network signal and outputs the converted core network signal to the core network signal processor unit 2341. The core network signal processor unit 2341 processes the signal output from the primary core network signal conversion unit 2343 and outputs the processed signal to the secondary core network signal conversion unit 2339. The secondary core network signal conversion unit 2339 performs a secondary conversion of the signal output from the core network signal processor unit 2341 to a core network signal and outputs the converted core network signal to the combination unit 2323.

The combination unit 2323 combines the signal output from the secondary core network signal conversion unit 2339 with the signal output from the secondary macro access point signal conversion unit 2321 and then outputs the combined signal to the downlink RF transmission unit 2325. The downlink RF transmission unit 2325 performs an outgoing signal RF processing of the signal output from the combination unit 2323 and then outputs the processed signal to the duplexer 2327. The duplexer 2327 transmits the signal output from the downlink RF transmission unit 2325 to a corresponding UE through the antenna 2329 at a corresponding time point.

Fourth, a method of transmitting an uplink signal received from a UE to a core network by a femto access point when the femto access point is in a femto access point mode will be described.

When an uplink signal from a corresponding UE is received through the antenna 2329, the uplink signal received through the antenna 2329 is output to the duplexer 2327. The duplexer 2327 outputs the uplink signal output from the antenna 2329 to the uplink RF reception unit 2331 at a corresponding time point. The uplink RF reception unit 2331 performs an incoming signal RF processing of the signal output from the duplexer 2327 and outputs the processed signal to the distribution unit 2333. The distribution unit 2333 outputs the signal output from the uplink RF reception unit 2331 to the secondary core network signal conversion unit 2339. The secondary core network signal conversion unit 2339 performs a secondary conversion of the signal output from the distribution unit 2333 to a core network signal and then outputs the converted signal to the core network signal processor unit 2341. The core network signal processor unit 2341 processes the signal output from the secondary core network signal conversion unit 2339 and outputs the processed signal to the primary core network signal conversion unit 2343. The primary core network signal conversion unit 2343 performs a primary conversion of the signal output from the core network signal processor unit 2341 to a core network signal and then outputs the converted signal to the core network signal transmission/reception unit 2345. The core network signal transmission/reception unit 2345 transmits the signal output from the primary core network signal conversion unit 2343 to the core network.

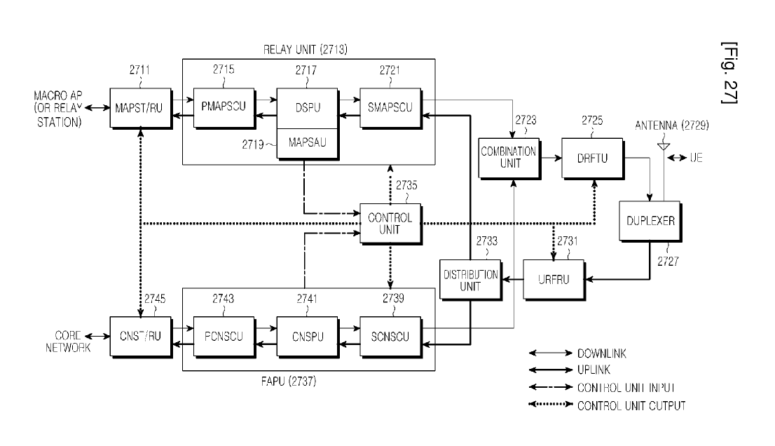

FIG. 24 is a block diagram illustrating an internal structure of a femto access point according to another embodiment of the present invention.

It should be noted that the internal structure of the femto access point shown in FIG. 24 corresponds to an internal structure in which the relay unit has a digital filtering repeater type. Further, when the relay unit is a unit of the digital filtering repeater type, since the relay unit includes a DSP capable of analyzing a baseband signal, the relay unit also can analyze a macro access point signal. However, when the relay unit cannot analyze a macro access point signal due to a problem of expense, etc., it is necessary to use the DSP included in a femto access point unit. FIG. 24 is based on an assumption that the relay unit uses a DSP included in the femto access point unit.

Referring to FIG. 24, the femto access point includes a macro access point signal transmission/reception unit 2411, a relay unit 2413, a combination unit 2421, a downlink RF transmission unit 2423, a duplexer 2425, an antenna 2427, an uplink RF reception unit 2429, a distribution unit 2431, a control unit 2433, a femto access point unit 2435, and a core network signal transmission/reception unit 2443. The relay unit 2413 includes a primary macro access point signal conversion unit 2415, an digital filter unit 2417, and a secondary macro access point signal conversion unit 2419, and the femto access point unit 2435 includes a primary core network signal conversion unit 2441, a core network signal processor unit 2439, and a secondary core network signal conversion unit 2437. Further, each of the primary macro access point signal conversion unit 2415 and the secondary macro access point signal conversion unit 2419 includes a down-converting unit and an up-converting unit.

First, the macro access point signal transmission/reception unit 2411 receives a downlink signal from a macro access point and outputs the downlink signal to the primary macro access point signal conversion unit 2415 or receives an uplink signal from the primary macro access point signal conversion unit 2415 and transmits the uplink signal to the macro access point.

The primary macro access point signal conversion unit 2415 performs a primary conversion of the downlink signal output from the macro access point signal transmission/reception unit 2411 to a macro access point signal and then outputs the primary-converted macro access point signal to the digital filter unit 2417, or performs a primary conversion of the uplink signal output from the digital filter unit 2417 to a macro access point signal and then outputs the primary-converted macro access point signal to the macro access point signal transmission/reception unit 2411.

The digital filter unit 2417 performs digital filtering of the signal output from the primary macro access point signal conversion unit 2415 and outputs the filtered signal to the secondary macro access point signal conversion unit 2419, or performs digital filtering of the signal output from the secondary macro access point signal conversion unit 2419 and outputs the filtered signal to the primary macro access point signal conversion unit 2415.

The secondary macro access point signal conversion unit 2419 performs a secondary conversion of the signal output from the digital filter unit 2417 to a macro access point signal and then outputs the secondary-converted macro access point signal to the combination unit 2421, or performs a secondary conversion of the signal output from the distribution unit 2431 to a macro access point signal and then outputs the secondary-converted macro access point signal to the digital filter unit 2417. The combination unit 2421 combines the signal output from the secondary macro access point signal conversion unit 2419 with a signal output from the secondary core network signal conversion unit 2437 and outputs the combined signal to the downlink RF transmission unit 2423. The downlink RF transmission unit 2423 performs RF transmission processing of the signal output from the combination unit 2421 and then outputs the processed signal to the duplexer 2425. The duplexer 2425 transmits the signal output from the downlink RF transmission unit 2423 to a corresponding UE through the antenna 2427 at a corresponding time point.

Meanwhile, a signal received from the UE through the antenna 2427 is output to the duplexer 2425, and the duplexer 2425 outputs the signal received through the antenna 2427 to the uplink RF reception unit 2429 at a corresponding time point. The uplink RF reception unit 2429 performs an incoming signal RF processing of the signal output from the duplexer 2425 and then outputs the processed signal to the distribution unit 2431. The distribution unit 2431 determines the unit to which the signal output from the uplink RF reception unit 2429 should be distributed, and then outputs the signal to the secondary macro access point signal conversion unit 2419 or the secondary core network signal conversion unit 2437. The distribution unit 2431 outputs the uplink signal received from the UE to the secondary macro access point signal conversion unit 2419 when the uplink signal received from the UE should be transmitted through the relay unit 2413, and outputs the uplink signal received from the UE to the secondary core network signal conversion unit 2437 when the uplink signal received from the UE should be transmitted through the femto access point unit 2435.

The secondary core network signal conversion unit 2437 performs a secondary conversion of the signal output from the distribution unit 2431 to a core network signal and then outputs the secondary-converted core network signal to the core network signal processor unit 2439, or performs a secondary conversion of the signal output from the core network signal processor unit 2439 to a core network signal and then outputs the secondary-converted core network signal to the distribution unit 2431. The core network signal processor unit 2439 performs signal processing of the signal output from the secondary core network signal conversion unit 2437 and then outputs the processed signal to the primary core network signal conversion unit 2441, or performs signal processing of the signal output from the primary core network signal conversion unit 2441 and then outputs the processed signal to the secondary core network signal conversion unit 2437.

The primary core network signal conversion unit 2441 performs a primary conversion of the signal output from the core network signal processor unit 2439 to a core network signal and then outputs the primary-converted core network signal to the core network signal transmission/reception unit 2443, or performs a primary conversion of the signal output from the core network signal transmission/reception unit 2443 to a core network signal and then outputs the primary-converted core network signal to the core network signal processor unit 2439. The core network signal transmission/reception unit 2443 transmits the signal output from the primary core network signal conversion unit 2441 to a core network, or outputs a signal received through the core network to the primary core network signal conversion unit 2441.

Further, the control unit 2433 controls the operations of the macro access point signal transmission/reception unit 2411, the relay unit 2413, the downlink RF transmission unit 2423, the uplink RF reception unit 2429, the femto access point unit 2435, and the core network signal transmission/reception unit 2443. Various control operations performed by the control unit 2433 are based on the signals output from the femto access point unit 2435 and received by the control unit 2433, and a detailed description of them has been already described above and is thus omitted here. In the meantime, when parameters relating to the control operations have been already determined by the service provider and the femto access point provides limited services as described above, the femto access point may not include the control unit 2433.

Hereinafter, a method of relaying a downlink signal received from a macro access point to a UE by a femto access point when the femto access point is in a relay mode will be first described.

First, the macro access point signal transmission/reception unit 2411 receives a downlink signal from a macro access point and outputs the downlink signal to the primary macro access point signal conversion unit 2415. The primary macro access point signal conversion unit 2415 primary-converts the signal output from the macro access point signal transmission/reception unit 2411 to a macro access point signal and then outputs the converted macro access point signal to the digital filter unit 2417. The digital filter unit 2417 performs digital filtering of the signal output from the primary macro access point signal conversion unit 2415 and outputs the filtered signal to the secondary macro access point signal conversion unit 2419. The secondary macro access point signal conversion unit 2419 secondary-converts the signal output from the digital filter unit 2417 to a macro access point signal and then outputs the converted macro access point signal to the combination unit 2421.

The combination unit 2421 combines the signal output from the secondary macro access point signal conversion unit 2419 with the signal output from the secondary core network signal conversion unit 2437 and then outputs the combined signal to the downlink RF transmission unit 2423. The downlink RF transmission unit 2423 performs an outgoing signal RF processing of the signal output from the combination unit 2421 and then outputs the processed signal to the duplexer 2425. The duplexer 2425 transmits the signal output from the downlink RF transmission unit 2423 to a corresponding UE through the antenna 2427 at a corresponding time point.

Second, a method of relaying an uplink signal received from a UE to a macro access point by a femto access point when the femto access point is in a relay mode will be described.

When an uplink signal from a corresponding UE is received through the antenna 2427, the uplink signal received through the antenna 2427 is output to the duplexer 2425. The duplexer 2425 outputs the uplink signal output from the antenna 2427 to the uplink RF reception unit 2429 at a corresponding time point. The uplink RF reception unit 2429 performs an incoming signal RF processing of the signal output from the duplexer 2425 and outputs the processed signal to the distribution unit 2431. The distribution unit 2431 outputs the signal output from the uplink RF reception unit 2429 to the secondary macro access point signal conversion unit 2419.

The secondary macro access point signal conversion unit 2419 performs a secondary conversion of the signal output from the distribution unit 2431 to a macro access point signal and outputs the converted macro access point signal to the digital filter unit 2417. The digital filter unit 2417 performs digital filtering of the signal output from the secondary macro access point signal conversion unit 2419 and outputs the filtered signal to the primary macro access point signal conversion unit 2415. The primary macro access point signal conversion unit 2415 performs a primary conversion of the signal output from the digital filter unit 2417 to a macro access point signal and outputs the converted macro access point signal to the macro access point signal transmission/reception unit 2411. The macro access point signal transmission/reception unit 2411 transmits the signal output from the primary macro access point signal conversion unit 2415 to a corresponding macro access point (or a relay station).

Third, a method of transmitting a downlink signal received from a core network to a UE by a femto access point when the femto access point is in a femto access point mode will be described.

The core network signal transmission/reception unit 2443 receives a downlink signal from the core network, and then outputs the received downlink signal to the primary core network signal conversion unit 2441. The primary core network signal conversion unit 2441 performs a primary conversion of the signal output from the core network signal transmission/reception unit 2443 to a core network signal and outputs the converted core network signal to the core network signal processor unit 2439. The core network signal processor unit 2439 processes the signal output from the primary core network signal conversion unit 2441 and outputs the processed signal to the secondary core network signal conversion unit 2437. The secondary core network signal conversion unit 2437 performs a secondary conversion of the signal output from the core network signal processor unit 2439 to a core network signal and outputs the converted core network signal to the combination unit 2421.

The combination unit 2421 combines the signal output from the secondary core network signal conversion unit 2437 with the signal output from the secondary macro access point signal conversion unit 2419 and then outputs the combined signal to the downlink RF transmission unit 2423. The downlink RF transmission unit 2423 performs an outgoing signal RF processing of the signal output from the combination unit 2421 and then outputs the processed signal to the duplexer 2425. The duplexer 2425 transmits the signal output from the downlink RF transmission unit 2423 to a corresponding UE through the antenna 2427 at a corresponding time point.

Fourth, a method of transmitting an uplink signal received from a UE to a core network by a femto access point when the femto access point is in a femto access point mode will be described.

When an uplink signal from a corresponding UE is received through the antenna 2427, the uplink signal received through the antenna 2427 is output to the duplexer 2425. The duplexer 2425 outputs the uplink signal output from the antenna 2427 to the uplink RF reception unit 2429 at a corresponding time point. The uplink RF reception unit 2429 performs an incoming signal RF processing of the signal output from the duplexer 2425 and outputs the processed signal to the distribution unit 2431. The distribution unit 2431 outputs the signal output from the uplink RF reception unit 2429 to the secondary core network signal conversion unit 2437.

The secondary core network signal conversion unit 2437 performs a secondary conversion of the signal output from the distribution unit 2431 to a core network signal and then outputs the converted signal to the core network signal processor unit 2439. The core network signal processor unit 2439 processes the signal output from the secondary core network signal conversion unit 2437 and outputs the processed signal to the primary core network signal conversion unit 2441. The primary core network signal conversion unit 2441 performs a primary conversion of the signal output from the core network signal processor unit 2439 to a core network signal and then outputs the converted signal to the core network signal transmission/reception unit 2443. The core network signal transmission/reception unit 2443 transmits the signal output from the primary core network signal conversion unit 2441 to the core network.

FIG. 25 is a block diagram illustrating an internal structure of a femto access point according to another embodiment of the present invention.

It should be noted that the internal structure of the femto access point shown in FIG. 25 corresponds to an internal structure in which the relay unit has an optical relay repeater type. Further, when the relay unit is a unit of the optical relay repeater type, since the relay unit includes a DSP capable of analyzing a baseband signal, the relay unit also can analyze a macro access point signal. However, when the relay unit cannot analyze a macro access point signal due to a problem of expense, etc., it is necessary to use the DSP included in a femto access point unit. FIG. 25 is based on an assumption that the relay unit can analyze a macro access point signal.

Referring to FIG. 25, the femto access point includes a macro access point signal transmission/reception unit 2511, a relay unit 2513, a combination unit 2523, a downlink RF transmission unit 2525, a duplexer 2527, an antenna 2529, an uplink RF reception unit 2531, a distribution unit 2533, a control unit 2535, a femto access point unit 2537, and a core network signal transmission/reception unit 2545. The relay unit 2513 includes a primary macro access point signal conversion unit 2515, a signal processor unit 2517, a macro access point signal analysis unit 2519, and a secondary macro access point signal conversion unit 2521, and the femto access point unit 2537 includes a primary core network signal conversion unit 2543, a core network signal processor unit 2541, and a secondary core network signal conversion unit 2539.

Further, the primary macro access point signal conversion unit 2515 includes an optical transmission/reception unit, and the secondary macro access point signal conversion unit 2521 includes a down-converting unit and an up-converting unit.

First, the macro access point signal transmission/reception unit 2511 receives a downlink signal from a macro access point and outputs the downlink signal to the primary macro access point signal conversion unit 2515 or receives an uplink signal from the primary macro access point signal conversion unit 2515 and transmits the uplink signal to the macro access point.

The primary macro access point signal conversion unit 2515 performs a primary conversion of the downlink signal output from the macro access point signal transmission/reception unit 2511 to a macro access point signal and then outputs the primary-converted macro access point signal to the signal processor unit 2517, or performs a primary conversion of the uplink signal output from the signal processor unit 2517 to a macro access point signal and then outputs the primary-converted macro access point signal to the macro access point signal transmission/reception unit 2511.

The signal processor unit 2517 processes the signal output from the primary macro access point signal conversion unit 2515 and outputs the processed signal to the macro access point analysis unit 2519 and the secondary macro access point signal conversion unit 2521, or processes the signal output from the secondary macro access point signal conversion unit 2521 and outputs the processed signal to the primary macro access point signal conversion unit 2515.

The secondary macro access point signal conversion unit 2521 performs a secondary conversion of the signal output from the signal processor unit 2517 to a macro access point signal and then outputs the secondary-converted macro access point signal to the combination unit 2523, or performs a secondary conversion of the signal output from the distribution unit 2533 to a macro access point signal and then outputs the secondary-converted macro access point signal to the signal processor unit 2517. The combination unit 2523 combines the signal output from the secondary macro access point signal conversion unit 2521 with a signal output from the secondary core network signal conversion unit 2539 and outputs the combined signal to the downlink RF transmission unit 2525. The downlink RF transmission unit 2525 performs RF transmission processing of the signal output from the combination unit 2523 and then outputs the processed signal to the duplexer 2527. The duplexer 2527 transmits the signal output from the downlink RF transmission unit 2525 to a corresponding UE through the antenna 2529 at a corresponding time point.

Meanwhile, a signal received from the UE through the antenna 2529 is output to the duplexer 2527, and the duplexer 2527 outputs the signal received through the antenna 2529 to the uplink RF reception unit 2531 at a corresponding time point. The uplink RF reception unit 2531 performs an incoming signal RF processing of the signal output from the duplexer 2527 and then outputs the processed signal to the distribution unit 2533. The distribution unit 2533 determines the unit to which the signal output from the uplink RF reception unit 2531 should be distributed, and then outputs the signal to the secondary macro access point signal conversion unit 2521 or the secondary core network signal conversion unit 2539. The distribution unit 2533 outputs the uplink signal received from the UE to the secondary macro access point signal conversion unit 2521 when the uplink signal received from the UE should be transmitted through the relay unit 2513, and outputs the uplink signal received from the UE to the secondary core network signal conversion unit 2539 when the uplink signal received from the UE should be transmitted through the femto access point unit 2537.

The secondary core network signal conversion unit 2539 performs a secondary conversion of the signal output from the distribution unit 2533 to a core network signal and then outputs the secondary-converted core network signal to the core network signal processor unit 2541, or performs a secondary conversion of the signal output from the core network signal processor unit 2541 to a core network signal and then outputs the secondary-converted core network signal to the distribution unit 2533. The core network signal processor unit 2541 performs signal processing of the signal output from the secondary core network signal conversion unit 2539 and then outputs the processed signal to the primary core network signal conversion unit 2543, or performs signal processing of the signal output from the primary core network signal conversion unit 2543 and then outputs the processed signal to the secondary core network signal conversion unit 2539.

The primary core network signal conversion unit 2543 performs a primary conversion of the signal output from the core network signal processor unit 2541 to a core network signal and then outputs the primary-converted core network signal to the core network signal transmission/reception unit 2545, or performs a primary conversion of the signal output from the core network signal transmission/reception unit 2545 to a core network signal and then outputs the primary-converted core network signal to the core network signal processor unit 2541. The core network signal transmission/reception unit 2545 transmits the signal output from the primary core network signal conversion unit 2543 to a core network, or outputs a signal received through the core network to the primary core network signal conversion unit 2543.

Further, the control unit 2535 controls the operations of the macro access point signal transmission/reception unit 2511, the relay unit 2513, the downlink RF transmission unit 2525, the uplink RF reception unit 2531, the femto access point unit 2537, and the core network signal transmission/reception unit 2545. Various control operations performed by the control unit 2535 are based on the signals output from the femto access point unit 2537 and received by the control unit 2535, and a detailed description of them has been already described above and is thus omitted here. In the meantime, when parameters relating to the control operations have been already determined by the service provider and the femto access point provides limited services as described above, the femto access point may not include the control unit 2535.

Further, the macro access point signal analysis unit 2519 analyzes the signal output from the signal processor unit 2517 and then outputs the analyzed signal to the control unit 2535.

Hereinafter, a method of relaying a downlink signal received from a macro access point to a UE by a femto access point when the femto access point is in a relay mode will be first described.

First, the macro access point signal transmission/reception unit 2511 receives a downlink signal from a macro access point and outputs the downlink signal to the primary macro access point signal conversion unit 2515. The primary macro access point signal conversion unit 2515 primary-converts the signal output from the macro access point signal transmission/reception unit 2511 to a macro access point signal and then outputs the converted macro access point signal to the signal processor unit 2517. The signal processor unit 2517 performs signal processing of the signal output from the primary macro access point signal conversion unit 2515 and outputs the processed signal to the secondary macro access point signal conversion unit 2521 and the macro access point signal analysis unit 2519. The secondary macro access point signal conversion unit 2521 secondary-converts the signal output from the signal processor unit 2517 to a macro access point signal and then outputs the converted macro access point signal to the combination unit 2523.

The combination unit 2523 combines the signal output from the secondary macro access point signal conversion unit 2521 with the signal output from the secondary core network signal conversion unit 2539 and then outputs the combined signal to the downlink RF transmission unit 2525. The downlink RF transmission unit 2525 performs an outgoing signal RF processing of the signal output from the combination unit 2523 and then outputs the processed signal to the duplexer 2527. The duplexer 2527 transmits the signal output from the downlink RF transmission unit 2525 to a corresponding UE through the antenna 2529 at a corresponding time point.

Second, a method of relaying an uplink signal received from a UE to a macro access point by a femto access point when the femto access point is in a relay mode will be described.

When an uplink signal from a corresponding UE is received through the antenna 2529, the uplink signal received through the antenna 2529 is output to the duplexer 2527. The duplexer 2527 outputs the uplink signal output from the antenna 2529 to the uplink RF reception unit 2531 at a corresponding time point. The uplink RF reception unit 2531 performs an incoming signal RF processing of the signal output from the duplexer 2527 and outputs the processed signal to the distribution unit 2533. The distribution unit 2533 outputs the signal output from the uplink RF reception unit 2531 to the secondary macro access point signal conversion unit 2521.

The secondary macro access point signal conversion unit 2521 performs a secondary conversion of the signal output from the distribution unit 2533 to a macro access point signal and outputs the converted macro access point signal to the signal processor unit 2517. The signal processor unit 2517 performs signal processing of the signal output from the secondary macro access point signal conversion unit 2521 and outputs the processed signal to the primary macro access point signal conversion unit 2515. The primary macro access point signal conversion unit 2515 performs a primary conversion of the signal output from the signal processor unit 2517 to a macro access point signal and outputs the converted macro access point signal to the macro access point signal transmission/reception unit 2511. The macro access point signal transmission/reception unit 2511 transmits the signal output from the primary macro access point signal conversion unit 2515 to a corresponding macro access point (or a relay station).

Third, a method of transmitting a downlink signal received from a core network to a UE by a femto access point when the femto access point is in a femto access point mode will be described.

The core network signal transmission/reception unit 2545 receives a downlink signal from the core network, and then outputs the received downlink signal to the primary core network signal conversion unit 2543. The primary core network signal conversion unit 2543 performs a primary conversion of the signal output from the core network signal transmission/reception unit 2545 to a core network signal and outputs the converted core network signal to the core network signal processor unit 2541. The core network signal processor unit 2541 processes the signal output from the primary core network signal conversion unit 2543 and outputs the processed signal to the secondary core network signal conversion unit 2539. The secondary core network signal conversion unit 2539 performs a secondary conversion of the signal output from the core network signal processor unit 2541 to a core network signal and outputs the converted core network signal to the combination unit 2523.

The combination unit 2523 combines the signal output from the secondary core network signal conversion unit 2539 with the signal output from the secondary macro access point signal conversion unit 2521 and then outputs the combined signal to the downlink RF transmission unit 2525. The downlink RF transmission unit 2525 performs an outgoing signal RF processing of the signal output from the combination unit 2523 and then outputs the processed signal to the duplexer 2527. The duplexer 2527 transmits the signal output from the downlink RF transmission unit 2525 to a corresponding UE through the antenna 2529 at a corresponding time point.

Fourth, a method of transmitting an uplink signal received from a UE to a core network by a femto access point when the femto access point is in a femto access point mode will be described.

When an uplink signal from a corresponding UE is received through the antenna 2529, the uplink signal received through the antenna 2529 is output to the duplexer 2527. The duplexer 2527 outputs the uplink signal output from the antenna 2529 to the uplink RF reception unit 2531 at a corresponding time point. The uplink RF reception unit 2531 performs an incoming signal RF processing of the signal output from the duplexer 2527 and outputs the processed signal to the distribution unit 2533. The distribution unit 2533 outputs the signal output from the uplink RF reception unit 2531 to the secondary core network signal conversion unit 2539.

The secondary core network signal conversion unit 2539 performs a secondary conversion of the signal output from the distribution unit 2533 to a core network signal and then outputs the converted signal to the core network signal processor unit 2541. The core network signal processor unit 2541 processes the signal output from the secondary core network signal conversion unit 2539 and outputs the processed signal to the primary core network signal conversion unit 2543. The primary core network signal conversion unit 2543 performs a primary conversion of the signal output from the core network signal processor unit 2541 to a core network signal and then outputs the converted signal to the core network signal transmission/reception unit 2545. The core network signal transmission/reception unit 2545 transmits the signal output from the primary core network signal conversion unit 2543 to the core network.

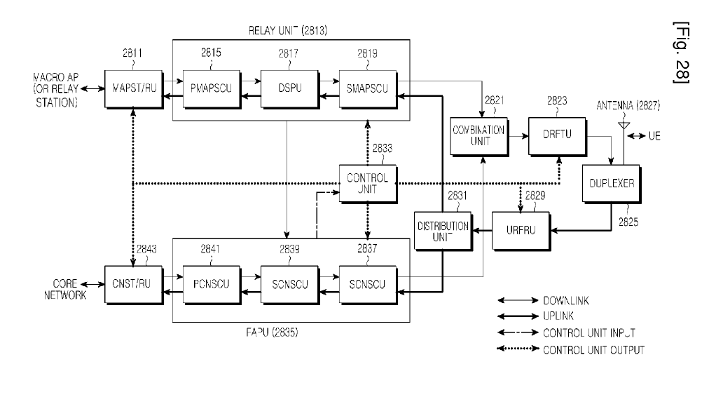

FIG. 26 is a block diagram illustrating an internal structure of a femto access point according to another embodiment of the present invention.

It should be noted that the internal structure of the femto access point shown in FIG. 26 corresponds to an internal structure in which the relay unit has an optical relay repeater type. Further, when the relay unit is a unit of the optical relay repeater type, since the relay unit includes a DSP capable of analyzing a baseband signal, the relay unit also can analyze a macro access point signal. However, when the relay unit cannot analyze a macro access point signal due to a problem of expense, etc., it is necessary to use the DSP included in a femto access point unit. FIG. 26 is based on an assumption that the relay unit uses a DSP included in the femto access point unit.

Referring to FIG. 26, the femto access point includes a macro access point signal transmission/reception unit 2611, a relay unit 2613, a combination unit 2621, a downlink RF transmission unit 2623, a duplexer 2625, an antenna 2627, an uplink RF reception unit 2629, a distribution unit 2631, a control unit 2633, a femto access point unit 2635, and a core network signal transmission/reception unit 2643. The relay unit 2613 includes a primary macro access point signal conversion unit 2615, a signal processor unit 2617, and a secondary macro access point signal conversion unit 2619, and the femto access point unit 2635 includes a primary core network signal conversion unit 2641, a core network signal processor unit 2639, and a secondary core network signal conversion unit 2637. Further, the primary macro access point signal conversion unit 2615 includes an optical transmission/reception unit, and the secondary macro access point signal conversion unit 2619 includes a down-converting unit and an up-converting unit.

First, the macro access point signal transmission/reception unit 2611 receives a downlink signal from a macro access point and outputs the downlink signal to the primary macro access point signal conversion unit 2615 or receives an uplink signal from the primary macro access point signal conversion unit 2615 and transmits the uplink signal to the macro access point.

The primary macro access point signal conversion unit 2615 performs a primary conversion of the downlink signal output from the macro access point signal transmission/reception unit 2611 to a macro access point signal and then outputs the primary-converted macro access point signal to the signal processor unit 2617, or performs a primary conversion of the uplink signal output from the signal processor unit 2617 to a macro access point signal and then outputs the primary-converted macro access point signal to the macro access point signal transmission/reception unit 2611.

The signal processor unit 2617 performs signal processing of the signal output from the primary macro access point signal conversion unit 2615 and outputs the filtered signal to the secondary macro access point signal conversion unit 2619, or performs signal processing of the signal output from the secondary macro access point signal conversion unit 2619 and outputs the filtered signal to the primary macro access point signal conversion unit 2615.

The secondary macro access point signal conversion unit 2619 performs a secondary conversion of the signal output from the signal processor unit 2617 to a macro access point signal and then outputs the secondary-converted macro access point signal to the combination unit 2621, or performs a secondary conversion of the signal output from the distribution unit 2631 to a macro access point signal and then outputs the secondary-converted macro access point signal to the signal processor unit 2617.

The combination unit 2621 combines the signal output from the secondary macro access point signal conversion unit 2619 with a signal output from the secondary core network signal conversion unit 2637 and outputs the combined signal to the downlink RF transmission unit 2623. The downlink RF transmission unit 2623 performs RF transmission processing of the signal output from the combination unit 2621 and then outputs the processed signal to the duplexer 2625. The duplexer 2625 transmits the signal output from the downlink RF transmission unit 2623 to a corresponding UE through the antenna 2627 at a corresponding time point.

Meanwhile, a signal received from the UE through the antenna 2627 is output to the duplexer 2625, and the duplexer 2625 outputs the signal received through the antenna 2627 to the uplink RF reception unit 2629 at a corresponding time point. The uplink RF reception unit 2629 performs an incoming signal RF processing of the signal output from the duplexer 2625 and then outputs the processed signal to the distribution unit 2631. The distribution unit 2631 determines the unit to which the signal output from the uplink RF reception unit 2629 should be distributed, and then outputs the signal to the secondary macro access point signal conversion unit 2619 or the secondary core network signal conversion unit 2637. The distribution unit 2631 outputs the uplink signal received from the UE to the secondary macro access point signal conversion unit 2619 when the uplink signal received from the UE should be transmitted through the relay unit 2613, and outputs the uplink signal received from the UE to the secondary core network signal conversion unit 2637 when the uplink signal received from the UE should be transmitted through the femto access point unit 2635.

The secondary core network signal conversion unit 2637 performs a secondary conversion of the signal output from the distribution unit 2631 to a core network signal and then outputs the secondary-converted core network signal to the core network signal processor unit 2639, or performs a secondary conversion of the signal output from the core network signal processor unit 2639 to a core network signal and then outputs the secondary-converted core network signal to the distribution unit 2631.

The core network signal processor unit 2639 performs signal processing of the signal output from the secondary core network signal conversion unit 2637 and then outputs the processed signal to the primary core network signal conversion unit 2641, or performs signal processing of the signal output from the primary core network signal conversion unit 2641 and then outputs the processed signal to the secondary core network signal conversion unit 2637.

The primary core network signal conversion unit 2641 performs a primary conversion of the signal output from the core network signal processor unit 2639 to a core network signal and then outputs the primary-converted core network signal to the core network signal transmission/reception unit 2643, or performs a primary conversion of the signal output from the core network signal transmission/reception unit 2643 to a core network signal and then outputs the primary-converted core network signal to the core network signal processor unit 2639. The core network signal transmission/reception unit 2643 transmits the signal output from the primary core network signal conversion unit 2641 to a core network, or outputs a signal received through the core network to the primary core network signal conversion unit 2641.

Further, the control unit 2633 controls the operations of the macro access point signal transmission/reception unit 2611, the relay unit 2613, the downlink RF transmission unit 2623, the uplink RF reception unit 2629, the femto access point unit 2635, and the core network signal transmission/reception unit 2643. Various control operations performed by the control unit 2633 are based on the signals output from the femto access point unit 2635 and received by the control unit 2633, and a detailed description of them has been already described above and is thus omitted here. In the meantime, when parameters relating to the control operations have been already determined by the service provider and the femto access point provides limited services as described above, the femto access point may not include the control unit 2633.

Hereinafter, a method of relaying a downlink signal received from a macro access point to a UE by a femto access point when the femto access point is in a relay mode will be first described.

First, the macro access point signal transmission/reception unit 2611 receives a downlink signal from a macro access point and outputs the downlink signal to the primary macro access point signal conversion unit 2615. The primary macro access point signal conversion unit 2615 primary-converts the signal output from the macro access point signal transmission/reception unit 2611 to a macro access point signal and then outputs the converted macro access point signal to the signal processor unit 2617. The signal processor unit 2617 performs signal processing of the signal output from the primary macro access point signal conversion unit 2615 and outputs the processed signal to the secondary macro access point signal conversion unit 2619. The secondary macro access point signal conversion unit 2619 secondary-converts the signal output from the signal processor unit 2617 to a macro access point signal and then outputs the converted macro access point signal to the combination unit 2621.

The combination unit 2621 combines the signal output from the secondary macro access point signal conversion unit 2619 with the signal output from the secondary core network signal conversion unit 2637 and then outputs the combined signal to the downlink RF transmission unit 2623. The downlink RF transmission unit 2623 performs an outgoing signal RF processing of the signal output from the combination unit 2621 and then outputs the processed signal to the duplexer 2625. The duplexer 2625 transmits the signal output from the downlink RF transmission unit 2623 to a corresponding UE through the antenna 2627 at a corresponding time point.

Second, a method of relaying an uplink signal received from a UE to a macro access point by a femto access point when the femto access point is in a relay mode will be described.

When an uplink signal from a corresponding UE is received through the antenna 2627, the uplink signal received through the antenna 2627 is output to the duplexer 2625. The duplexer 2625 outputs the uplink signal output from the antenna 2627 to the uplink RF reception unit 2629 at a corresponding time point. The uplink RF reception unit 2629 performs an incoming signal RF processing of the signal output from the duplexer 2625 and outputs the processed signal to the distribution unit 2631. The distribution unit 2631 outputs the signal output from the uplink RF reception unit 2629 to the secondary macro access point signal conversion unit 2619.

The secondary macro access point signal conversion unit 2619 performs a secondary conversion of the signal output from the distribution unit 2631 to a macro access point signal and outputs the converted macro access point signal to the signal processor unit 2617. The signal processor unit 2617 performs signal processing of the signal output from the secondary macro access point signal conversion unit 2619 and outputs the processed signal to the primary macro access point signal conversion unit 2615. The primary macro access point signal conversion unit 2615 performs a primary conversion of the signal output from the signal processor unit 2617 to a macro access point signal and outputs the converted macro access point signal to the macro access point signal transmission/reception unit 2611. The macro access point signal transmission/reception unit 2611 transmits the signal output from the primary macro access point signal conversion unit 2615 to a corresponding macro access point (or a relay station).

Third, a method of transmitting a downlink signal received from a core network to a UE by a femto access point when the femto access point is in a femto access point mode will be described.

The core network signal transmission/reception unit 2643 receives a downlink signal from the core network, and then outputs the received downlink signal to the primary core network signal conversion unit 2641. The primary core network signal conversion unit 2641 performs a primary conversion of the signal output from the core network signal transmission/reception unit 2643 to a core network signal and outputs the converted core network signal to the core network signal processor unit 2639. The core network signal processor unit 2639 processes the signal output from the primary core network signal conversion unit 2641 and outputs the processed signal to the secondary core network signal conversion unit 2637. The secondary core network signal conversion unit 2637 performs a secondary conversion of the signal output from the core network signal processor unit 2639 to a core network signal and outputs the converted core network signal to the combination unit 2621.

The combination unit 2621 combines the signal output from the secondary core network signal conversion unit 2637 with the signal output from the secondary macro access point signal conversion unit 2619 and then outputs the combined signal to the downlink RF transmission unit 2623. The downlink RF transmission unit 2623 performs an outgoing signal RF processing of the signal output from the combination unit 2621 and then outputs the processed signal to the duplexer 2625. The duplexer 2625 transmits the signal output from the downlink RF transmission unit 2623 to a corresponding UE through the antenna 2627 at a corresponding time point.

Fourth, a method of transmitting an uplink signal received from a UE to a core network by a femto access point when the femto access point is in a femto access point mode will be described.

When an uplink signal from a corresponding UE is received through the antenna 2627, the uplink signal received through the antenna 2627 is output to the duplexer 2625. The duplexer 2625 outputs the uplink signal output from the antenna 2627 to the uplink RF reception unit 2629 at a corresponding time point. The uplink RF reception unit 2629 performs an incoming signal RF processing of the signal output from the duplexer 2625 and outputs the processed signal to the distribution unit 2631. The distribution unit 2631 outputs the signal output from the uplink RF reception unit 2629 to the secondary core network signal conversion unit 2637.

The secondary core network signal conversion unit 2637 performs a secondary conversion of the signal output from the distribution unit 2631 to a core network signal and then outputs the converted signal to the core network signal processor unit 2639. The core network signal processor unit 2639 processes the signal output from the secondary core network signal conversion unit 2637 and outputs the processed signal to the primary core network signal conversion unit 2641. The primary core network signal conversion unit 2641 performs a primary conversion of the signal output from the core network signal processor unit 2639 to a core network signal and then outputs the converted signal to the core network signal transmission/reception unit 2643. The core network signal transmission/reception unit 2643 transmits the signal output from the primary core network signal conversion unit 2641 to the core network.

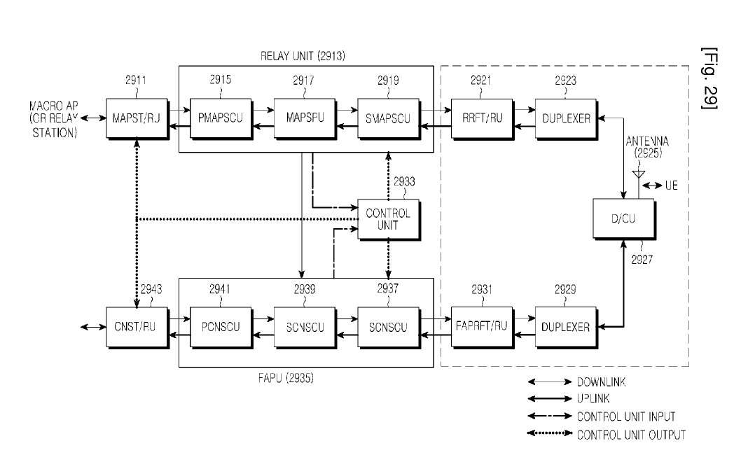

FIG. 27 is a block diagram illustrating an internal structure of a femto access point according to another embodiment of the present invention.

It should be noted that the internal structure of the femto access point shown in FIG. 27 corresponds to an internal structure in which the relay unit has a relay type. Further, when the relay unit is a unit of the relay type, since the relay unit includes a DSP capable of analyzing a baseband signal, the relay unit also can analyze a macro access point signal. However, when the relay unit cannot analyze a macro access point signal due to a problem of expense, etc., it is necessary to use the DSP included in a femto access point unit. FIG. 27 is based on an assumption that the relay unit can analyze a macro access point signal.

Referring to FIG. 27, the femto access point includes a macro access point signal transmission/reception unit 2711, a relay unit 2713, a combination unit 2723, a downlink RF transmission unit 2725, a duplexer 2727, an antenna 2729, an uplink RF reception unit 2731, a distribution unit 2733, a control unit 2735, a femto access point unit 2737, and a core network signal transmission/reception unit 2745. The relay unit 2713 includes a primary macro access point signal conversion unit 2715, a digital signal processor unit 2717, a macro access point signal analysis unit 2719, and a secondary macro access point signal conversion unit 2721, and the femto access point unit 2737 includes a primary core network signal conversion unit 2743, a core network signal processor unit 2741, and a secondary core network signal conversion unit 2739. Further, each of the primary macro access point signal conversion unit 2715 and the secondary macro access point signal conversion unit 2721 includes a down-converting unit and an up-converting unit.

First, the macro access point signal transmission/reception unit 2711 receives a downlink signal from a macro access point and outputs the downlink signal to the primary macro access point signal conversion unit 2715 or receives an uplink signal from the primary macro access point signal conversion unit 2715 and transmits the uplink signal to the macro access point.

The primary macro access point signal conversion unit 2715 performs a primary conversion of the downlink signal output from the macro access point signal transmission/reception unit 2711 to a macro access point signal and then outputs the primary-converted macro access point signal to the digital signal processor unit 2717, or performs a primary conversion of the uplink signal output from the digital signal processor unit 2717 to a macro access point signal and then outputs the primary-converted macro access point signal to the macro access point signal transmission/reception unit 2711.

The digital signal processor unit 2717 processes the signal output from the primary macro access point signal conversion unit 2715 and outputs the processed signal to the macro access point analysis unit 2719 and the secondary macro access point signal conversion unit 2721, or processes the signal output from the secondary macro access point signal conversion unit 2721 and outputs the processed signal to the primary macro access point signal conversion unit 2715.

The secondary macro access point signal conversion unit 2721 performs a secondary conversion of the signal output from the digital signal processor unit 2717 to a macro access point signal and then outputs the secondary-converted macro access point signal to the combination unit 2723, or performs a secondary conversion of the signal output from the distribution unit 2733 to a macro access point signal and then outputs the secondary-converted macro access point signal to the digital signal processor unit 2717. The combination unit 2723 combines the signal output from the secondary macro access point signal conversion unit 2721 with a signal output from the secondary core network signal conversion unit 2739 and outputs the combined signal to the downlink RF transmission unit 2725. The downlink RF transmission unit 2725 performs RF transmission processing of the signal output from the combination unit 2723 and then outputs the processed signal to the duplexer 2727. The duplexer 2727 transmits the signal output from the downlink RF transmission unit 2725 to a corresponding UE through the antenna 2729 at a corresponding time point.

Meanwhile, a signal received from the UE through the antenna 2729 is output to the duplexer 2727, and the duplexer 2727 outputs the signal received through the antenna 2729 to the uplink RF reception unit 2731 at a corresponding time point. The uplink RF reception unit 2731 performs an incoming signal RF processing of the signal output from the duplexer 2727 and then outputs the processed signal to the distribution unit 2733. The distribution unit 2733 determines the unit to which the signal output from the uplink RF reception unit 2731 should be distributed, and then outputs the signal to the secondary macro access point signal conversion unit 2721 or the secondary core network signal conversion unit 2739. The distribution unit 2733 outputs the uplink signal received from the UE to the secondary macro access point signal conversion unit 2721 when the uplink signal received from the UE should be transmitted through the relay unit 2713, and outputs the uplink signal received from the UE to the secondary core network signal conversion unit 2739 when the uplink signal received from the UE should be transmitted through the femto access point unit 2737.

The secondary core network signal conversion unit 2739 performs a secondary conversion of the signal output from the distribution unit 2733 to a core network signal and then outputs the secondary-converted core network signal to the core network signal processor unit 2741, or performs a secondary conversion of the signal output from the core network signal processor unit 2741 to a core network signal and then outputs the secondary-converted core network signal to the distribution unit 2733. The core network signal processor unit 2741 performs signal processing of the signal output from the secondary core network signal conversion unit 2739 and then outputs the processed signal to the primary core network signal conversion unit 2743, or performs signal processing of the signal output from the primary core network signal conversion unit 2743 and then outputs the processed signal to the secondary core network signal conversion unit 2739.

The primary core network signal conversion unit 2743 performs a primary conversion of the signal output from the core network signal processor unit 2741 to a core network signal and then outputs the primary-converted core network signal to the core network signal transmission/reception unit 2745, or performs a primary conversion of the signal output from the core network signal transmission/reception unit 2745 to a core network signal and then outputs the primary-converted core network signal to the core network signal processor unit 2741. The core network signal transmission/reception unit 2745 transmits the signal output from the primary core network signal conversion unit 2743 to a core network, or outputs a signal received through the core network to the primary core network signal conversion unit 2743.

Further, the control unit 2735 controls the operations of the macro access point signal transmission/reception unit 2711, the relay unit 2713, the downlink RF transmission unit 2725, the uplink RF reception unit 2731, the femto access point unit 2737, and the core network signal transmission/reception unit 2745. Various control operations performed by the control unit 2735 are based on the signals output from the femto access point unit 2737 and the macro access point signal analysis unit 2719 and received by the control unit 2735, and a detailed description of them has been already described above and is thus omitted here. In the meantime, when parameters relating to the control operations have been already determined by the service provider and the femto access point provides limited services as described above, the femto access point may not include the control unit 2735.

Further, the macro access point signal analysis unit 2719 analyzes the signal output from the digital signal processor unit 2717 and then outputs the analyzed signal to the control unit 2735.

Hereinafter, a method of relaying a downlink signal received from a macro access point to a UE by a femto access point when the femto access point is in a relay mode will be first described.

First, the macro access point signal transmission/reception unit 2711 receives a downlink signal from a macro access point and outputs the downlink signal to the primary macro access point signal conversion unit 2715. The primary macro access point signal conversion unit 2715 primary-converts the signal output from the macro access point signal transmission/reception unit 2711 to a macro access point signal and then outputs the converted macro access point signal to the digital signal processor unit 2717. The digital signal processor unit 2717 performs signal processing of the signal output from the primary macro access point signal conversion unit 2715 and outputs the processed signal to the secondary macro access point signal conversion unit 2721 and the macro access point signal analysis unit 2719. The secondary macro access point signal conversion unit 2721 secondary-converts the signal output from the digital signal processor unit 2717 to a macro access point signal and then outputs the converted macro access point signal to the combination unit 2723.

The combination unit 2723 combines the signal output from the secondary macro access point signal conversion unit 2721 with the signal output from the secondary core network signal conversion unit 2739 and then outputs the combined signal to the downlink RF transmission unit 2725. The downlink RF transmission unit 2725 performs an outgoing signal RF processing of the signal output from the combination unit 2723 and then outputs the processed signal to the duplexer 2727. The duplexer 2727 transmits the signal output from the downlink RF transmission unit 2725 to a corresponding UE through the antenna 2729 at a corresponding time point.

Second, a method of relaying an uplink signal received from a UE to a macro access point by a femto access point when the femto access point is in a relay mode will be described.

When an uplink signal from a corresponding UE is received through the antenna 2729, the uplink signal received through the antenna 2729 is output to the duplexer 2727. The duplexer 2727 outputs the uplink signal output from the antenna 2729 to the uplink RF reception unit 2731 at a corresponding time point. The uplink RF reception unit 2731 performs an incoming signal RF processing of the signal output from the duplexer 2727 and outputs the processed signal to the distribution unit 2733. The distribution unit 2733 outputs the signal output from the uplink RF reception unit 2731 to the secondary macro access point signal conversion unit 2721.

The secondary macro access point signal conversion unit 2721 performs a secondary conversion of the signal output from the distribution unit 2733 to a macro access point signal and outputs the converted macro access point signal to the digital signal processor unit 2717. The digital signal processor unit 2717 performs signal processing of the signal output from the secondary macro access point signal conversion unit 2721 and outputs the processed signal to the primary macro access point signal conversion unit 2715. The primary macro access point signal conversion unit 2715 performs a primary conversion of the signal output from the digital signal processor unit 2717 to a macro access point signal and outputs the converted macro access point signal to the macro access point signal transmission/reception unit 2711. The macro access point signal transmission/reception unit 2711 transmits the signal output from the primary macro access point signal conversion unit 2715 to a corresponding macro access point (or a relay station).

Third, a method of transmitting a downlink signal received from a core network to a UE by a femto access point when the femto access point is in a femto access point mode will be described.

The core network signal transmission/reception unit 2745 receives a downlink signal from the core network, and then outputs the received downlink signal to the primary core network signal conversion unit 2743. The primary core network signal conversion unit 2743 performs a primary conversion of the signal output from the core network signal transmission/reception unit 2745 to a core network signal and outputs the converted core network signal to the core network signal processor unit 2741. The core network signal processor unit 2741 processes the signal output from the primary core network signal conversion unit 2743 and outputs the processed signal to the secondary core network signal conversion unit 2739. The secondary core network signal conversion unit 2739 performs a secondary conversion of the signal output from the core network signal processor unit 2741 to a core network signal and outputs the converted core network signal to the combination unit 2723.

The combination unit 2723 combines the signal output from the secondary core network signal conversion unit 2739 with the signal output from the secondary macro access point signal conversion unit 2721 and then outputs the combined signal to the downlink RF transmission unit 2725. The downlink RF transmission unit 2725 performs an outgoing signal RF processing of the signal output from the combination unit 2723 and then outputs the processed signal to the duplexer 2727. The duplexer 2727 transmits the signal output from the downlink RF transmission unit 2725 to a corresponding UE through the antenna 2729 at a corresponding time point.

Fourth, a method of transmitting an uplink signal received from a UE to a core network by a femto access point when the femto access point is in a femto access point mode will be described.

When an uplink signal from a corresponding UE is received through the antenna 2729, the uplink signal received through the antenna 2729 is output to the duplexer 2727. The duplexer 2727 outputs the uplink signal output from the antenna 2729 to the uplink RF reception unit 2731 at a corresponding time point. The uplink RF reception unit 2731 performs an incoming signal RF processing of the signal output from the duplexer 2727 and outputs the processed signal to the distribution unit 2733. The distribution unit 2733 outputs the signal output from the uplink RF reception unit 2731 to the secondary core network signal conversion unit 2739. The secondary core network signal conversion unit 2739 performs a secondary conversion of the signal output from the distribution unit 2733 to a core network signal and then outputs the converted signal to the core network signal processor unit 2741. The core network signal processor unit 2741 processes the signal output from the secondary core network signal conversion unit 2739 and outputs the processed signal to the primary core network signal conversion unit 2743. The primary core network signal conversion unit 2743 performs a primary conversion of the signal output from the core network signal processor unit 2741 to a core network signal and then outputs the converted signal to the core network signal transmission/reception unit 2745. The core network signal transmission/reception unit 2745 transmits the signal output from the primary core network signal conversion unit 2743 to the core network.

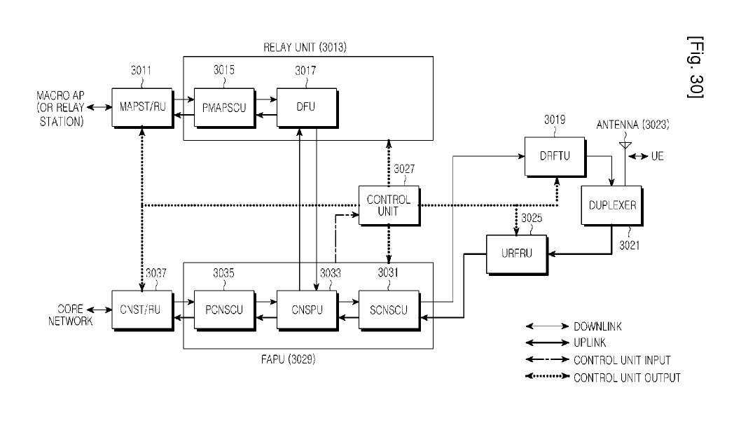

FIG. 28 is a block diagram illustrating an internal structure of a femto access point according to another embodiment of the present invention.

It should be noted that the internal structure of the femto access point shown in FIG. 28 corresponds to an internal structure in which the relay unit has a relay type. Further, when the relay unit is a unit of the relay type, since the relay unit includes a DSP capable of analyzing a baseband signal, the relay unit also can analyze a macro access point signal. However, when the relay unit cannot analyze a macro access point signal due to a problem of expense, etc., it is necessary to use the DSP included in a femto access point unit. FIG. 28 is based on an assumption that the relay unit uses a DSP included in the femto access point unit.

Referring to FIG. 28, the femto access point includes a macro access point signal transmission/reception unit 2811, a relay unit 2813, a combination unit 2821, a downlink RF transmission unit 2823, a duplexer 2825, an antenna 2827, an uplink RF reception unit 2829, a distribution unit 2831, a control unit 2833, a femto access point unit 2835, and a core network signal transmission/reception unit 2843. The relay unit 2813 includes a primary macro access point signal conversion unit 2815, a digital signal processor unit 2817, and a secondary macro access point signal conversion unit 2819, and the femto access point unit 2835 includes a primary core network signal conversion unit 2841, a core network signal processor unit 2839, and a secondary core network signal conversion unit 2837.

Further, each of the primary macro access point signal conversion unit 2815 and the secondary macro access point signal conversion unit 2819 includes a down-converting unit and an up-converting unit.

First, the macro access point signal transmission/reception unit 2811 receives a downlink signal from a macro access point and outputs the downlink signal to the primary macro access point signal conversion unit 2815 or receives an uplink signal from the primary macro access point signal conversion unit 2815 and transmits the uplink signal to the macro access point.

The primary macro access point signal conversion unit 2815 performs a primary conversion of the downlink signal output from the macro access point signal transmission/reception unit 2811 to a macro access point signal and then outputs the primary-converted macro access point signal to the digital signal processor unit 2817, or performs a primary conversion of the uplink signal output from the digital signal processor unit 2817 to a macro access point signal and then outputs the primary-converted macro access point signal to the macro access point signal transmission/reception unit 2811.

The digital signal processor unit 2817 performs signal processing of the signal output from the primary macro access point signal conversion unit 2815 and outputs the processed signal to the secondary macro access point signal conversion unit 2819, or performs signal processing of the signal output from the secondary macro access point signal conversion unit 2819 and outputs the processed signal to the primary macro access point signal conversion unit 2815.

The secondary macro access point signal conversion unit 2819 performs a secondary conversion of the signal output from the digital signal processor unit 2817 to a macro access point signal and then outputs the secondary-converted macro access point signal to the combination unit 2821, or performs a secondary conversion of the signal output from the distribution unit 2831 to a macro access point signal and then outputs the secondary-converted macro access point signal to the digital signal processor unit 2817. The combination unit 2821 combines the signal output from the secondary macro access point signal conversion unit 2819 with a signal output from the secondary core network signal conversion unit 2837 and outputs the combined signal to the downlink RF transmission unit 2823. The downlink RF transmission unit 2823 performs RF transmission processing of the signal output from the combination unit 2821 and then outputs the processed signal to the duplexer 2825. The duplexer 2825 transmits the signal output from the downlink RF transmission unit 2823 to a corresponding UE through the antenna 2827 at a corresponding time point.

Meanwhile, a signal received from the UE through the antenna 2827 is output to the duplexer 2825, and the duplexer 2825 outputs the signal received through the antenna 2827 to the uplink RF reception unit 2829 at a corresponding time point. The uplink RF reception unit 2829 performs an incoming signal RF processing of the signal output from the duplexer 2825 and then outputs the processed signal to the distribution unit 2831. The distribution unit 2831 determines the unit to which the signal output from the uplink RF reception unit 2829 should be distributed, and then outputs the signal to the secondary macro access point signal conversion unit 2819 or the secondary core network signal conversion unit 2837. The distribution unit 2831 outputs the uplink signal received from the UE to the secondary macro access point signal conversion unit 2819 when the uplink signal received from the UE should be transmitted through the relay unit 2813, and outputs the uplink signal received from the UE to the secondary core network signal conversion unit 2837 when the uplink signal received from the UE should be transmitted through the femto access point unit 2835.

The secondary core network signal conversion unit 2837 performs a secondary conversion of the signal output from the distribution unit 2831 to a core network signal and then outputs the secondary-converted core network signal to the core network signal processor unit 2839, or performs a secondary conversion of the signal output from the core network signal processor unit 2839 to a core network signal and then outputs the secondary-converted core network signal to the distribution unit 2831. The core network signal processor unit 2839 performs signal processing of the signal output from the secondary core network signal conversion unit 2837 and then outputs the processed signal to the primary core network signal conversion unit 2841, or performs signal processing of the signal output from the primary core network signal conversion unit 2841 and then outputs the processed signal to the secondary core network signal conversion unit 2837.

The primary core network signal conversion unit 2841 performs a primary conversion of the signal output from the core network signal processor unit 2839 to a core network signal and then outputs the primary-converted core network signal to the core network signal transmission/reception unit 2843, or performs a primary conversion of the signal output from the core network signal transmission/reception unit 2843 to a core network signal and then outputs the primary-converted core network signal to the core network signal processor unit 2839. The core network signal transmission/reception unit 2843 transmits the signal output from the primary core network signal conversion unit 2841 to a core network, or outputs a signal received through the core network to the primary core network signal conversion unit 2841.

Further, the control unit 2833 controls the operations of the macro access point signal transmission/reception unit 2811, the relay unit 2813, the downlink RF transmission unit 2823, the uplink RF reception unit 2829, the femto access point unit 2835, and the core network signal transmission/reception unit 2843. Various control operations performed by the control unit 2833 are based on the signals output from the femto access point unit 2835 and received by the control unit 2833, and a detailed description of them has been already described above and is thus omitted here. In the meantime, when parameters relating to the control operations have been already determined by the service provider and the femto access point provides limited services as described above, the femto access point may not include the control unit 2833.

Hereinafter, a method of relaying a downlink signal received from a macro access point to a UE by a femto access point when the femto access point is in a relay mode will be first described.

First, the macro access point signal transmission/reception unit 2811 receives a downlink signal from a macro access point and outputs the downlink signal to the primary macro access point signal conversion unit 2815. The primary macro access point signal conversion unit 2815 primary-converts the signal output from the macro access point signal transmission/reception unit 2811 to a macro access point signal and then outputs the converted macro access point signal to the digital signal processor unit 2817. The digital signal processor unit 2817 performs signal processing of the signal output from the primary macro access point signal conversion unit 2815 and outputs the processed signal to the secondary macro access point signal conversion unit 2819. The secondary macro access point signal conversion unit 2819 secondary-converts the signal output from the digital signal processor unit 2817 to a macro access point signal and then outputs the converted macro access point signal to the combination unit 2821.

The combination unit 2821 combines the signal output from the secondary macro access point signal conversion unit 2819 with the signal output from the secondary core network signal conversion unit 2837 and then outputs the combined signal to the downlink RF transmission unit 2823. The downlink RF transmission unit 2823 performs an outgoing signal RF processing of the signal output from the combination unit 2821 and then outputs the processed signal to the duplexer 2825. The duplexer 2825 transmits the signal output from the downlink RF transmission unit 2823 to a corresponding UE through the antenna 2827 at a corresponding time point.

Second, a method of relaying an uplink signal received from a UE to a macro access point by a femto access point when the femto access point is in a relay mode will be described.

When an uplink signal from a corresponding UE is received through the antenna 2827, the uplink signal received through the antenna 2827 is output to the duplexer 2825. The duplexer 2825 outputs the uplink signal output from the antenna 2827 to the uplink RF reception unit 2829 at a corresponding time point. The uplink RF reception unit 2829 performs an incoming signal RF processing of the signal output from the duplexer 2825 and outputs the processed signal to the distribution unit 2831. The distribution unit 2831 outputs the signal output from the uplink RF reception unit 2829 to the secondary macro access point signal conversion unit 2819.

The secondary macro access point signal conversion unit 2819 performs a secondary conversion of the signal output from the distribution unit 2831 to a macro access point signal and outputs the converted macro access point signal to the digital signal processor unit 2817. The digital signal processor unit 2817 performs signal processing of the signal output from the secondary macro access point signal conversion unit 2819 and outputs the processed signal to the primary macro access point signal conversion unit 2815. The primary macro access point signal conversion unit 2815 performs a primary conversion of the signal output from the digital signal processor unit 2817 to a macro access point signal and outputs the converted macro access point signal to the macro access point signal transmission/reception unit 2811. The macro access point signal transmission/reception unit 2811 transmits the signal output from the primary macro access point signal conversion unit 2815 to a corresponding macro access point (or a relay station).

Third, a method of transmitting a downlink signal received from a core network to a UE by a femto access point when the femto access point is in a femto access point mode will be described.

The core network signal transmission/reception unit 2843 receives a downlink signal from the core network, and then outputs the received downlink signal to the primary core network signal conversion unit 2841. The primary core network signal conversion unit 2841 performs a primary conversion of the signal output from the core network signal transmission/reception unit 2843 to a core network signal and outputs the converted core network signal to the core network signal processor unit 2839. The core network signal processor unit 2839 processes the signal output from the primary core network signal conversion unit 2841 and outputs the processed signal to the secondary core network signal conversion unit 2837. The secondary core network signal conversion unit 2837 performs a secondary conversion of the signal output from the core network signal processor unit 2839 to a core network signal and outputs the converted core network signal to the combination unit 2821.

The combination unit 2821 combines the signal output from the secondary core network signal conversion unit 2837 with the signal output from the secondary macro access point signal conversion unit 2819 and then outputs the combined signal to the downlink RF transmission unit 2823. The downlink RF transmission unit 2823 performs an outgoing signal RF processing of the signal output from the combination unit 2821 and then outputs the processed signal to the duplexer 2825. The duplexer 2825 transmits the signal output from the downlink RF transmission unit 2823 to a corresponding UE through the antenna 2827 at a corresponding time point.

Fourth, a method of transmitting an uplink signal received from a UE to a core network by a femto access point when the femto access point is in a femto access point mode will be described.

When an uplink signal from a corresponding UE is received through the antenna 2827, the uplink signal received through the antenna 2827 is output to the duplexer 2825. The duplexer 2825 outputs the uplink signal output from the antenna 2827 to the uplink RF reception unit 2829 at a corresponding time point. The uplink RF reception unit 2829 performs an incoming signal RF processing of the signal output from the duplexer 2825 and outputs the processed signal to the distribution unit 2831. The distribution unit 2831 outputs the signal output from the uplink RF reception unit 2829 to the secondary core network signal conversion unit 2837.

The secondary core network signal conversion unit 2837 performs a secondary conversion of the signal output from the distribution unit 2831 to a core network signal and then outputs the converted signal to the core network signal processor unit 2839. The core network signal processor unit 2839 processes the signal output from the secondary core network signal conversion unit 2837 and outputs the processed signal to the primary core network signal conversion unit 2841. The primary core network signal conversion unit 2841 performs a primary conversion of the signal output from the core network signal processor unit 2839 to a core network signal and then outputs the converted signal to the core network signal transmission/reception unit 2843. The core network signal transmission/reception unit 2843 transmits the signal output from the primary core network signal conversion unit 2841 to the core network.

In the structure of the femto access point shown in FIGS. 18 to 28 as described above, the signal output from the RF transmission/reception unit is combined just after the relay unit or distributed just before the femto access point unit.

However, the femto access point either may combine or distribute the signal output from the RF transmission/reception unit just after the duplexer or may combine or distribute the signal output from the RF transmission/reception unit in a baseband signal processing unit. The combination or distribution of the signal output from the RF transmission/reception unit in a baseband signal processing unit implies that a baseband signal output from the relay unit is combined or distributed in the femto access point unit.

Hereinafter, an internal structure of a femto access point, which combines or distributes the signal output from the RF transmission/reception unit just after the duplexer, will be described with reference to FIG. 29.

For convenience, in FIGS. 29 to 32, a macro AP signal transmission/reception unit is illustrated as MAPST/RU, a primary macro AP signal conversion unit is illustrated as PMAPSCU, a macro AP signal processor unit is illustrated as MAPSPU, a secondary macro AP signal conversion unit is illustrated as SMAPSCU, a downlink RF transmission unit is illustrated as DRFTU, a uplink RF reception unit is illustrated as URFRU, a femto AP unit is illustrated as FAPU, a secondary core network signal conversion unit is illustrated as SCNSCU, a core network signal processor unit is illustrated as CNSPU, a primary core network signal conversion unit is illustrated as PCNSCU, a core network signal transmission/reception unit is illustrated as CNST/RU, a RF channel filter unit is illustrated as RFCFU, a downlink RF transmission unit is illustrated as DRFTU, a uplink RF reception unit is illustrated as IURFRU, a macro AP signal conversion unit is illustrated as MAPSCU, a macro AP signal analysis unit is illustrated as MAPSAU, an IF channel filter unit is illustrated as IFCFU, a digital filter unit is illustrated as DFU, a signal processor unit is illustrated as SPU, a digital signal processor unit is illustrated as DSPU, a relay RF transmission/reception unit is illustrated as RRFT/RU, a distribution/combination unit is illustrated as D/CU, a femto AP RF transmission/reception unit is illustrated as FAPRFT/RU.

FIG. 29 is a block diagram illustrating an internal structure of a femto access point according to another embodiment of the present invention.

Referring to FIG. 29, the femto access point includes a macro access point signal transmission/reception unit 2911, a relay unit 2913, the relay RF transmission/reception unit 2921, the duplexer 2923, an antenna 2925, the distribution/combination unit 2927, the duplexer 2929, the femto access point RF transmission/reception unit 2931, a control unit 2933, a femto access point unit 2935, and a core network signal transmission/reception unit 2943. The relay unit 2913 includes a primary macro access point signal conversion unit 2915, a macro access point signal processor unit 2917, and a secondary macro access point signal conversion unit 2919, and the femto access point unit 2935 includes a primary core network signal conversion unit 2941, a core network signal processor unit 2939, and a secondary core network signal conversion unit 2937.

First, the macro access point signal transmission/reception unit 2911 receives a downlink signal from a macro access point and outputs the downlink signal to the primary macro access point signal conversion unit 2915 or receives an uplink signal from the primary macro access point signal conversion unit 2915 and transmits the uplink signal to the macro access point.

The primary macro access point signal conversion unit 2915 performs a primary conversion of the downlink signal output from the macro access point signal transmission/reception unit 2911 to a macro access point signal and then outputs the primary-converted macro access point signal to the macro access point signal processor unit 2917, or performs a primary conversion of the uplink signal output from the macro access point signal processor unit 2917 to a macro access point signal and then outputs the primary-converted macro access point signal to the macro access point signal transmission/reception unit 2911.

The macro access point signal processor unit 2917 performs signal processing of the signal output from the primary macro access point signal conversion unit 2915 and outputs the filtered signal to the secondary macro access point signal conversion unit 2919, or performs signal processing of the signal output from the secondary macro access point signal conversion unit 2919 and outputs the filtered signal to the primary macro access point signal conversion unit 2915.

The secondary macro access point signal conversion unit 2919 performs a secondary conversion of the signal output from the macro access point signal processor unit 2917 to a macro access point signal and then outputs the secondary-converted macro access point signal to the relay RF transmission/reception unit 2921, or performs a secondary conversion of the signal output from the relay RF transmission/reception unit 2921 to a macro access point signal and then outputs the secondary-converted macro access point signal to the macro access point signal processor unit 2917. The relay RF transmission/reception unit 2921 receives the signal output from the second access point signal conversion unit 2919, amplifies the received signal, and outputs the amplified signal to the duplexer 2923, or receives the signal output from the duplexer 2923, amplifies the received signal, and outputs the amplified signal to the second access point signal conversion unit 2919. The relay RF transmission/reception unit 2921 includes an uplink path and a downlink path. The duplexer 2923 outputs the signal output from the relay RF transmission/reception unit 2921 to the distribution/combination unit 2927 at a corresponding time point or outputs the signal output from the distribution/combination unit 2927 to the relay RF transmission/reception unit 2921 at a corresponding time point.

The distribution/combination unit 2927 combines the signal output from the duplexer 2923 with the signal output from the duplexer 2929 and transmits the combined signal to a corresponding UE through the antenna 2925, or receives a signal from a corresponding UE through the antenna 2925 and distributes the received signal to the duplexer 2923 or the duplexer 2929.

The duplexer 2929 outputs the signal output from the distribution/combination unit 2927 to the femto access point RF transmission/reception unit 2931 at a corresponding time point, or outputs the signal output from the femto access point RF transmission/reception unit 2931 to the distribution/combination unit 2927 at a corresponding time point.

The femto access point RF transmission/reception unit 2931 amplifies the signal output from the duplexer 2929 and outputs the amplified signal to the secondary core network signal conversion unit 2937, or amplifies the signal output from the secondary core network signal conversion unit 2937 and outputs the amplified signal to the duplexer 2929. The femto access point RF transmission/reception unit 2931 includes an uplink path and a downlink path.

The secondary core network signal conversion unit 2937 performs a secondary conversion of the signal output from the femto access point RF transmission/reception unit 2931 to a core network signal and then outputs the secondary-converted core network signal to the core network signal processor unit 2939, or performs a secondary conversion of the signal output from the core network signal processor unit 2939 to a core network signal and then outputs the secondary-converted core network signal to the femto access point RF transmission/reception unit 2931. The core network signal processor unit 2939 performs signal processing of the signal output from the secondary core network signal conversion unit 2937 and then outputs the processed signal to the primary core network signal conversion unit 2941, or performs signal processing of the signal output from the primary core network signal conversion unit 2941 and then outputs the processed signal to the secondary core network signal conversion unit 2937.

The primary core network signal conversion unit 2941 performs a primary conversion of the signal output from the core network signal processor unit 2939 to a core network signal and then outputs the primary-converted core network signal to the core network signal transmission/reception unit 2943, or performs a primary conversion of the signal output from the core network signal transmission/reception unit 2943 to a core network signal and then outputs the primary-converted core network signal to the core network signal processor unit 2939. The core network signal transmission/reception unit 2943 transmits the signal output from the primary core network signal conversion unit 2941 to a core network, or outputs a signal received through the core network to the primary core network signal conversion unit 2941.

Further, the control unit 2933 controls the operations of the macro access point signal transmission/reception unit 2911, the relay unit 2913, the femto access point unit 2935, and the core network signal transmission/reception unit 2943. Various control operations performed by the control unit 2933 are based on the signals output from the relay unit 2913 and the femto access point unit 2935 and received by the control unit 2933, and a detailed description of them has been already described above and is thus omitted here. In the meantime, when parameters relating to the control operations have been already determined by the service provider and the femto access point provides limited services as described above, the femto access point may not include the control unit 2933.

Hereinafter, a method of relaying a downlink signal received from a macro access point to a UE by a femto access point when the femto access point is in a relay mode will be first described.

First, the macro access point signal transmission/reception unit 2911 receives a downlink signal from a macro access point and outputs the downlink signal to the primary macro access point signal conversion unit 2915. The primary macro access point signal conversion unit 2915 primary-converts the signal output from the macro access point signal transmission/reception unit 2911 to a macro access point signal and then outputs the converted macro access point signal to the macro access point signal processor unit 2917. The macro access point signal processor unit 2917 performs signal processing of the signal output from the primary macro access point signal conversion unit 2915 and outputs the processed signal to the secondary macro access point signal conversion unit 2919.

The secondary macro access point signal conversion unit 2919 secondary-converts the signal output from the macro access point signal processor unit 2917 to a macro access point signal and then outputs the converted macro access point signal to the relay RF transmission/reception unit 2921.

The relay RF transmission/reception unit 2921 amplifies the signal output from the second access point signal conversion unit 2919 and then outputs the amplified signal to the duplexer 2923. The duplexer 2923 outputs the signal output from the duplexer 2923 the relay RF transmission/reception unit 2921 to the distribution/combination unit 2927 at a corresponding time point. The distribution/combination unit 2927 combines the signal output form the duplexer 2923 with the signal output from the duplexer 2929 and then transmits the combined signal to a corresponding UE through the antenna 2925.

Second, a method of relaying an uplink signal received from a UE to a macro access point by a femto access point when the femto access point is in a relay mode will be described.

When an uplink signal from a corresponding UE is received through the antenna 2925, the uplink signal received through the antenna 2925 is output to the distribution/combination unit 2927. The distribution/combination unit 2927 outputs the uplink signal received through the antenna 2925 to the duplexer 2923. The duplexer 2923 outputs the signal to the relay RF transmission/reception unit 2921 at a corresponding time point. The relay RF transmission/reception unit 2921 amplifies the signal output from the duplexer 2923 and then outputs the amplified signal to the secondary macro access point signal conversion unit 2919.

The secondary macro access point signal conversion unit 2919 performs a secondary conversion of the signal output from the relay RF transmission/reception unit 2921 to a macro access point signal and outputs the converted macro access point signal to the macro access point signal processor unit 2917. The macro access point signal processor unit 2917 performs signal processing of the signal output from the secondary macro access point signal conversion unit 2919 and outputs the processed signal to the primary macro access point signal conversion unit 2915. The primary macro access point signal conversion unit 2915 performs a primary conversion of the signal output from the macro access point signal processor unit 2917 to a macro access point signal and outputs the converted macro access point signal to the macro access point signal transmission/reception unit 2911. The macro access point signal transmission/reception unit 2911 transmits the signal output from the primary macro access point signal conversion unit 2915 to a corresponding macro access point (or a relay station).

Third, a method of transmitting a downlink signal received from a core network to a UE by a femto access point when the femto access point is in a femto access point mode will be described.

The core network signal transmission/reception unit 2943 receives a downlink signal from the core network, and then outputs the received downlink signal to the primary core network signal conversion unit 2941. The primary core network signal conversion unit 2941 performs a primary conversion of the signal output from the core network signal transmission/reception unit 2943 to a core network signal and outputs the converted core network signal to the core network signal processor unit 2939. The core network signal processor unit 2939 processes the signal output from the primary core network signal conversion unit 2941 and outputs the processed signal to the secondary core network signal conversion unit 2937. The secondary core network signal conversion unit 2937 performs a secondary conversion of the signal output from the core network signal processor unit 2939 to a core network signal and outputs the converted core network signal to the femto access point RF transmission/reception unit 2931.

The femto access point RF transmission/reception unit 2931 amplifies the signal output from the secondary core network signal conversion unit 2937 and then outputs the amplified signal to the duplexer 2929. The duplexer 2929 outputs the signal output from the femto access point RF transmission/reception unit 2931 to the distribution/combination unit 2927 at a corresponding time point. The distribution/combination unit 2927 combines the signal output from the duplexer 2929 with the signal output from the duplexer 2923 and then transmits the combined signal to a corresponding UE through the antenna 2925.

Fourth, a method of transmitting an uplink signal received from a UE to a core network by a femto access point when the femto access point is in a femto access point mode will be described.

When an uplink signal from a corresponding UE is received through the antenna 2925, the uplink signal received through the antenna 2925 is output to the distribution/combination unit 2927. The distribution/combination unit 2927 outputs the uplink signal received through the antenna 2925 to the duplexer 2929. The duplexer 2929 outputs the signal output from the distribution/combination unit 2927 to the femto access point RF transmission/reception unit 2931 at a corresponding time point. The femto access point RF transmission/reception unit 2931 amplifies the signal output from the duplexer 2929 and then outputs the amplified signal to the secondary core network signal conversion unit 2937.

The secondary core network signal conversion unit 2937 performs a secondary conversion of the signal output from the femto access point RF transmission/reception unit 2931 to a core network signal and then outputs the converted signal to the core network signal processor unit 2939. The core network signal processor unit 2939 processes the signal output from the secondary core network signal conversion unit 2937 and outputs the processed signal to the primary core network signal conversion unit 2941. The primary core network signal conversion unit 2941 performs a primary conversion of the signal output from the core network signal processor unit 2939 to a core network signal and then outputs the converted signal to the core network signal transmission/reception unit 2943. The core network signal transmission/reception unit 2943 transmits the signal output from the primary core network signal conversion unit 2941 to the core network.

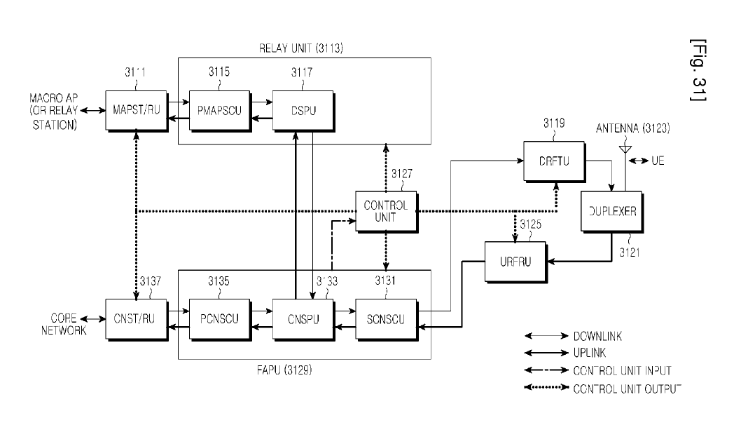

Hereinafter, an internal structure of a femto access point, which combines or distributes the signal output from the RF transmission/reception unit in a baseband signal processing unit, will be described with reference to FIG. 30.

FIG. 30 is a block diagram illustrating an internal structure of a femto access point according to another embodiment of the present invention.

Referring to FIG. 30, the femto access point includes a macro access point signal transmission/reception unit 3011, a relay unit 3013, a downlink RF transmission unit 3019, a duplexer 3021, an antenna 3023, an uplink RF reception unit 3025, a control unit 3027, a femto access point unit 3029, and a core network signal transmission/reception unit 3037. The relay unit 3013 includes a primary macro access point signal conversion unit 3015 and a digital filter unit 3017, and the femto access point unit 3029 includes a primary core network signal conversion unit 3035, a core network signal processor unit 3033, and a secondary core network signal conversion unit 3031.

First, the macro access point signal transmission/reception unit 3011 receives a downlink signal from a macro access point and outputs the downlink signal to the primary macro access point signal conversion unit 3015 or receives an uplink signal from the primary macro access point signal conversion unit 3015 and transmits the uplink signal to the macro access point.

The primary macro access point signal conversion unit 3015 performs a primary conversion of the downlink signal output from the macro access point signal transmission/reception unit 3011 to a macro access point signal and then outputs the primary-converted macro access point signal to the digital filter unit 3017, or performs a primary conversion of the uplink signal output from the digital filter unit 3017 to a macro access point signal and then outputs the primary-converted macro access point signal to the macro access point signal transmission/reception unit 3011.

The digital filter unit 3017 performs digital filtering of the signal output from the primary macro access point signal conversion unit 3015 and outputs the filtered signal to the core network signal processor unit 3033, or performs digital filtering of the signal output from the core network signal processor unit 3033 and outputs the filtered signal to the primary macro access point signal conversion unit 3015.

The downlink RF transmission unit 3019 performs RF transmission processing of the signal output from the secondary core network signal conversion unit 3031 and then outputs the processed signal to the duplexer 3021. The duplexer 3021 transmits the signal output from the downlink RF transmission unit 3019 to a corresponding UE through the antenna 3023 at a corresponding time point, or outputs a signal received through the antenna 3023 to the uplink RF reception unit 3025 at a corresponding time point. The uplink RF reception unit 3025 performs an RF processing of the signal output from the duplexer 3021 and then outputs the processed signal to the secondary core network signal conversion unit 3031.

The secondary core network signal conversion unit 3031 performs a secondary conversion of the signal output from the uplink RF reception unit 3025 to a core network signal and then outputs the secondary-converted core network signal to the core network signal processor unit 3033, or performs a secondary conversion of the signal output from the core network signal processor unit 3033 to a core network signal and then outputs the secondary-converted core network signal to the uplink RF reception unit 3025. The core network signal processor unit 3033 performs signal processing of the signal output from the secondary core network signal conversion unit 3031 and then outputs the processed signal to the primary core network signal conversion unit 3035, or performs signal processing of the signal output from the primary core network signal conversion unit 3035 and then outputs the processed signal to the secondary core network signal conversion unit 3031. Further, the core network signal processor unit 3033 combines the signal output from the primary core network signal conversion unit 3035 with the signal output from the digital filter unit 3017 and then outputs through the combined signal through the secondary core network signal conversion unit 3031 to the uplink RF reception unit 3025.

The primary core network signal conversion unit 3035 performs a primary conversion of the signal output from the core network signal processor unit 3033 to a core network signal and then outputs the primary-converted core network signal to the core network signal transmission/reception unit 3037, or performs a primary conversion of the signal output from the core network signal transmission/reception unit 3037 to a core network signal and then outputs the primary-converted core network signal to the core network signal processor unit 3033. The core network signal transmission/reception unit 3037 transmits the signal output from the primary core network signal conversion unit 3035 to a core network, or outputs a signal received through the core network to the primary core network signal conversion unit 3035.

Further, the control unit 3027 controls the operations of the macro access point signal transmission/reception unit 3011, the relay unit 3013, the femto access point unit 3029, and the core network signal transmission/reception unit 3037. Various control operations performed by the control unit 3027 are based on the signals output from the femto access point unit 3029 and received by the control unit 3027, and a detailed description of them has been already described above and is thus omitted here. In the meantime, when parameters relating to the control operations have been already determined by the service provider and the femto access point provides limited services as described above, the femto access point may not include the control unit 3027.

Although the digital filter unit 3017 and the core network signal processor unit 3033 are separate units in FIG. 30, it goes without saying that the digital filter unit 3017 and the core network signal processor unit 3033 may be implemented as a single unit.

Further, in the internal structure of the femto access point shown in FIG. 30, a baseband signal processing unit should combine or distribute the signal output from the RF transmission/reception unit. Therefore, when the relay unit is implemented by an RF scheme or an IF scheme in which the relay unit does not include a baseband digital signal processor, it is impossible to implement the internal structure of the femto access point shown in FIG. 30.

Hereinafter, a method of relaying a downlink signal received from a macro access point to a UE by a femto access point when the femto access point is in a relay mode will be first described.

First, the macro access point signal transmission/reception unit 3011 receives a downlink signal from a macro access point and outputs the downlink signal to the primary macro access point signal conversion unit 3015. The primary macro access point signal conversion unit 3015 primary-converts the signal output from the macro access point signal transmission/reception unit 3011 to a macro access point signal and then outputs the converted macro access point signal to the digital filter unit 3017. The digital filter unit 3017 performs digital filtering of the signal output from the primary macro access point signal conversion unit 3015 and outputs the processed signal to the core network signal processor unit 3033.

The core network signal processor unit 3033 combines the signal output from the digital filter unit 3017 with the signal output from the core network signal processor unit 3033, and then outputs the combined signal through the secondary core network signal conversion unit 3031 to the downlink RF transmission unit 3019. The downlink RF transmission unit 3019 performs RF processing of the signal output from the secondary core network signal conversion unit 3031 and outputs the processed signal to the duplexer 3021. The duplexer 3021 transmits the signal output from the downlink RF transmission unit 3019 to a corresponding UE through the antenna 3023 at a corresponding time point.

Second, a method of relaying an uplink signal received from a UE to a macro access point by a femto access point when the femto access point is in a relay mode will be described.

When an uplink signal from a corresponding UE is received through the antenna 3023, the uplink signal received through the antenna 3023 is output to the duplexer 3021. The duplexer 3021 outputs the uplink signal output from the antenna 3023 to the uplink RF reception unit 3025 at a corresponding time point. The uplink RF reception unit 3025 performs an RF processing of the signal output from the duplexer 3021 and outputs the processed signal to the core network signal processor unit 3033. The core network signal processor unit 3033 processes the signal output from the secondary core network signal conversion unit 3031 and then outputs the processed signal to the digital filter unit 3017. The digital filter unit 3017 performs digital filtering of the signal output from the core network signal processor unit 3033 and outputs the filtered signal to the primary macro access point signal conversion unit 3015. The primary macro access point signal conversion unit 3015 performs a primary conversion of the signal output from the digital filter unit 3017 to a macro access point signal and outputs the converted macro access point signal to the macro access point signal transmission/reception unit 3011. The macro access point signal transmission/reception unit 3011 transmits the signal output from the primary macro access point signal conversion unit 3015 to a corresponding macro access point (or a relay station).

Third, a method of transmitting a downlink signal received from a core network to a UE by a femto access point when the femto access point is in a femto access point mode will be described.

The core network signal transmission/reception unit 3037 receives a downlink signal from the core network, and then outputs the received downlink signal to the primary core network signal conversion unit 3035. The primary core network signal conversion unit 3035 performs a primary conversion of the signal output from the core network signal transmission/reception unit 3037 to a core network signal and outputs the converted core network signal to the core network signal processor unit 3033. The core network signal processor unit 3033 processes the signal output from the primary core network signal conversion unit 3035 and outputs the processed signal to the secondary core network signal conversion unit 3031. The secondary core network signal conversion unit 3031 performs a secondary conversion of the signal output from the core network signal processor unit 3033 to a core network signal and outputs the converted core network signal to the downlink RF transmission unit 3019.

The downlink RF transmission unit 3019 performs an outgoing signal RF processing of the signal output from the secondary core network signal conversion unit 3031 and then outputs the processed signal to the duplexer 3021. The duplexer 3021 transmits the signal output from the downlink RF transmission unit 3019 to a corresponding UE through the antenna 3023 at a corresponding time point.

Fourth, a method of transmitting an uplink signal received from a UE to a core network by a femto access point when the femto access point is in a femto access point mode will be described.

When an uplink signal from a corresponding UE is received through the antenna 3023, the uplink signal received through the antenna 3023 is output to the duplexer 3021. The duplexer 3021 outputs the uplink signal output from the antenna 3023 to the uplink RF reception unit 3025 at a corresponding time point. The uplink RF reception unit 3025 performs an RF processing of the signal output from the duplexer 3021 and outputs the processed signal to the secondary core network signal conversion unit 3031.

The secondary core network signal conversion unit 3031 performs a secondary conversion of the uplink RF reception unit 3025 to a core network signal and then outputs the converted signal to the core network signal processor unit 3033. The core network signal processor unit 3033 processes the signal output from the secondary core network signal conversion unit 3031 and outputs the processed signal to the primary core network signal conversion unit 3035. The primary core network signal conversion unit 3035 performs a primary conversion of the signal output from the core network signal processor unit 3033 to a core network signal and then outputs the converted signal to the core network signal transmission/reception unit 3037. The core network signal transmission/reception unit 3037 transmits the signal output from the primary core network signal conversion unit 3035 to the core network.

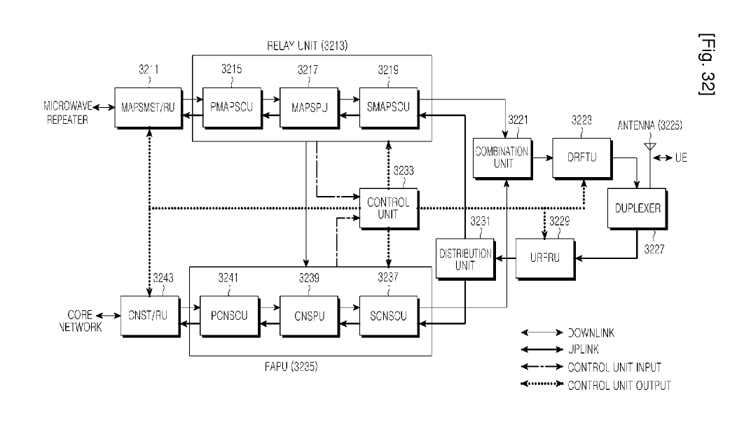

FIG. 31 is a block diagram illustrating an internal structure of a femto access point according to another embodiment of the present invention.

Referring to FIG. 31, the femto access point includes a macro access point signal transmission/reception unit 3111, a relay unit 3113, a downlink RF transmission unit 3119, a duplexer 3121, an antenna 3123, an uplink RF reception unit 3125, a control unit 3127, a femto access point unit 3129, and a core network signal transmission/reception unit 3137. The relay unit 3113 includes a primary macro access point signal conversion unit 3115 and a digital filter unit 3117, and the femto access point unit 3129 includes a primary core network signal conversion unit 3135, a core network signal processor unit 3133, and a secondary core network signal conversion unit 3131.

First, the macro access point signal transmission/reception unit 3111 receives a downlink signal from a macro access point and outputs the downlink signal to the primary macro access point signal conversion unit 3115 or receives an uplink signal from the primary macro access point signal conversion unit 3115 and transmits the uplink signal to the macro access point.

The primary macro access point signal conversion unit 3115 performs a primary conversion of the downlink signal output from the macro access point signal transmission/reception unit 3111 to a macro access point signal and then outputs the primary-converted macro access point signal to the digital filter unit 3117, or performs a primary conversion of the uplink signal output from the digital filter unit 3117 to a macro access point signal and then outputs the primary-converted macro access point signal to the macro access point signal transmission/reception unit 3111.

The digital filter unit 3117 performs digital filtering of the signal output from the primary macro access point signal conversion unit 3115 and outputs the filtered signal to the core network signal processor unit 3133, or performs digital filtering of the signal output from the core network signal processor unit 3133 and outputs the filtered signal to the primary macro access point signal conversion unit 3115.

The downlink RF transmission unit 3119 performs RF processing of the signal output from the secondary core network signal conversion unit 3131 and then outputs the processed signal to the duplexer 3121. The duplexer 3121 transmits the signal output from the downlink RF transmission unit 3119 to a corresponding UE through the antenna 3123 at a corresponding time point, or outputs a signal received through the antenna 3123 to the uplink RF reception unit 3125 at a corresponding time point. The uplink RF reception unit 3125 performs an RF processing of the signal output from the duplexer 3121 and then outputs the processed signal to the secondary core network signal conversion unit 3131.

The secondary core network signal conversion unit 3131 performs a secondary conversion of the signal output from the uplink RF reception unit 3125 to a core network signal and then outputs the secondary-converted core network signal to the core network signal processor unit 3133, or performs a secondary conversion of the signal output from the core network signal processor unit 3133 to a core network signal and then outputs the secondary-converted core network signal to the uplink RF reception unit 3125. The core network signal processor unit 3133 performs signal processing of the signal output from the secondary core network signal conversion unit 3131 and then outputs the processed signal to the primary core network signal conversion unit 3135, or performs signal processing of the signal output from the primary core network signal conversion unit 3135 and then outputs the processed signal to the secondary core network signal conversion unit 3131. Further, the core network signal processor unit 3133 combines the signal output from the primary core network signal conversion unit 3135 with the signal output from the digital filter unit 3117 and then outputs through the combined signal through the secondary core network signal conversion unit 3131 to the uplink RF reception unit 3125.

The primary core network signal conversion unit 3135 performs a primary conversion of the signal output from the core network signal processor unit 3133 to a core network signal and then outputs the primary-converted core network signal to the core network signal transmission/reception unit 3137, or performs a primary conversion of the signal output from the core network signal transmission/reception unit 3137 to a core network signal and then outputs the primary-converted core network signal to the core network signal processor unit 3133. The core network signal transmission/reception unit 3137 transmits the signal output from the primary core network signal conversion unit 3135 to a core network, or outputs a signal received through the core network to the primary core network signal conversion unit 3135.

Further, the control unit 3127 controls the operations of the macro access point signal transmission/reception unit 3111, the relay unit 3113, the femto access point unit 3129, and the core network signal transmission/reception unit 3137. Various control operations performed by the control unit 3127 are based on the signals output from the femto access point unit 3129 and received by the control unit 3127, and a detailed description of them has been already described above and is thus omitted here. In the meantime, when parameters relating to the control operations have been already determined by the service provider and the femto access point provides limited services as described above, the femto access point may not include the control unit 3127.

Although the digital filter unit 3117 and the core network signal processor unit 3133 are separate units in FIG. 31, it goes without saying that the digital filter unit 3117 and the core network signal processor unit 3133 may be implemented as a single unit.

Further, in the internal structure of the femto access point shown in FIG. 31, a baseband signal processing unit should combine or distribute the signal output from the RF transmission/reception unit. Therefore, when the relay unit is implemented by an RF scheme or an IF scheme in which the relay unit does not include a baseband digital signal processor, it is impossible to implement the internal structure of the femto access point shown in FIG. 31.

Hereinafter, a method of relaying a downlink signal received from a macro access point to a UE by a femto access point when the femto access point is in a relay mode will be first described.

First, the macro access point signal transmission/reception unit 3111 receives a downlink signal from a macro access point and outputs the downlink signal to the primary macro access point signal conversion unit 3115. The primary macro access point signal conversion unit 3115 primary-converts the signal output from the macro access point signal transmission/reception unit 3111 to a macro access point signal and then outputs the converted macro access point signal to the digital filter unit 3117. The digital filter unit 3117 performs digital filtering of the signal output from the primary macro access point signal conversion unit 3115 and outputs the processed signal to the core network signal processor unit 3133.

The core network signal processor unit 3133 combines the signal output from the digital filter unit 3117 with the signal output from the core network signal processor unit 3133, and then outputs the combined signal through the secondary core network signal conversion unit 3131 to the downlink RF transmission unit 3119. The downlink RF transmission unit 3119 performs RF processing of the signal output from the secondary core network signal conversion unit 3131 and outputs the processed signal to the duplexer 3121. The duplexer 3121 transmits the signal output from the downlink RF transmission unit 3119 to a corresponding UE through the antenna 3123 at a corresponding time point.

Second, a method of relaying an uplink signal received from a UE to a macro access point by a femto access point when the femto access point is in a relay mode will be described.

When an uplink signal from a corresponding UE is received through the antenna 3123, the uplink signal received through the antenna 3123 is output to the duplexer 3121. The duplexer 3121 outputs the uplink signal output from the antenna 3123 to the uplink RF reception unit 3125 at a corresponding time point. The uplink RF reception unit 3125 performs an RF processing of the signal output from the duplexer 3121 and outputs the processed signal to the core network signal processor unit 3133. The core network signal processor unit 3133 processes the signal output from the secondary core network signal conversion unit 3131 and then outputs the processed signal to the digital filter unit 3117. The digital filter unit 3117 performs digital filtering of the signal output from the core network signal processor unit 3133 and outputs the filtered signal to the primary macro access point signal conversion unit 3115. The primary macro access point signal conversion unit 3115 performs a primary conversion of the signal output from the digital filter unit 3117 to a macro access point signal and outputs the converted macro access point signal to the macro access point signal transmission/reception unit 3111. The macro access point signal transmission/reception unit 3111 transmits the signal output from the primary macro access point signal conversion unit 3115 to a corresponding macro access point (or a relay station).

Third, a method of transmitting a downlink signal received from a core network to a UE by a femto access point when the femto access point is in a femto access point mode will be described.

The core network signal transmission/reception unit 3137 receives a downlink signal from the core network, and then outputs the received downlink signal to the primary core network signal conversion unit 3135. The primary core network signal conversion unit 3135 performs a primary conversion of the signal output from the core network signal transmission/reception unit 3137 to a core network signal and outputs the converted core network signal to the core network signal processor unit 3133. The core network signal processor unit 3133 processes the signal output from the primary core network signal conversion unit 3135 and outputs the processed signal to the secondary core network signal conversion unit 3131. The secondary core network signal conversion unit 3131 performs a secondary conversion of the signal output from the core network signal processor unit 3133 to a core network signal and outputs the converted core network signal to the downlink RF transmission unit 3119.

The downlink RF transmission unit 3119 performs an outgoing signal RF processing of the signal output from the secondary core network signal conversion unit 3131 and then outputs the processed signal to the duplexer 3121. The duplexer 3121 transmits the signal output from the downlink RF transmission unit 3119 to a corresponding UE through the antenna 3123 at a corresponding time point.

Fourth, a method of transmitting an uplink signal received from a UE to a core network by a femto access point when the femto access point is in a femto access point mode will be described.

When an uplink signal from a corresponding UE is received through the antenna 3123, the uplink signal received through the antenna 3123 is output to the duplexer 3121. The duplexer 3121 outputs the uplink signal output from the antenna 3123 to the uplink RF reception unit 3125 at a corresponding time point. The uplink RF reception unit 3125 performs an RF processing of the signal output from the duplexer 3121 and outputs the processed signal to the secondary core network signal conversion unit 3131.

The secondary core network signal conversion unit 3131 performs a secondary conversion of the uplink RF reception unit 3125 to a core network signal and then outputs the converted signal to the core network signal processor unit 3133. The core network signal processor unit 3133 processes the signal output from the secondary core network signal conversion unit 3131 and outputs the processed signal to the primary core network signal conversion unit 3135. The primary core network signal conversion unit 3135 performs a primary conversion of the signal output from the core network signal processor unit 3133 to a core network signal and then outputs the converted signal to the core network signal transmission/reception unit 3137. The core network signal transmission/reception unit 3137 transmits the signal output from the primary core network signal conversion unit 3135 to the core network.

FIG. 32 is a block diagram illustrating an internal structure of a femto access point according to another embodiment of the present invention.

It should be noted that the internal structure of the femto access point shown in FIG. 32 corresponds to an internal structure in which the type of the relay unit is a microwave repeater type. Further, when the relay unit is implemented by an RF scheme, it is impossible to apply the internal structure of the femto access point unit shown in FIG. 32.

Referring to FIG. 32, the femto access point includes a macro access point microwave signal transmission/reception unit 3211, a relay unit 3213, a combination unit 3221, a downlink RF transmission unit 3223, a duplexer 3227, an antenna 3225, an uplink RF reception unit 3229, a distribution unit 3231, a control unit 3233, a femto access point unit 3235, and a core network signal transmission/reception unit 3243. The relay unit 3213 includes a primary macro access point signal conversion unit 3215, a digital signal processor unit 3217, and a secondary macro access point signal conversion unit 3219, and the femto access point unit 3235 includes a primary core network signal conversion unit 3241, a core network signal processor unit 3239, and a secondary core network signal conversion unit 3237.

First, the macro access point microwave signal transmission/reception unit 3211 receives a downlink signal from a microwave repeater and outputs the downlink signal to the primary macro access point signal conversion unit 3215 or receives an uplink signal from the primary macro access point signal conversion unit 3215 and transmits the uplink signal to the microwave repeater.

The primary macro access point signal conversion unit 3215 performs a primary conversion of the downlink signal output from the macro access point microwave signal transmission/reception unit 3211 to a macro access point signal and then outputs the primary-converted macro access point signal to the digital signal processor unit 3217, or performs a primary conversion of the uplink signal output from the digital signal processor unit 3217 to a macro access point signal and then outputs the primary-converted macro access point signal to the macro access point microwave signal transmission/reception unit 3211. The digital signal processor unit 3217 performs signal processing of the signal output from the primary macro access point signal conversion unit 3215 and outputs the processed signal to the secondary macro access point signal conversion unit 3219, or performs signal processing of the signal output from the secondary macro access point signal conversion unit 3219 and outputs the processed signal to the primary macro access point signal conversion unit 3215.

The secondary macro access point signal conversion unit 3219 performs a secondary conversion of the signal output from the digital signal processor unit 3217 to a macro access point signal and then outputs the secondary-converted macro access point signal to the combination unit 3221, or performs a secondary conversion of the signal output from the distribution unit 3231 to a macro access point signal and then outputs the secondary-converted macro access point signal to the digital signal processor unit 3217.

The combination unit 3221 combines the signal output from the secondary macro access point signal conversion unit 3219 with a signal output from the secondary core network signal conversion unit 3237 and outputs the combined signal to the downlink RF transmission unit 3223. The downlink RF transmission unit 3223 performs RF transmission processing of the signal output from the combination unit 3221 and then outputs the processed signal to the duplexer 3227. The duplexer 3227 transmits the signal output from the downlink RF transmission unit 3223 to a corresponding UE through the antenna 3225 at a corresponding time point.

Meanwhile, a signal received from the UE through the antenna 3225 is output to the duplexer 3227, and the duplexer 3227 outputs the signal received through the antenna 3225 to the uplink RF reception unit 3229 at a corresponding time point. The uplink RF reception unit 3229 performs an incoming signal RF processing of the signal output from the duplexer 3227 and then outputs the processed signal to the distribution unit 3231. The distribution unit 3231 determines the unit to which the signal output from the uplink RF reception unit 3229 should be distributed, and then outputs the signal to the secondary macro access point signal conversion unit 3219 or the secondary core network signal conversion unit 3237. The distribution unit 3231 outputs the uplink signal received from the UE to the secondary macro access point signal conversion unit 3219 when the uplink signal received from the UE should be transmitted through the relay unit 3213, and outputs the uplink signal received from the UE to the secondary core network signal conversion unit 3237 when the uplink signal received from the UE should be transmitted through the femto access point unit 3235.

The secondary core network signal conversion unit 3237 performs a secondary conversion of the signal output from the distribution unit 3231 to a core network signal and then outputs the secondary-converted core network signal to the core network signal processor unit 3239, or performs a secondary conversion of the signal output from the core network signal processor unit 3239 to a core network signal and then outputs the secondary-converted core network signal to the distribution unit 3231.

The core network signal processor unit 3239 performs signal processing of the signal output from the secondary core network signal conversion unit 3237 and then outputs the processed signal to the primary core network signal conversion unit 3241, or performs signal processing of the signal output from the primary core network signal conversion unit 3241 and then outputs the processed signal to the secondary core network signal conversion unit 3237.

The primary core network signal conversion unit 3241 performs a primary conversion of the signal output from the core network signal processor unit 3239 to a core network signal and then outputs the primary-converted core network signal to the core network signal transmission/reception unit 3243, or performs a primary conversion of the signal output from the core network signal transmission/reception unit 3243 to a core network signal and then outputs the primary-converted core network signal to the core network signal processor unit 3239.

The core network signal transmission/reception unit 3243 transmits the signal output from the primary core network signal conversion unit 3241 to a core network, or outputs a signal received through the core network to the primary core network signal conversion unit 3241.

Further, the control unit 3233 controls the operations of the macro access point microwave signal transmission/reception unit 3211, the relay unit 3213, the downlink RF transmission unit 3223, the uplink RF reception unit 3229, the femto access point unit 3235, and the core network signal transmission/reception unit 3243. Various control operations performed by the control unit 3233 are based on the signals output from the relay unit 3213 and the femto access point unit 3235 and received by the control unit 3233, and a detailed description of them has been already described above and is thus omitted here. In the meantime, when parameters relating to the control operations have been already determined by the service provider and the femto access point provides limited services as described above, the femto access point may not include the control unit 3233.

Hereinafter, a method of relaying a downlink signal received from a macro access point to a UE by a femto access point when the femto access point is in a relay mode will be first described.

First, the macro access point microwave signal transmission/reception unit 3211 receives a downlink signal from a macro access point and outputs the downlink signal to the primary macro access point signal conversion unit 3215. The primary macro access point signal conversion unit 3215 primary-converts the signal output from the macro access point microwave signal transmission/reception unit 3211 to a macro access point signal and then outputs the converted macro access point signal to the digital signal processor unit 3217. The digital signal processor unit 3217 performs signal processing of the signal output from the primary macro access point signal conversion unit 3215 and outputs the processed signal to the secondary macro access point signal conversion unit 3219. The secondary macro access point signal conversion unit 3219 secondary-converts the signal output from the digital signal processor unit 3217 to a macro access point signal and then outputs the converted macro access point signal to the combination unit 3221.

The combination unit 3221 combines the signal output from the secondary macro access point signal conversion unit 3219 with the signal output from the secondary core network signal conversion unit 3237 and then outputs the combined signal to the downlink RF transmission unit 3223. The downlink RF transmission unit 3223 performs an outgoing signal RF processing of the signal output from the combination unit 3221 and then outputs the processed signal to the duplexer 3227. The duplexer 3227 transmits the signal output from the downlink RF transmission unit 3223 to a corresponding UE through the antenna 3225 at a corresponding time point.

Second, a method of relaying an uplink signal received from a UE to a macro access point by a femto access point when the femto access point is in a relay mode will be described.

When an uplink signal from a corresponding UE is received through the antenna 3225, the uplink signal received through the antenna 3225 is output to the duplexer 3227. The duplexer 3227 outputs the uplink signal output from the antenna 3225 to the uplink RF reception unit 3229 at a corresponding time point. The uplink RF reception unit 3229 performs an incoming signal RF processing of the signal output from the duplexer 3227 and outputs the processed signal to the distribution unit 3231. The distribution unit 3231 outputs the signal output from the uplink RF reception unit 3229 to the secondary macro access point signal conversion unit 3219.

The secondary macro access point signal conversion unit 3219 performs a secondary conversion of the signal output from the distribution unit 3231 to a macro access point signal and outputs the converted macro access point signal to the digital signal processor unit 3217. The digital signal processor unit 3217 performs signal processing of the signal output from the secondary macro access point signal conversion unit 3219 and outputs the processed signal to the primary macro access point signal conversion unit 3215. The primary macro access point signal conversion unit 3215 performs a primary conversion of the signal output from the digital signal processor unit 3217 to a macro access point signal and outputs the converted macro access point signal to the macro access point microwave signal transmission/reception unit 3211. The macro access point microwave signal transmission/reception unit 3211 transmits the signal output from the primary macro access point signal conversion unit 3215 to a corresponding macro access point (or a relay station).

Third, a method of transmitting a downlink signal received from a core network to a UE by a femto access point when the femto access point is in a femto access point mode will be described.

The core network signal transmission/reception unit 3243 receives a downlink signal from the core network, and then outputs the received downlink signal to the primary core network signal conversion unit 3241. The primary core network signal conversion unit 3241 performs a primary conversion of the signal output from the core network signal transmission/reception unit 3243 to a core network signal and outputs the converted core network signal to the core network signal processor unit 3239. The core network signal processor unit 3239 processes the signal output from the primary core network signal conversion unit 3241 and outputs the processed signal to the secondary core network signal conversion unit 3237. The secondary core network signal conversion unit 3237 performs a secondary conversion of the signal output from the core network signal processor unit 3239 to a core network signal and outputs the converted core network signal to the combination unit 3221.

The combination unit 3221 combines the signal output from the secondary core network signal conversion unit 3237 with the signal output from the secondary macro access point signal conversion unit 3219 and then outputs the combined signal to the downlink RF transmission unit 3223. The downlink RF transmission unit 3223 performs an outgoing signal RF processing of the signal output from the combination unit 3221 and then outputs the processed signal to the duplexer 3227. The duplexer 3227 transmits the signal output from the downlink RF transmission unit 3223 to a corresponding UE through the antenna 3225 at a corresponding time point.

Fourth, a method of transmitting an uplink signal received from a UE to a core network by a femto access point when the femto access point is in a femto access point mode will be described.

When an uplink signal from a corresponding UE is received through the antenna 3225, the uplink signal received through the antenna 3225 is output to the duplexer 3227. The duplexer 3227 outputs the uplink signal output from the antenna 3225 to the uplink RF reception unit 3229 at a corresponding time point. The uplink RF reception unit 3229 performs an incoming signal RF processing of the signal output from the duplexer 3227 and outputs the processed signal to the distribution unit 3231. The distribution unit 3231 outputs the signal output from the uplink RF reception unit 3229 to the secondary core network signal conversion unit 3237. The secondary core network signal conversion unit 3237 performs a secondary conversion of the signal output from the distribution unit 3231 to a core network signal and then outputs the converted signal to the core network signal processor unit 3239. The core network signal processor unit 3239 processes the signal output from the secondary core network signal conversion unit 3237 and outputs the processed signal to the primary core network signal conversion unit 3241. The primary core network signal conversion unit 3241 performs a primary conversion of the signal output from the core network signal processor unit 3239 to a core network signal and then outputs the converted signal to the core network signal transmission/reception unit 3243. The core network signal transmission/reception unit 3243 transmits the signal output from the primary core network signal conversion unit 3241 to the core network.

Meanwhile, the above description with reference to FIGS. 18 to 32 is based on an assumption that the mobile communication system discussed above uses a Frequency Division Duplex (FDD) scheme. Therefore, the femto access point shown in FIGS. 18 to 32 includes a duplexer since the mobile communication system uses an FDD communication system. However, when the mobile communication system discussed above is a system using a Time Division Duplex (TDD) scheme, the femto access point need not include a duplexer.

Therefore, according to whether the mobile communication system shown in FIGS. 18 to 32 uses an FDD scheme or a TDD scheme, the femto access point either may include a duplexer or may not include a duplexer.

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. A femto access point in a communication system, which provides an interface for a User Equipment (UE), an interface for a macro access point or a relay, and an interface for a core network.

2. The femto access point of claim 1, comprising:
a relay unit for outputting a first downlink signal, which is received from a macro access point or a relay station, to a combination/distribution unit and relaying an uplink signal, which is output from the combination/distribution unit, to the macro access point or the relay station;
a femto access point unit for outputting a second downlink signal, which is received from the core network, to the combination/distribution unit and transmitting an uplink signal, which is output from the combination/distribution unit, to the core network;
the combination unit for combining the first downlink signal and the second downlink signal with each other and outputting a combined signal to the UE;
the distribution unit for distributing uplink signals received from the UE to the relay unit and the femto access point unit;
a Radio Frequency (RF) transmission unit for RF-processing the signal output from the combination unit and transmitting a processed signal to the UE; and
an RF reception unit for RF-processing the signal output from the distribution unit and outputting the processed signal to the relay unit or the femto access point unit.

3. The femto access point of claim 2, wherein the relay unit receives downlink signals of all macro access points in the unit of preset frequency or Frequency Assignment (FA) and detects a service provider identifier and a cell identifier by using a reference downlink signal having the best signal quality from among the received downlink signals.

4. The femto access point of claim 2, further comprising a reference signal generation unit for generating a reference signal, wherein the reference signal generation unit detects a synchronization signal from a downlink signal received from the macro access point and generates, by using the synchronization, the reference signal to be used by the femto access point.

5. The femto access point of claim 2, further comprising a reference signal generation unit for generating a reference signal, wherein the reference signal generation unit comprises:
a macro access point signal conversion unit for converting a downlink signal received from the macro access point to a baseband signal, thereby generating a first signal;
a synchronization detection unit for detecting a synchronization signal of the macro access point from the first signal;
a crystal oscillator; and
a counter-and-clock generation unit for detecting the number of crystal clocks existing in a preset time interval by using the synchronization signal, calculating the number of clocks of the crystal oscillator necessary in order to generate a reference clock by using the detected number of crystal clocks, and generating the reference clock based on the calculated number of clocks of the crystal oscillator.

6. The femto access point of claim 2, further comprising a control unit for performing a control operation by using signals output from the relay unit and the femto access point unit, wherein the control unit determines if it will use the relay unit or the femto access point unit in order to provide a service, based on if the UE is registered in the femto access point.

7. The femto access point of claim 6, wherein, when the femto access point is using all available capacity, the control unit determines to use the relay unit in providing a service to the UE.

8. The femto access point of claim 6, wherein the relay unit uses at least one FA and the control unit causes the relay unit and the femto access point unit to use different FAs.

9. The femto access point of claim 8, wherein said at least one FA used by the relay unit comprises an FA, through which a downlink signal having the best signal quality from among FAs of the macro access point is transmitted, and the femto access point unit uses one FA, which is selected from other FAs of the macro access point except for said at least one FA used by the relay unit.

10. The femto access point of claim 6, wherein the FA used by the femto access point unit is an FA corresponding to FA information acquired through registration by the femto access point or an FA, which is selected from other FAs of the macro access point except for said at least one FA used by the relay unit, and said at least one FA used by the relay unit comprises an FA, through which a downlink signal having the best signal quality from among FAs of the macro access point is transmitted.

11. The femto access point of claim 6, further comprising a reference signal generation unit for generating a reference signal, wherein the reference signal generation unit detects a synchronization signal from a downlink signal received from the macro access point and generates, by using the synchronization, the reference signal to be used by the femto access point.

12. A control method by a femto access point in a communication system, comprising a step of providing an interface for a UE, an interface for a macro access point or a relay, and an interface for a core network.

13. The method of claim 12, wherein the step of providing an interface for a UE, an interface for a macro access point or a relay, and an interface for a core network comprises the steps of:
combining a first downlink signal, which is received from a macro access point or a relay station, and a second downlink signal, which is received from the core network, with each other, thereby generating a combined signal;
RF-processing the combined signal and then transmitting the processed signal to the UE; and
relaying an uplink signal, which is received from the UE, to the macro access point or the relay station, or transmitting an uplink signal, which is received from the UE, to the core network.

14. The method of claim 13, further comprising the steps of:
detecting a synchronization signal from a downlink signal received from the macro access point; and
generating, by using the synchronization, a reference signal to be used by the femto access point.

15. The method of claim 13, further comprising a step of performing a control operation by using the first downlink signal, the second downlink signal, and the uplink signal.

16. The method of claim 13, wherein the step of performing a control operation by using the first downlink signal, the second downlink signal, and the uplink signal comprises the steps of:
determining if the UE is registered in the femto access point; and
determining if it will use a relay mode or a femto access point mode in order to provide a service to the UE, based on if the UE is registered in the femto access point.

17. The method of claim 15, wherein the step of performing a control operation by using the first downlink signal, the second downlink signal, and the uplink signal comprises a step of, when the femto access point is using all available capacity, determining to use the relay mode in providing a service to the UE.

18. The method of claim 15, wherein at least one FA is used when the relay mode is used to provide a service to the UE, and said at least one FA used when the relay mode is used to provide a service to the UE is different from an FA used when the femto access point mode is used to provide a service to the UE.

19. The method of claim 18, wherein said at least one FA used when the relay mode is used to provide a service to the UE comprises an FA, through which a downlink signal having the best signal quality from among FAs of the macro access point is transmitted, and the FA used when the femto access point mode is used to provide a service to the UE is an FA, which is selected from other FAs of the macro access point except for said at least one FA used by the relay unit.

20. The method of claim 13, further comprising the steps of:
detecting a synchronization signal from a downlink signal received from the macro access point; and
generating, by using the synchronization, a reference signal to be used by the femto access point.
